(19) United States
(12) Patent Application Publication
(10) Pub. No.: US 2026/0229507 A1
(43) Pub. Date: Aug. 6, 2026

(54) LITHIUM-ION SECONDARY BATTERY

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Yohei MOMMA, Isehara, Kanagawa (JP); Nao KUROSAWA, Atsugi, Kanagawa (JP); Atsushi KAWATSUKI, Yokohama, Kanagawa (JP); Tatsuyoshi TAKAHASHI, Atsugi, Kanagawa (JP)

(21) Appl. No.: 19/147,824

(22) PCT Filed: Jan. 19, 2024
(86) PCT No.: PCT/IB2024/050504

§ 371 Date: Jul. 14, 2025

(30) Foreign Application Priority Data
Jan. 26, 2023 (JP) 2023-010389
Apr. 21, 2023 (JP) 2023-070241

(51) Int. Cl. H01M 4/525; H01M 4/58; H01M 10/0525

(52) U.S. Cl. CPC H01M 4/525; H01M 4/5825; H01M 10/0525

(57) ABSTRACT

A positive electrode active material that inhibits a decrease in discharge capacity in charge and discharge cycles and a secondary battery using the positive electrode active material are provided. Alternatively, a highly safe secondary battery is provided. A lithium-ion secondary battery includes a positive electrode and a negative electrode. The positive electrode includes a positive electrode current collector and a positive electrode active material layer over the positive electrode current collector. The negative electrode includes a negative electrode current collector and a negative electrode active material layer over the negative electrode current collector. In a region where the positive electrode current collector and the negative electrode current collector face each other, the positive electrode active material layer contains a positive electrode active material, the positive electrode active material has a layered rock-salt crystal structure belonging to the space group R-3m, and an angle formed by the normal of the negative electrode current collector and the c-axis of the crystal structure of 50% or more of the number of particles of the positive electrode active material in the positive electrode active material layer is greater than or equal to 60° and less than or equal to 120°. As the positive electrode active material, lithium cobalt oxide or lithium nickel-cobalt-manganese oxide can be used.

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to a power storage device including a secondary battery, a semiconductor device, a display device, a light-emitting device, a lighting device, an electronic device, or a manufacturing method thereof.

Electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, air batteries, and all-solid-state batteries have been actively developed. In particular, demand for lithium-ion secondary batteries with high output and a high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Document 1 to Patent Document 3). In addition, a crystal structure of a positive electrode active material has also been studied (e.g., Non-Patent Document 1 to Non-Patent Document 5). Furthermore, controlling the direction of a crystal of a positive electrode active material has been examined (e.g., Patent Document 4 and Patent Document 5).

In addition, X-ray diffraction (XRD) is one of methods used for analysis of the crystal structure of a positive electrode active material. With the use of the ICSD (Inorganic Crystal Structure Database) described in Non-Patent Document 6, XRD data can be analyzed. For example, the ICSD can be referred to for the lattice constant of the lithium cobalt oxide described in Non-Patent Document 7. For Rietveld analysis, the analysis program RIETAN-FP (Non-Patent Document 8) can be used, for example. VESTA (Non-Patent Document 9) can be used as software for drawing crystal structures.

As image processing software, for example, ImageJ (Non-Patent Document 10 to Non-Patent Document 12) is known. Using this software makes it possible to analyze the shape of a positive electrode active material, for example.

Nanobeam electron diffraction can also be effectively used to identify the crystal structure of a positive electrode active material, particularly the crystal structure of its surface portion. For analysis of electron diffraction patterns, an analysis program ReciPro (Non-Patent Document 13) can be used, for example.

Fluorides such as fluorite (calcium fluoride) have been used as fusing agents in iron manufacture and the like for a very long time, and the physical properties of fluorides have been studied (Non-Patent Document 14 and Non-Patent Document 15).

### REFERENCES

### Patent Documents

[Patent Document 1] Japanese Published Patent Application No. 2019-179758
[Patent Document 2] International Publication WO2020/26078 Pamphlet
[Patent Document 3] Japanese Published Patent Application No. 2020-140954
[Patent Document 4] International Publication WO2010/74304 Pamphlet
[Patent Document 5] Japanese Published Patent Application No. 2012-99405

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348
[Non-Patent Document 2]T. Motohashi, et al., “Electronic phase diagram of the layered cobalt oxide system LiₓCoO₂ (0.0≤x≤1.0)”, Physical Review B, 80 (16); 165114
[Non-Patent Document 3] Zhaohui Chen et al., “Staging Phase Transitions in LiₓCoO₂”, Journal of The Electrochemical Society, 2002, 149 (12), A1604-A1609
[Non-Patent Document 4]G. G. Amatucci et al., “CoO₂, The End Member of the LiₓCoO₂ Solid Solution”, J. Electrochem. Soc., 143 (3), 1114 (1996).
[Non-Patent Document 5] Tsuyoshi Ohnishi et al., “In Situ X-ray Diffraction of LiCoO₂ in Thin-Film Batteries under High-Voltage Charging”, ACS Appl. Energy Mater., 2021, 4, 12, 14372-14379
[Non-Patent Document 6]A. Belsky, et al., “New developments in the Inorganic Crystal Structure Database (ICSD): accessibility in support of materials research and design”, Acta Cryst., (2002), B58, 364-369.
[Non-Patent Document 7] Akimoto, J.; Gotoh, Y.; Oosawa, Y. “Synthesis and structure refinement of LiCoO₂ single crystals”, Journal of Solid State Chemistry (1998) 141, pp. 298-302.
[Non-Patent Document 8]F. Izumi and K. Momma, Solid State Phenom., (2007) 130, 15-20.
[Non-Patent Document 9]K. Momma and F. Izumi, J. Appl. Cryst., (2011)., 44, 1272-1276
[Non-Patent Document 10] Rasband, W. S., Image J, U. S. National Institutes of Health, Bethesda, Maryland, USA, http://rsb.info.nih.gov/ij/, 1997-2012.
[Non-Patent Document 11] Schneider, C. A., Rasband, W. S., Eliceiri, K.W., “NIH Image to ImageJ: 25 years of image analysis”, Nature Methods, 9, 671-675, 2012.
[Non-Patent Document 12] Abramoff, M. D., Magelhaes, P. J., Ram, S. J., “Image Processing with ImageJ”, Biophotonics International, volume 11, issue 7, pp. 36-42, 2004.
[Non-Patent Document 13] Seto, Y. & Ohtsuka, M., “ReciPro: free and open-source multipurpose crystallographic software integrating a crystal model database and viewer, diffraction and microscopy simulators, and diffraction data analysis tools” (2022)., J. Appl. Cryst., 55.
[Non-Patent Document 14]W. E. Counts, R. Roy, and E. F. Osborn, “Fluoride Model Systems: II, The Binary Systems CaF₂—BeF₂, MgF₂—BeF₂, and LiF—MgF₂”, Journal of the American Ceramic Society, 36 [1]12-17 (1953).
[Non-Patent Document 15]P. P. Fedotieff and K. Timofeeff, Z Anorg. Allg. Chem., “Schemelzdiagramme der Systeme KF-ALF₃ und LiF—AlF₃”, 206 [3]263-266 (1932).

### SUMMARY OF THE INVENTION

### Problems to be Solved by the Invention

There is room for improvements in a variety of aspects of lithium-ion secondary batteries, such as discharge capacity, cycle performance, reliability, safety, and cost.

Therefore, positive electrode active materials that can settle issues such as discharge capacity, cycle performance, reliability, safety, and cost when used in secondary batteries have been needed.

An object of one embodiment of the present invention is to provide a positive electrode active material or a composite oxide which can be used in a lithium-ion secondary battery and which inhibits the discharge capacity from decreasing during charge and discharge cycles. Another object is to provide a positive electrode active material or a composite oxide whose crystal structure is not easily broken even when charge and discharge are repeated. Another object is to provide a positive electrode active material or a composite oxide with high discharge capacity. Another object is to provide a highly safe or highly reliable secondary battery.

Another object of one embodiment of the present invention is to provide a positive electrode active material, a composite oxide, a power storage device, or a manufacturing method thereof.

Note that the description of these objects does not preclude the existence of other objects. One embodiment of the present invention does not need to achieve all of these objects. Other objects can be derived from the descriptions of the specification, the drawings, and the claims.

### Means for Solving the Problems

One embodiment of the present invention is a lithium-ion secondary battery including a positive electrode and a negative electrode. The positive electrode includes a positive electrode current collector and a positive electrode active material layer over the positive electrode current collector. The negative electrode includes a negative electrode current collector and a negative electrode active material layer over the negative electrode current collector. In a region where the positive electrode current collector and the negative electrode current collector face each other, the positive electrode active material layer contains a positive electrode active material; the positive electrode active material has a layered rock-salt crystal structure belonging to a space group R-3m; and an angle formed by a normal of the negative electrode current collector and a c-axis of the crystal structure of 50% or more of the number of particles of the positive electrode active material in the positive electrode active material layer is greater than or equal to 60° and less than or equal to 120°.

In the lithium-ion secondary battery, the positive electrode active material layer contains graphene, and the positive electrode active material includes a region in contact with the graphene at a surface having a normal in a direction intersecting the c-axis of the crystal structure.

In one of the above lithium-ion secondary batteries, the positive electrode active material is a lithium composite oxide containing cobalt. Alternatively, in one of the above lithium-ion secondary batteries, the positive electrode active material is a lithium composite oxide containing nickel, cobalt, and manganese.

Another embodiment of the present invention is a lithium-ion secondary battery including a positive electrode and a negative electrode. The positive electrode includes a positive electrode current collector and a positive electrode active material layer over the positive electrode current collector. The negative electrode includes a negative electrode current collector and a negative electrode active material layer over the negative electrode current collector. In a region where the positive electrode current collector and the negative electrode current collector face each other, the positive electrode active material layer contains a positive electrode active material; the positive electrode active material has an olivine crystal structure belonging to a space group pnma; and an angle formed by a normal of the negative electrode current collector and a [010] direction of the crystal structure of 50% or more of the number of particles of the positive electrode active material in the positive electrode active material layer is greater than or equal to 0° and less than or equal to 30°.

In the lithium-ion secondary battery, the positive electrode active material contains lithium iron phosphate.

### Effect of the Invention

One embodiment of the present invention can provide a positive electrode active material or a composite oxide which can be used in a lithium-ion secondary battery and which inhibits the discharge capacity from decreasing during charge and discharge cycles. A positive electrode active material or a composite oxide whose crystal structure is not easily broken even when charge and discharge are repeated can be provided. A positive electrode active material or a composite oxide with high discharge capacity can be provided. A highly safe or highly reliable secondary battery can be provided.

Another embodiment of the present invention can provide a positive electrode active material, a composite oxide, a power storage device, or a manufacturing method thereof.

Note that the description of these effects does not preclude the existence of other effects. Note that one embodiment of the present invention does not necessarily need to have all these effects. Note that other effects will be apparent from the description of the specification, the drawings, the claims, and the like and other effects can be derived from the description of the specification, the drawings, the claims, and the like.

### BRIEF DESCRIPTION OF THE DRAWINGS

FIG. 1A is a cross-sectional view illustrating an inner structure of a secondary battery, and FIG. 1B is a cross-sectional view illustrating a positive electrode and an electrolyte of the secondary battery.

FIG. 2 is a perspective view illustrating crystal planes in a layered rock-salt crystal structure represented by the space group R-3m.

FIG. 3 is a diagram illustrating the direction in which lithium ions easily move in a positive electrode active material and the positional relationship between a positive electrode current collector and a negative electrode current collector.

FIG. 4A and FIG. 4B are cross-sectional views each illustrating the direction of the c-axis of a positive electrode active material 100A included in a positive electrode.

FIG. 5A and FIG. 5B are cross-sectional views each illustrating the [010] direction of a positive electrode active material 100B included in a positive electrode.

FIG. 6A and FIG. 6B are cross-sectional views of a positive electrode active material.

FIG. 7A to FIG. 7D are diagrams illustrating phase changes of a positive electrode active material.

FIG. 8 is a diagram illustrating charge depths and lattice constants of a positive electrode active material.

FIG. 9A is a diagram illustrating an example of a formation method of a positive electrode active material. FIG. 9B and FIG. 9C are diagrams illustrating heating method examples in the formation method.

FIG. 10A and FIG. 10B are diagrams illustrating examples of a method for forming a positive electrode active material.

FIG. 11A and FIG. 11B are diagrams illustrating examples of a method for forming the positive electrode active material.

FIG. 12 is a diagram illustrating an example of a method for forming the positive electrode active material.

FIG. 13 is a diagram illustrating an example of a method for forming the positive electrode active material.

FIG. 14 is a diagram illustrating an example of a method for forming the positive electrode active material.

FIG. 15A and FIG. 15B are diagrams illustrating examples of manufacturing apparatuses. FIG. 15C is a diagram illustrating a cross section of the manufacturing apparatus.

FIG. 16A and FIG. 16B are an example of a schematic cross-sectional view of a batch-type rotary kiln, and FIG. 16C is a diagram illustrating an example of a time chart at the time of heat treatment.

FIG. 17 is a phase diagram showing a relationship between temperature and compositions of lithium fluoride and magnesium fluoride.

FIG. 18 is a phase diagram showing a relationship between temperature and compositions of lithium fluoride and aluminum fluoride.

FIG. 19 is an example of a TEM image showing crystal orientations substantially aligned with each other.

FIG. 20A is an example of a STEM image showing crystal orientations substantially aligned with each other. FIG. 20B shows an FFT pattern of a region of a rock-salt crystal RS, and FIG. 20C shows an FFT pattern of a region of a layered rock-salt crystal LRS.

FIG. 21 is a diagram illustrating crystal structures of a positive electrode active material.

FIG. 22 is a diagram illustrating crystal structures of a conventional positive electrode active material.

FIG. 23 is a diagram showing XRD patterns calculated from crystal structures.

FIG. 24 is a diagram showing XRD patterns calculated from crystal structures.

FIG. 25A and FIG. 25B are diagrams each showing XRD patterns calculated from crystal structures.

FIG. 26 is a diagram illustrating crystal structures of a positive electrode active material.

FIG. 27A and FIG. 27B are diagrams each illustrating a positive electrode active material of one embodiment of the present invention.

FIG. 28 is a diagram illustrating a method for forming a positive electrode active material of one embodiment of the present invention.

FIG. 29 is a diagram illustrating an example of a method for forming a positive electrode active material of one embodiment of the present invention.

FIG. 30 is a diagram illustrating the appearance of a secondary battery.

FIG. 31A to FIG. 31C are diagrams illustrating a method for manufacturing the secondary battery.

FIG. 32A to FIG. 32H are diagrams illustrating examples of electronic devices.

FIG. 33A to FIG. 33D are diagrams illustrating examples of electronic devices.

FIG. 34A to FIG. 34C are diagrams illustrating examples of electronic devices.

FIG. 35A to FIG. 35C are diagrams illustrating examples of vehicles.

### MODE FOR CARRYING OUT THE INVENTION

Embodiment examples for carrying out the present invention will be described below with reference to the drawings and the like. Note that the present invention should not be interpreted as being limited to the embodiment examples given below. Embodiments for carrying out the invention can be changed unless they deviate from the spirit of the present invention.

In this specification and the like, a space group is represented using the short notation of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “-” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure in some cases. In some cases, not only (hkl) but also (hkil) is used as the Miller index. Here, i is −(h+k). In this specification and the like, a crystal plane or the like in the space group R-3m is represented with use of a composite hexagonal lattice, unless otherwise specified.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

A theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

The remaining amount of lithium that can be inserted into and extracted from a positive electrode active material is represented by x in a compositional formula, e.g., LiₓCoO₂. In the case of a positive electrode active material in a secondary battery, x=(theoretical capacity−charge capacity)/theoretical capacity can be satisfied. For example, in the case where a secondary battery using LiCoO₂ as a positive electrode active material is charged to 219.2 mAh/g, it can be said that the positive electrode active material is represented by Li_{0.2}CoO₂ or x=0.2. Note that “x in LiₓCoO₂ is small” means, for example, 0.1<x≤0.24. The amount of lithium extracted from a positive electrode active material with respect to the theoretical capacity is sometimes referred to as a charge depth. In this specification and the like, a charge depth is 1−x.

Lithium cobalt oxide to be used for a positive electrode, which has been appropriately synthesized and almost satisfies the stoichiometric proportion, is LiCoO₂ and x=1. In a secondary battery after its discharge ends, it can be said that contained lithium cobalt oxide is also LiCoO₂ and x=1. Here, “discharge ends” means that a voltage becomes lower than or equal to 3.0 V or lower than or equal to 2.5 V at a current of 100 mA/g or lower, for example.

Charge capacity and/or discharge capacity used for calculation of x in LiₓCoO₂ is preferably measured under the condition where there is no influence or small influence of a short circuit and/or decomposition of an electrolyte solution or the like. For example, data of a secondary battery, suffering from a sudden change of capacity that seems to result from a short circuit, should not be used for calculation of x.

The space group of a crystal structure is identified by XRD, electron diffraction, neutron diffraction, or the like. Thus, in this specification and the like, the terms such as belonging to a space group, being attributed to a space group, and being a space group can be rephrased as being identified as a space group.

Furthermore, when the arrangement of anions is close to a cubic close-packed structure, the arrangement can be regarded as the cubic close-packed structure. The arrangement of anions forming the cubic close-packed structure refers to a state where anions in a second layer are positioned above voids between anions packed in a first layer, and anions in a third layer are placed at the positions that are positioned right above voids between the anions in the second layer and are not positioned right above the anions in the first layer. Accordingly, anions do not necessarily form a cubic lattice structure. In addition, actual crystals always have a defect and thus, analysis results are not necessarily consistent with the theory. For example, in an electron diffraction pattern or an FFT (fast Fourier transform) pattern of a TEM image or the like, a spot may appear in a position slightly different from a theoretical position. For example, anions may be regarded as forming a cubic close-packed structure when a difference in orientation from a theoretical position is less than or equal to 5° or less than or equal to 2.5°.

The distribution of an element indicates the region where the element is successively detected by a successive analysis method to the extent that the detection value is no longer on the noise level. The region where the element is successively detected to the extent that the detection value is no longer on the noise level can also be regarded as a region where the element is surely detected when the analysis is performed a plurality of times.

A positive electrode active material to which an additive element is added is sometimes referred to as a composite oxide, a positive electrode member, a positive electrode material, a secondary battery positive electrode member, or the like.

In this specification and the like, a secondary particle refers to a particle formed by aggregation of primary particles. In this specification and the like, aggregation includes a state where particles gather and there is no limitation on the bonding force acting between a plurality of primary particles. That is, the bonding force may be any of covalent bonding, ionic bonding, a hydrophobic interaction, the Van der Waals force, and other molecular interactions, or a plurality of bonding forces may work together. In this specification and the like, a primary particle refers to a particle whose appearance shows no grain boundary. In this specification and the like, a single particle refers to a particle whose appearance shows no grain boundary. Since a single particle is a particle whose appearance shows no grain boundary, a single particle is referred to as a primary particle in some cases. In this specification and the like, a single crystal refers to a crystal where no grain boundary is observed in an inner portion of a particle, whereas a polycrystal refers to a crystal where a grain boundary exists in an inner portion of a particle. A polycrystal may be regarded as a group of a plurality of crystallites, and a grain boundary may be regarded as an interface existing between two or more crystallites. Note that crystallites in a polycrystal are preferably in the same direction.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can inhibit a charge and discharge capacity decrease due to repeated charge and discharge.

A short circuit of a secondary battery might cause not only a malfunction in charge operation and/or discharge operation of the secondary battery but also heat generation and ignition. In order to obtain a safe secondary battery, a short-circuit current is preferably inhibited even at a high charge voltage. In the positive electrode active material of one embodiment of the present invention, a short-circuit current is inhibited even at a high charge voltage. Thus, a secondary battery having a high discharge capacity and a high level of safety can be obtained.

In this specification and the like, ignition in a nail penetration test refers to a state where fire is observed outside an exterior body within one minute after nail penetration. In addition, the ignition refers to a state where thermal runway has occurred in a secondary battery. For example, when the temperature of a secondary battery exceeds 130° C., it can be said that thermal runaway has occurred. The temperature at this time can be measured with a temperature sensor attached to an exterior body of a secondary battery. In addition, a state where a solid thermal decomposition product of a positive electrode and/or a negative electrode is observed at a position more than or equal to 2 cm away from a penetration point after a nail penetration test is finished can also be referred to as ignition.

Note that the description is made on the assumption that materials (such as a positive electrode active material, a negative electrode active material, an electrolyte, and a separator) of a secondary battery have not deteriorated unless otherwise specified. A decrease in discharge capacity due to aging treatment and burn-in treatment during the manufacturing process of a secondary battery is not regarded as deterioration. For example, the case where discharge capacity is higher than or equal to 97% of the rated capacity of a lithium-ion secondary battery cell and an assembled lithium-ion secondary battery (hereinafter, referred to as a lithium-ion secondary battery) can be regarded as a non-deteriorated state. The rated capacity conforms to JIS C 8711:2019 in the case of a lithium-ion secondary battery for a portable device. The rated capacities of other lithium-ion secondary batteries conform to JIS described above, JIS for electric vehicle propulsion, industrial use, and the like, standards defined by IEC, and the like.

Note that in this specification and the like, in some cases, materials included in a secondary battery that have not deteriorated are referred to as initial products or materials in an initial state, and materials that have deteriorated (have discharge capacity lower than 97% of the rated capacity of the secondary battery) are referred to as products in use, materials in a used state, products that are already used, or materials in an already-used state.

### Embodiment 1

In this embodiment, a battery (also referred to as a lithium-ion battery) of one embodiment of the present invention will be described.

### [Battery]

One embodiment of the present invention includes a positive electrode, a negative electrode, and an electrolyte. When the electrolyte includes an electrolyte solution, a separator is provided between the positive electrode and the negative electrode. An exterior body covering at least part of peripheries of the positive electrode, the negative electrode, and the electrolyte may be further provided.

In this embodiment, a positive electrode and a positive electrode active material of one embodiment of the present invention are mainly described. The positive electrode active material included in the battery will be described in Embodiment 2 and Embodiment 3, and the other components of the lithium ion battery of one embodiment of the present invention will be described in detail in Embodiment 4.

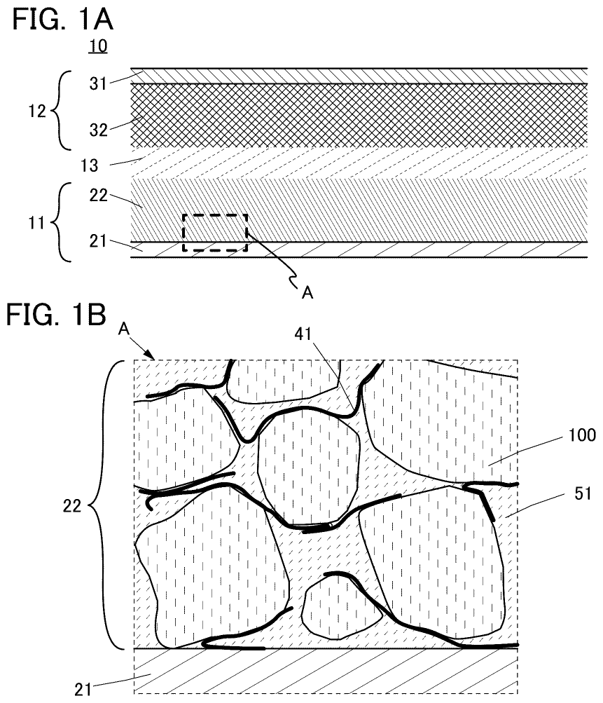

FIG. 1A is a schematic cross-sectional view illustrating an inner structure of a battery 10. The battery 10 includes a positive electrode 11, a negative electrode 12, and a separator 13. The positive electrode 11 includes a positive electrode current collector 21 and a positive electrode active material layer 22 over the positive electrode current collector 21, and the negative electrode 12 includes a negative electrode current collector 31 and a negative electrode active material layer 32. As illustrated, the positive electrode active material layer 22 and the negative electrode active material layer 32 face each other with the separator 13 therebetween. The positive electrode current collector 21 and the negative electrode current collector 31 face each other with the separator 13 therebetween. Although not illustrated in FIG. 1A, the battery 10 includes electrolytes 51 in a void included in the positive electrode active material layer 22, a void included in the separator 13, and a void included in the negative electrode active material layer 32.

Note that one positive electrode 11, one negative electrode 12, and one separator 13 are illustrated in FIG. 1A; however, the structure of the lithium ion battery of one embodiment of the present invention is not limited thereto. Two positive electrodes 11, two negative electrodes 12, and two separators 13 may be provided, or three or more positive electrodes 11, three or more negative electrodes 12, and three or more separators 13 may be stacked. Moreover, not a stacked-layer structure illustrated in FIG. 1A but a wound structure may be employed.

FIG. 1B is an enlarged view of a portion A surrounded by a dashed line in FIG. 1A.

### [Positive Electrode]

The positive electrode 11 includes the positive electrode current collector 21 and the positive electrode active material layer 22. The positive electrode active material layer 22 contains a positive electrode active material 100 and a conductive material 41. Although not illustrated, the positive electrode active material layer 22 may contain a binder in addition to the positive electrode active material 100 and the conductive material 41.

The void included in the positive electrode active material layer 22 is preferably filled with the electrolyte 51 as illustrated. For example, the proportion of the void included in the positive electrode active material layer 22 filled with the electrolyte 51 is preferably higher than or equal to 60%, further preferably higher than or equal to 70%, still further preferably higher than or equal to 80%, yet further preferably higher than or equal to 90%, yet still further preferably higher than or equal to 95%, most preferably higher than or equal to 99%. Note that the void included in the positive electrode active material layer 22 refers to a region other than a solid component (e.g., a positive electrode active material or a conductive material) in the positive electrode active material layer 22.

### <Conductive Material>

A conductive material is also referred to as a conductivity-imparting agent or a conductive additive, and a carbon material is used. The conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

As the conductive material 41, a particulate conductive material, a fibrous conductive material, or a sheet-like conductive material can be used alone or in combination thereof. For example, although FIG. 1B illustrates an example in which a sheet-like conductive material is used as the conductive material 41, instead, a fibrous conductive material and a particulate conductive material may be used, a fibrous conductive material and a sheet-like conductive material may be used, or a particulate conductive material and a sheet-like conductive material may be used.

As the particulate conductive material, one or two or more kinds of carbon black such as acetylene black or furnace black and graphite such as artificial graphite or natural graphite can be used, for example.

As the fibrous conductive material, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be formed by, for example, a vapor deposition method.

As the sheet-like conductive material, a graphene compound can be used, for example. A graphene compound in this specification and the like includes graphene, multilayer graphene, multi graphene, graphene oxide, multilayer graphene oxide, multi graphene oxide, reduced graphene oxide, reduced multilayer graphene oxide, reduced multi graphene oxide, or the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group.

The content of the conductive material 41 to the total amount of the positive electrode active material layer 22 is preferably greater than or equal to 0.1 wt % and less than or equal to 10 wt %, further preferably greater than or equal to 0.5 wt % and less than or equal to 5 wt %.

Unlike a particulate conductive material such as carbon black, which makes point contact with a positive electrode active material, the graphene compound is capable of making low-resistance surface contact; accordingly, the electrical conduction between the particulate positive electrode active material and the graphene compound can be improved with a smaller amount of the graphene compound than that of a normal conductive material. This can increase the proportion of the active material in the active material layer. Accordingly, the discharge capacity of the battery can be increased.

As the positive electrode active material 100, a composite oxide having a layered rock-salt crystal structure belonging to the space group R-3m can be used (a positive electrode active material 100A). In the case where the positive electrode active material 100A, which is a composite oxide having a layered rock-salt crystal structure belonging to the space group R-3m, is used, it is preferable to be in contact with the conductive material at a particle surface that is exposed in a direction intersecting with the (00l) plane than to be in contact with the conductive material at a particle surface parallel to the (00l) plane of the composite oxide. The particle surface that is exposed in the direction intersecting with the (00l) plane can also be referred to as a particle surface having the normal in a direction intersecting with the c-axis. In other words, the positive electrode active material 100 preferably includes a region in contact with the conductive material 41 at the particle surface having the normal in a direction intersecting with the c-axis.

As the composite oxide having a layered rock-salt crystal structure belonging to the space group R-3m, one or more of lithium cobalt oxide, lithium nickel-cobalt-manganese oxide, lithium nickel-cobalt-aluminum oxide, and lithium nickel-manganese-aluminum oxide can be used, for example. Among these, it is particularly preferable to use lithium cobalt oxide described in Embodiment 2 or lithium nickel-cobalt-manganese oxide described in Embodiment 3.

In this specification and the like, the (001) plane, the (003) plane, and the like are sometimes collectively referred to as the (00l) plane. In this specification and the like, the (00l) plane is sometimes referred to as a C-plane, a basal plane, or the like. In a composite oxide such as lithium cobalt oxide or lithium nickel-cobalt-manganese oxide, lithium has a two-dimensional diffusion path. That is, it can be said that the diffusion path of lithium exists along a plane. In this specification and the like, a plane where the diffusion path of lithium is exposed, i.e., a plane other than a plane where lithium is inserted and extracted (specifically, the (00l) plane), is sometimes referred to as an edge plane.

In addition, in electron conduction of a composite oxide such as lithium cobalt oxide or lithium nickel-cobalt-manganese oxide, the electron conductivity in the two-dimensional diffusion path along the (00l) plane is higher than that in a direction orthogonal to the (001) plane. That is, in a composite oxide such as lithium cobalt oxide or lithium nickel-cobalt-manganese oxide, an electron diffusion path exists along the plane. Thus, in the case where a composite oxide having a layered rock-salt crystal structure belonging to the space group R-3m is used as the positive electrode active material 100A, the electron conductivity between the positive electrode active material 100 and the conductive material 41 can be increased when the composite oxide is in contact with the conductive material at the particle surface that is exposed in a direction intersecting with the (00l) plane compared to when the composite oxide is in contact with the conductive material at the particle surface parallel to the (00l) plane. That is, it can be said that the electron conductivity of the positive electrode active material layer 22 is increased when the positive electrode active material 100 includes a region in contact with the conductive material 41 at the particle surface having the normal in a direction intersecting with the c-axis.

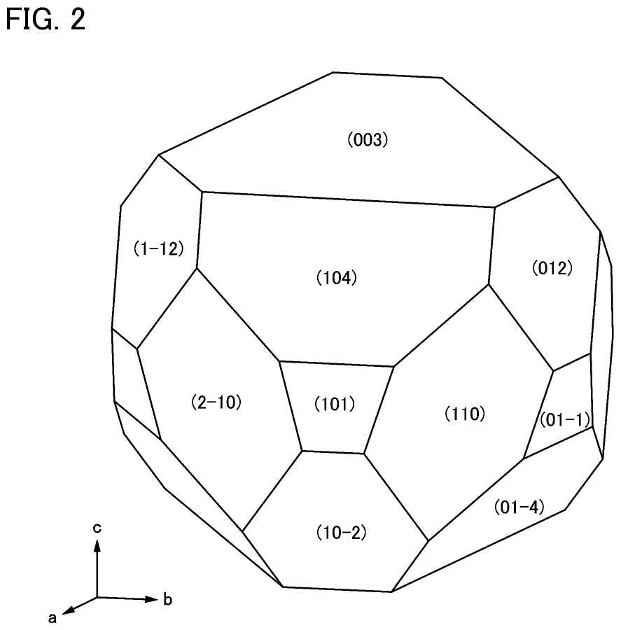

FIG. 2 is a perspective view illustrating typical crystal planes of a composite oxide having a layered rock-salt crystal structure belonging to the space group R-3m, such as lithium cobalt oxide or lithium nickel-cobalt-manganese oxide. FIG. 2 schematically illustrates a state where a variety of crystal planes appear on a particle surface of the composite oxide. Examples of the particle surface having the normal in a direction intersecting with the c-axis include the (104) plane, the (012) plane, the (1-12) plane, the (110) plane, and a plane equivalent thereto in FIG. 2. Note that since a facet plane as in FIG. 2 does not appear on a particle surface of an actual composite oxide in some cases, the particle surface having the normal in a direction intersecting with the c-axis does not refer to a particular crystal plane.

### <Orientation of Positive Electrode Active Material>

As described above, a composite oxide such as lithium cobalt oxide or lithium nickel-cobalt-manganese oxide has a diffusion path of lithium ions on the (00l) plane. In addition, as described above, a composite oxide such as lithium cobalt oxide or lithium nickel-cobalt-manganese oxide has high electron conductivity on the (00l) plane. That is, in a composite oxide having a layered rock-salt crystal structure belonging to the space group R-3m, lithium ions and electrons are likely to move in a direction parallel to the (00l) plane.

The movement of lithium ions in charging of a lithium-ion secondary battery is as follows: lithium ions are extracted from the particle surface of the positive electrode active material into the electrolyte, and then, the lithium ions are inserted into the negative electrode active material from the electrolyte. Moreover, as the movement of electrons in charging of the lithium-ion secondary battery when lithium ions are extracted from the positive electrode active material, electrons flow to an external circuit through the positive electrode current collector in the positive electrode, and electrons flow to the negative electrode active material from the external circuit through the negative electrode current collector in the negative electrode. The movement of lithium ions and the movement of electrons in charging of the lithium-ion secondary battery are in a direction opposite to the above-described flow.

Thus, in the battery 10 in which the positive electrode 11 and the negative electrode 12 face each other as illustrated in FIG. 1A, the movement of lithium ions and the movement of electrons can be described as follows. For example, in a region of the battery 10 where the positive electrode current collector 21 and the negative electrode current collector 31 face each other, a direction in which lithium ions in charge moves is in the normal direction of the positive electrode current collector 21, and a direction in which lithium ions in discharge moves is in the normal direction of the negative electrode current collector 31.

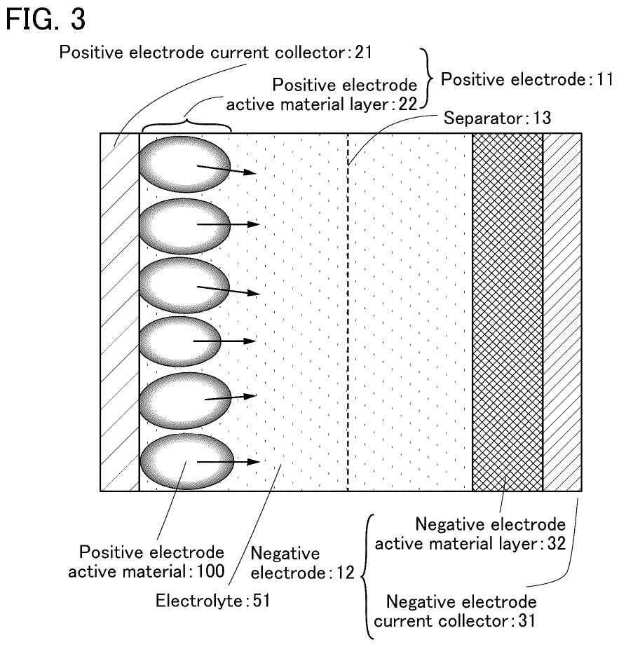

Thus, as illustrated in FIG. 3, in the positive electrode active material 100, when the direction in which lithium ions and electrons easily move (the direction indicated by arrows in the drawing) is aligned with the normal of the positive electrode current collector 21 or the normal of the negative electrode current collector 31, lithium ions easily move. Note that in the case where a composite oxide having a layered rock-salt crystal structure belonging to the space group R-3m is used as the positive electrode active material 100, the charge and discharge of the battery 10 can be smoothly performed and the output characteristics can be improved when the (00l) plane is aligned with the normal of the positive electrode current collector 21 or the normal of the negative electrode current collector 31, i.e., when the direction in which lithium ions and electrons move easily in the composite oxide and the normal direction of the positive electrode current collector 21 are aligned with each other. In other words, in the composite oxide having a layered rock-salt crystal structure belonging to the space group R-3m, when the (00l) plane is aligned with the normal direction of the negative electrode current collector 31, that is, when the direction in which lithium ions and electrons move easily is aligned with the normal direction of the negative electrode current collector 31 in the composite oxide, the charge and discharge of the battery 10 can be smoothly performed and the output characteristics of the battery 10 can be improved.

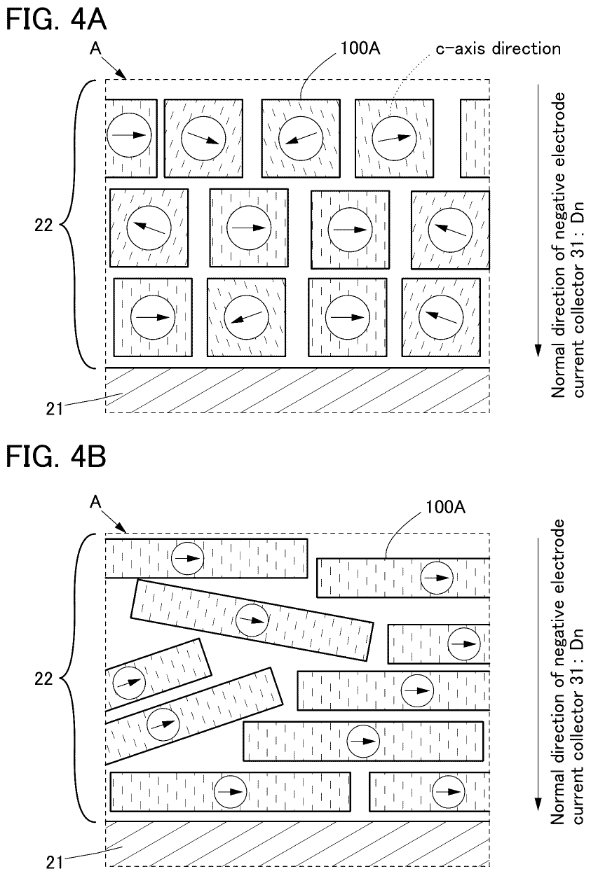

FIG. 4A and FIG. 4B are cross-sectional views illustrating variation examples of the structure of the positive electrode 11 illustrated in FIG. 1B.

In FIG. 4A and FIG. 4B, arrows in circles shown inside the positive electrode active material 100A indicate the direction of the c-axis of the composite oxide having a layered rock-salt crystal structure belonging to the space group R-3m. In addition, solid line arrows on the right side in the drawing indicate the normal direction Dn of the negative electrode current collector 31. Note that the shape of the positive electrode active material 100A illustrated in FIG. 4 or the like is sometimes simplified or exaggerated for easy viewing, and the shape of the positive electrode active material 100A of one embodiment of the present invention is not limited to the shape illustrated in FIG. 4 or the like.

For example, in the composite oxide having a layered rock-salt crystal structure belonging to the space group R-3m, when the direction in which lithium ions and electrons move easily and the normal direction of the negative electrode current collector 31 are aligned with each other as illustrated in FIG. 4A, the charge and discharge of the battery 10 can be smoothly performed and the output characteristics can be improved. Note that when the angle formed by the normal of the negative electrode current collector 31 and the c-axis of the crystal structure is greater than or equal to 50° and less than or equal to 130°, preferably greater than or equal to 60° and less than or equal to 120°, it can be said that the normal direction is aligned with the (00l) plane. The number of particles whose c-axis is aligned with the normal of the negative electrode current collector 31 preferably accounts for greater than or equal to 50%, further preferably greater than or equal to 60% with respect to the total number of particles of the positive electrode active material 100 included in the positive electrode active material layer 22. Such a state can be referred to as a state where the positive electrode active material 100 is oriented. Alternatively, the volume of the positive electrode active material 100 whose c-axis is aligned with the normal of the negative electrode current collector 31 preferably accounts for greater than or equal to 50%, further preferably greater than or equal to 60% with respect to the total volume of the positive electrode active material 100 included in the positive electrode active material layer 22. Such a state can be referred to as a state where the positive electrode active material 100 is oriented. Alternatively, when cross-sectional analysis is performed on the positive electrode active material layer 22, the cross-sectional area of the positive electrode active material 100 whose c-axis is aligned with the normal of the negative electrode current collector 31 preferably accounts for greater than or equal to 50%, further preferably greater than or equal to 60% with respect to the total cross-sectional area of the positive electrode active material 100. Such a state can be referred to as a state where the positive electrode active material 100 is oriented. For a method for analyzing the above orientation, XRD analysis, TEM analysis, an EBSD (electron backscatter diffraction pattern), or the like can be used.

The positive electrode active material layer 22 in which the positive electrode active material 100A is oriented can be formed by application of a magnetic field during the formation of the positive electrode active material layer 22. The intensity of the magnetic field is preferably, for example, greater than or equal to 1T, greater than or equal to 2T, greater than or equal to 3T, greater than or equal to 4T, greater than or equal to 5T, greater than or equal to 6T, greater than or equal to 7T, greater than or equal to 8T, greater than or equal to 9T, greater than or equal to 10T, or greater than or equal to 15T. An electromagnet can be used as a method for applying the magnetic field.

FIG. 4A schematically illustrates the case where the positive electrode active material 100A has a shape with a certain side length that is not extremely long, i.e., a shape close to a cube, a shape close to a spherical shape, a shape close to a regular octahedron, a shape close to a regular dodecahedron, or a shape having any of these shapes with rounded corners. In the case where the positive electrode active material 100A has such a shape, the positive electrode active material 100A is easily oriented in a particular direction by application of a magnetic field during the formation of the positive electrode active material layer 22. Note that the shape of the positive electrode active material 100A is not limited to the above-described shape.

Alternatively, in the case where the positive electrode active material 100A is formed to have a shape with a certain side length that is extremely long, e.g., a plate-like shape, a flake-like shape, a wire-like shape, or a columnar shape and to have the long side direction that is the c-axis direction of the crystal, the positive electrode active material layer 22 where the positive electrode active material 100A is oriented as illustrated in FIG. 4B can be obtained even when a magnetic field is not applied during the formation of the positive electrode active material layer 22.

Although the example of the composite oxide having a layered rock-salt crystal structure belonging to the space group R-3m is described above, the composite oxide that can be used for the positive electrode active material 100 is not limited thereto, and composite oxide particles having an olivine crystal structure belonging to the space group pnma, such as lithium iron phosphate (LiFePO₄), can be used for the positive electrode active material 100 (a positive electrode active material 100B). In the olivine crystal structure belonging to the space group pnma, the direction in which lithium ions diffuse is the [010] direction. Thus, in the case where the composite oxide having an olivine crystal structure belonging to the space group pnma is used, the charge and discharge of the battery 10 can be smoothly performed and the output characteristics of the battery 10 can be improved when the [010] direction of the composite oxide is aligned with the normal direction of the negative electrode current collector 31.

The phrase “the [010] direction of the composite oxide having an olivine crystal structure belonging to the space group pnma is aligned with the normal direction of the negative electrode current collector 31” means that the angle formed by the [010] direction and the normal is greater than or equal to 0° and less than or equal to 40°, preferably greater than or equal to 0° and less than or equal to 30°.

In the case where the composite oxide particles having an olivine crystal structure belonging to the space group pnma are used as the positive electrode active material 100B, the number of particles of the positive electrode active material 100 in which the [010] direction is aligned with the normal of the negative electrode current collector 31 is preferably greater than or equal to 50%, further preferably greater than or equal to 60% with respect to the total number of particles. Such a state can be referred to as a state where the positive electrode active material 100B is oriented.

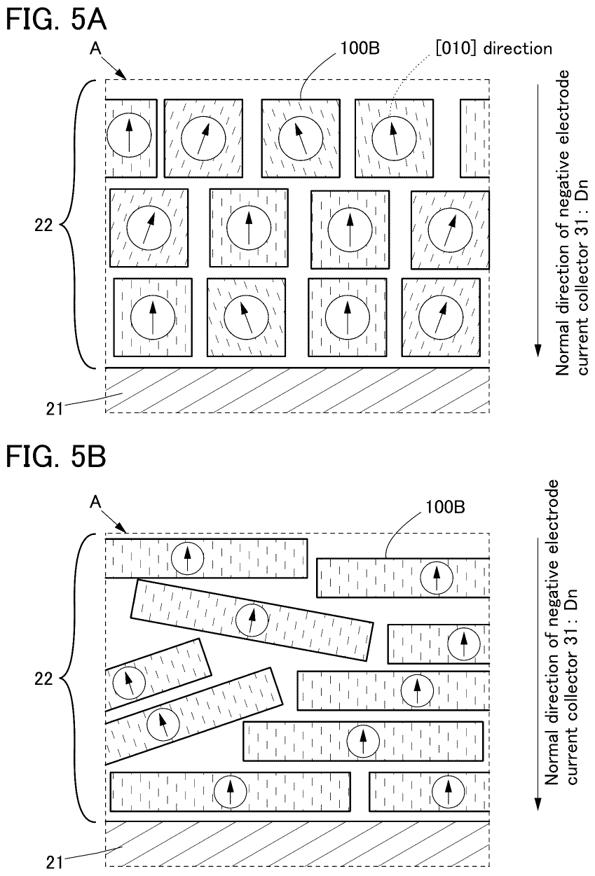

FIG. 5A and FIG. 5B illustrate examples of a state where the positive electrode active material 100B, which is the composite oxide having an olivine crystal structure belonging to the space group pnma, is oriented. FIG. 5A schematically illustrates the case where the positive electrode active material 100B has a shape with a certain side length that is not extremely long, i.e., a shape close to a cube, a shape close to a spherical shape, a shape close to a regular octahedron, a shape close to a regular dodecahedron, or a shape having any of these shapes with rounded corners. In the case where the positive electrode active material 100B has such a shape, the positive electrode active material 100B is easily oriented in a particular direction by application of a magnetic field during the formation of the positive electrode active material layer 22. Note that the shape of the positive electrode active material 100B is not limited to the above-described shape.

As the composite oxide having an olivine crystal structure belonging to the space group pnma, for example, LiM1PO₄ (Mb is one or more selected from Fe, Ni, Co, and Mn) can be used. Examples of LiM1PO₄ include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b is 1 or less, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e is 1 or less, 0<c<1, 0<d<1, and 0<e<1), and LiFe_{f}Ni_{g}CoₕMnᵢPO₄ (f+g+h+i is 1 or less, 0<f<1, 0<g<1, 0<h<1, and 0<i<1). Furthermore, a carbon coating layer may be provided on the particle surface of the composite oxide having an olivine crystal structure belonging to the space group pnma.

The positive electrode active material layer 22 in which the positive electrode active material 100B is oriented can be formed by application of a magnetic field during the formation of the positive electrode active material layer 22. The intensity of the magnetic field is preferably, for example, greater than or equal to 1T, greater than or equal to 2T, greater than or equal to 3T, greater than or equal to 4T, greater than or equal to 5T, greater than or equal to 6T, greater than or equal to 7T, greater than or equal to 8T, greater than or equal to 9T, greater than or equal to 10T, or greater than or equal to 15T. An electromagnet can be used as a method for applying the magnetic field.

FIG. 5A schematically illustrates the case where the positive electrode active material 100B has a shape with a certain side length that is not extremely long, i.e., a shape close to a cube, a shape close to a spherical shape, a shape close to a regular octahedron, a shape close to a regular dodecahedron, or a shape having any of these shapes with rounded corners. In the case where the positive electrode active material 100B has such a shape, the positive electrode active material 100B is easily oriented in a particular direction by application of a magnetic field during the formation of the positive electrode active material layer 22. Note that the shape of the positive electrode active material 100B is not limited to the above-described shape.

Alternatively, in the case where the positive electrode active material 100B is formed to have a shape with a certain side length that is extremely long, e.g., a plate-like shape, a flake-like shape, a wire-like shape, or a columnar shape and to have the short side direction that is the [010] direction of the crystal, the positive electrode active material layer 22 where the positive electrode active material 100B is oriented as illustrated in FIG. 5B can be obtained even when a magnetic field is not applied during the formation of the positive electrode active material layer 22.

This embodiment can be used in appropriate combination with any of the other embodiments.

### Embodiment 2

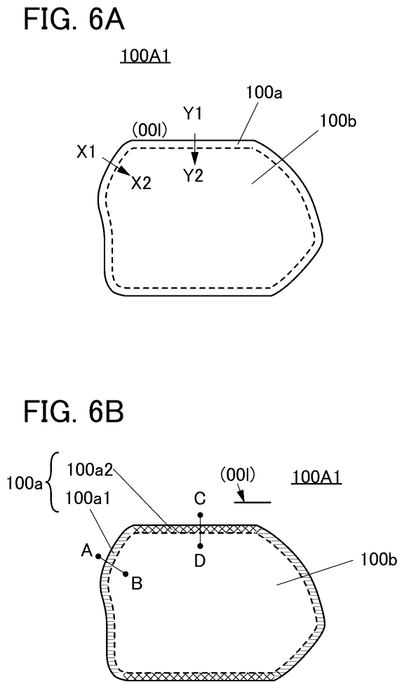

In this embodiment, as an example of the positive electrode active material 100 in Embodiment 1, the positive electrode active material 100A that is lithium cobalt oxide (also referred to as a lithium composite oxide containing cobalt) and a formation method thereof will be described with reference to FIG. 6A to FIG. 25.

FIG. 6A and FIG. 6B are each a cross-sectional view of a positive electrode active material 100A1 of one embodiment of the present invention. As illustrated in FIG. 6A, the positive electrode active material 100A1 includes a surface portion 100a and an inner portion 100b. In each drawing, the dashed line denotes a boundary between the surface portion 100a and the inner portion 100b. In the drawing, (00l) refers to a (00l) plane of lithium cobalt oxide (LiCoO₂). LiCoO₂ belongs to the space group R-3m.

The positive electrode active material 100A1 contains lithium, cobalt, oxygen, and an additive element. Alternatively, the positive electrode active material 100A1 contains lithium cobalt oxide to which an additive element is added.

As the additive element contained in the positive electrode active material 100A1, one or two or more selected from magnesium, nickel, aluminum, fluorine, titanium, zirconium, vanadium, iron, manganese, chromium, niobium, arsenic, zinc, silicon, sulfur, phosphorus, boron, bromine, and beryllium is preferably used.

Among the additive elements, the maximum value of the magnesium concentration in the surface portion 100a observed in EDX line analysis is preferably higher than or equal to 1 atomic %, further preferably higher than or equal to 10 atomic %. Alternatively, the magnesium concentration in the surface portion 100a is preferably higher than or equal to 3 atomic % and lower than or equal to 60 atomic %, further preferably higher than or equal to 3 atomic % and lower than or equal to 20 atomic %. Alternatively, the magnesium concentration in the surface portion 100a may be approximately 50 atomic %, for example, higher than or equal to 45 atomic % and lower than or equal to 55 atomic %. Magnesium is preferably dissolved in the surface portion of the positive electrode active material, and particularly preferably exists in lithium sites. As the amount of magnesium dissolved in the surface portion 100a is larger, the speed of current flowing into the positive electrode at the time of an internal short circuit of the secondary battery is expected to be lower. Accordingly, the secondary battery which is less likely to suffer thermal runaway and has higher safety can be provided. Note that the volume of the surface portion 100a is small with respect to the entire volume of the positive electrode active material 100A1; thus, it can be considered that the charge and discharge capacity of the positive electrode active material 100A1 hardly changes even when the concentration of the additive element in the surface portion 100a is as high as the above.

Among the additive elements, nickel also preferably exists in the surface portion 100a. Ni(II) holds promise for existing in lithium sites in the surface portion 100a to inhibit external release of magnesium. As a result, the magnesium concentration in the surface portion 100a can be further increased. Here, “external release” means, for example, dissolution from a positive electrode active material due to charge when the positive electrode active material is used for a secondary battery, and/or formation of a compound different from the positive electrode active material caused when some of magnesium fail to form a solid solution in a formation process of the positive electrode active material with heating and segregate at part of a surface or the like. A typical “compound different from a positive electrode active material” here is magnesium oxide.

Among the additive elements, titanium also preferably exists in the surface portion 100a. Existence of titanium in the surface portion 100a holds promise for an effect of promoting diffusion of lithium ions in charge and discharge. Thus, the charge and discharge rate may be improved. Furthermore, the existence of titanium has an effect of stabilizing the crystal structure by reducing the oxidation number of cobalt in lithium cobalt oxide by the charge of Ti(IV), in some cases.

Among the additive elements, fluorine also preferably exists in the surface portion 100a. Like nickel, fluorine holds promise for having a function of making magnesium to exist in the surface portion 100a stably.

Note that in this specification and the like, unless otherwise specified, the concentration (atomic %) of an element in the surface portion 100a refers to the concentration (atomic %) obtained by EDX line analysis including the surface portion 100a. Lithium is not detected in EDX and thus is not used for calculation of the concentration. Unless otherwise specified, the concentration (atomic %) of each element observed in EDX line analysis is the concentration (atomic %) when the sum of carbon, oxygen, fluorine, magnesium, aluminum, silicon, phosphorus, sulfur, calcium, titanium, manganese, iron, cobalt, nickel, and gallium is assumed to be 100 atomic %. Detailed description of EDX line analysis will be made later.

Note that when a plurality of additive elements exist in the surface portion 100a at the same time, the surface portion 100a can be stabilized in some cases as compared with the case where a single additive element exists in the surface portion 100a. Examples of the combination of the additive elements that preferably exist in the surface portion 100a include, in addition to “magnesium and fluorine” described above, “magnesium and aluminum”, “magnesium and nickel”, “magnesium and titanium”, “magnesium, nickel, and aluminum”, “magnesium, titanium, and aluminum”, “magnesium, fluorine, and aluminum”, “magnesium, fluorine, and nickel”, “magnesium, fluorine, and titanium”, “magnesium, nickel, fluorine, and aluminum”, and “magnesium, titanium, fluorine, and aluminum”.

The average value of the magnesium concentration in the inner portion 100b is preferably higher than or equal to 0.03 atomic % and lower than or equal to 1 atomic %.

The average value of the nickel concentration in the inner portion 100b is preferably higher than or equal to 100 ppm wt and lower than or equal to 300 ppm wt; that is, preferably higher than or equal to 0.0042 atomic % and lower than or equal to 0.0126 atomic %.

When the surface portion 100a and the inner portion 100b contain the additive element as described above, the composition and the crystal structure of the positive electrode active material 100A1 are more stable in charging. Thus, the positive electrode active material 100A1 can have an O3′ type crystal structure in charging. The positive electrode active material 100A1 having an O3′ type crystal structure in charging has extremely favorable charge and discharge cycle performance when used for a secondary battery. In addition, a high level of safety is expected.

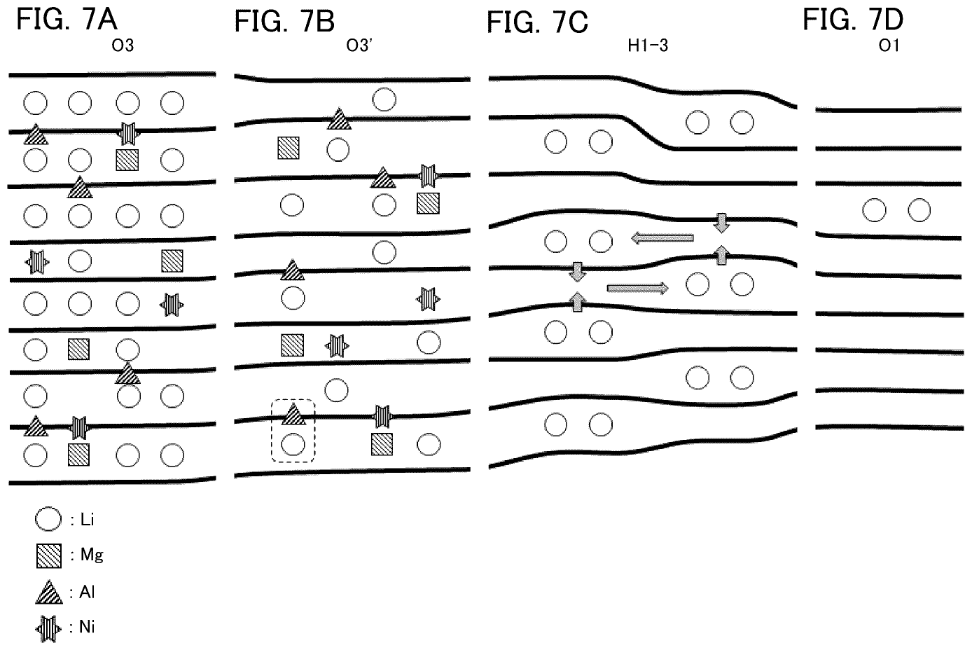

FIG. 7A to FIG. 7D are schematic diagrams illustrating phase changes in the crystal structure of the positive electrode active material due to lithium extraction. FIG. 7A is a schematic diagram of “O3” that is the crystal structure of the inner portion 100b of the positive electrode active material 100A1 of one embodiment of the present invention in a discharged state; that is, in a state where x in LiₓCoO₂ is 1. It is considered that magnesium and nickel exist in some of the lithium sites and aluminum and nickel exist in some of cobalt sites in the inner portion 100b.

FIG. 7B is a schematic diagram of “O3′” that is the crystal structure of the inner portion 100b of the positive electrode active material 100A1 of one embodiment of the present invention in a high-voltage charged state, e.g., when x in LiₓCoO₂ is approximately 0.2. The details of the O3′ type crystal structure will be described later. As in a portion surrounded by dotted lines, aluminum that exists in the cobalt sites probably inhibits extraction of nearby lithium. It is considered that magnesium and nickel exist in some of the lithium sites, as in the case of the discharged state. It is thus considered that lithium that exists in the inner portion 100b randomly exists in the lithium sites and does not form a cluster. It is considered that the cluster can be sufficiently small even in the case where the cluster is formed. Such an effect of the additive element inhibiting formation of a lithium-ion cluster is referred to as a pinning effect. This effect is probably dominantly due to the average interatomic distance between magnesium and oxygen. This effect inhibits contraction of the c-axis length of the positive electrode active material 100A1. Since the magnesium concentration in the surface portion 100a is high, the effect of inhibiting the c-axis length contraction is further increased, and the effect may spread to the inner portion 100b. The inhibition of the c-axis length contraction probably causes O3′ to appear in the inner portion 100b and directly below the surface portion 100a when x in LiₓCoO₂ is approximately 0.2.

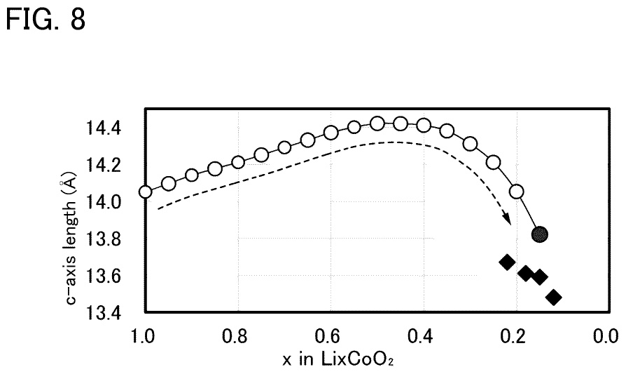

By contrast, FIG. 7C is a schematic diagram of the H1-3 phase that is the crystal structure of the case where no additive element is contained and x in LiₓCoO₂ is approximately 0.2. In that case, it is known that lithium in an inner portion of lithium cobalt oxide moves as indicated by arrows in the drawing to form a cluster and the phase changes to the H1-3 phase where a layer with lithium and a layer without lithium alternately appear (Non-Patent Document 5). It is also known that the c-axis length in lithium cobalt oxide changes with a phase change (Non-Patent Document 4). FIG. 8 shows a change in c-axis length of conventional lithium cobalt oxide described in Non-Patent Document 4. A dashed arrow in the drawing indicates the direction when charge is performed from a discharged state to a charged state. Circular markers indicate a hexagonal phase and rhombic markers indicate a monoclinic phase. The c-axis length contracts in an H1-3 phase as shown by the rhombic markers in FIG. 8. The phase transition from an O3 phase to an H1-3 phase is due to extraction of lithium ions, whereby a phase transition probably occurs from a surface of a positive electrode active material from which lithium ions are extracted first and eventually spreads to the entire positive electrode active material.

Even in the case where the additive element is contained, insufficient distribution of the additive element leads to H1-3 phase when x in LiₓCoO₂ is approximately 0.2. For example, when the maximum value of the magnesium concentration in the surface portion is lower than 1 atomic %, it is considered that the crystal structure does not change to O3′ because the c-axis length contracts.

Although not illustrated, a phase transition to a spinel phase is due to extraction of oxygen, so that the phase transition probably occurs from a surface from which oxygen is easily extracted. Lithium cobalt oxide exhibiting H1-3 when x in LiₓCoO₂ is approximately 0.2 contains no additive element in its surface portion or has insufficient additive element distribution in its surface portion; thus, oxygen may be easily extracted from the surface and a phase change to a spinel crystal structure may easily occur. A further phase change from the spinel crystal structure to a rock-salt crystal structure may easily occur. These phase changes may easily propagate particularly in the direction perpendicular to the c-axis. An increase in regions with the spinel crystal structure and the rock-salt crystal structure lowers the charge and discharge capacity of the positive electrode active material.

This means that the additive element such as nickel existing in the surface portion holds promise for having a function of inhibiting a phase change to a spinel phase.

A cation of a rock-salt oxide in the surface portion 100a is Mg(II) or Co(II). Cobalt in Co₃O₄ or LiCo₂O₄, which has a spinel crystal structure, is Co(II), Co(III), or Co(IV). Cobalt in LiCoO₂ in a discharged state is Co(III), and cobalt in LiₓCoO₂ (0<x<1) in a charged state is Co(III) or Co(IV). Thus, there is a possible tendency that, in LiₓCoO₂ (0<x<1) in a discharged state, a region between Co(IV) in the inner portion 100b and Co(II) or Mg(II) in the surface portion 100a changes to a spinel phase including Co(III) as a buffer.

It is known that when lithium is further extracted from the H1-3 phase, the crystal structure becomes the O1 phase as illustrated in FIG. 7D.

### (Formation Method 1 of Positive Electrode Active Material 100A1)

To obtain the positive electrode active material 100A1 in which the surface portion 100a and the inner portion 100b contain an additive element and O3′ is exhibited when x in LiₓCoO₂ is approximately 0.2 as described above, not only the additive element and its amount but also heating conditions in the formation process is important.

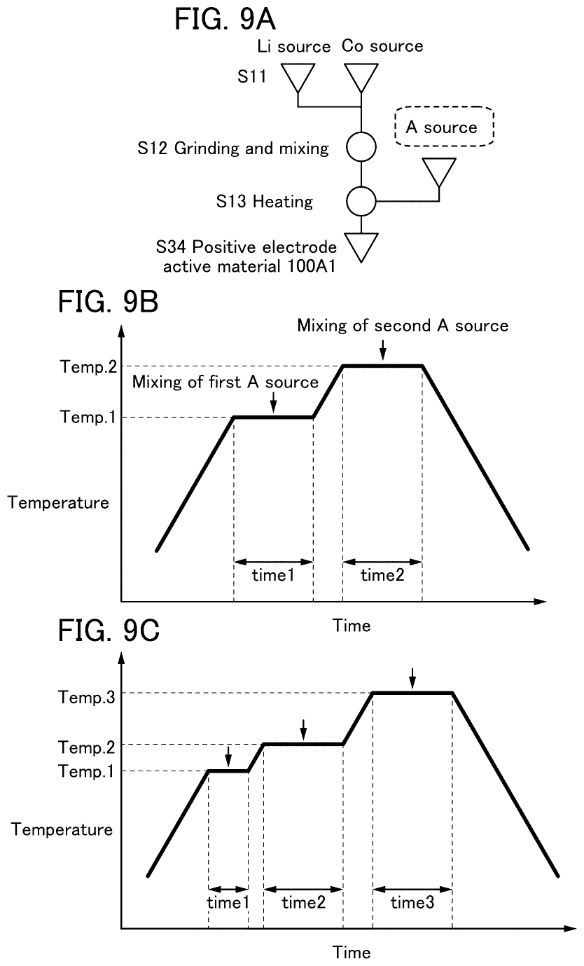

The positive electrode active material 100A1 can be formed by, for example, a flow shown in FIG. 9A.

### <Step S11>

In Step S11 shown in FIG. 9A, a lithium source (Li source) and a cobalt source (Co source) are prepared as materials for lithium and a transition metal that are starting materials.

As the lithium source, a lithium-containing compound is preferably used and for example, lithium carbonate, lithium hydroxide, lithium nitrate, or lithium fluoride can be used. The lithium source preferably has a high purity and is preferably a material having a purity higher than or equal to 99.99%, for example.

As the cobalt source, a cobalt-containing compound is preferably used, and for example, cobalt oxide such as tricobalt tetraoxide or cobalt hydroxide can be used.

The cobalt source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example. Impurities in the positive electrode active material can be controlled by using a high-purity material. As a result, the capacity of a secondary battery is increased and/or the reliability of the secondary battery is improved.

Furthermore, the cobalt source preferably has high crystallinity, and preferably includes single crystal particles, for example. The crystallinity of the cobalt source can be evaluated with a lattice image by a TEM (transmission electron microscope) device and a HAADF-STEM (high-angle annular dark-field scanning transmission electron microscope) image or an ABF-STEM (annular bright-field scanning transmission electron microscope) image by a STEM (scanning transmission electron microscope) device, for example, or by X-ray diffraction (XRD), electron diffraction, neutron diffraction, or the like. Note that the above methods for evaluating crystallinity can also be employed to evaluate the crystallinity of other materials in addition to the cobalt source.

### <Step S12>

Next, in Step S12 shown in FIG. 9A, the lithium source and the cobalt source are ground and mixed to form a mixed material. The grinding and mixing can be performed by a dry method or a wet method. A wet method is preferable because it can crush a material into a smaller size. When a wet method is employed, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is further preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% in the grinding and mixing. With the use of dehydrated acetone with the above-described purity, impurities that might be mixed can be reduced.

A ball mill, a bead mill, or the like can be used for the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, in Step S13 shown in FIG. 9A, the above mixed material is heated. The heating is preferably performed while changing the temperature in multiple stages. For example, the heating is preferably performed at the first heating temperature (Temp. 1) and then at the second heating temperature (Temp. 2) higher than the first heating temperature as shown in FIG. 9B.

The first heating step holds promise for an effect of reducing crystal defects of the positive electrode active material. The second heating step holds promise for an effect of diffusing the additive element in the surface portion of the positive electrode active material.

As indicated by arrows in the drawing, mixing of an additive element source (A source) is preferably performed in either or both of a period time 1 during which the first heating temperature is maintained and a period time 2 during which the second heating temperature is maintained. In that case, not only magnesium coating and diffusion but also nickel coating and aluminum diffusion are preferably performed on the outermost surface of the composite oxide. This can inhibit external release of magnesium. For this reason, magnesium, nickel, and aluminum are preferably mixed in either or both of time 1 and time 2.

In the case where the mixing of the additive element source is performed in both time 1 and time 2, mixing of a magnesium source and mixing of a nickel source are preferably performed at different timings. This is because when the mixings are performed at the same time, nickel might hinder magnesium from forming a solid solution with the positive electrode active material. It is preferable that, for example, mixing of the nickel source and mixing of an aluminum source be performed in the period time 1 during which the first heating temperature is maintained, and mixing of an aluminum source and mixing of a fluorine source be performed in the period time 2 during which the second heating temperature is maintained. Such a mixing order holds promise for facilitating distribution of nickel and aluminum in the inner portion 100b of the positive electrode active material 100A1.

Alternatively, the heating may be performed at the first heating temperature (Temp. 1), then at the second heating temperature (Temp. 2) higher than the first heating temperature, and finally at the third heating temperature (Temp. 3) higher than the second heating temperature, as shown in FIG. 9C. Also here, as indicated by arrows in the drawing, the mixing of the additive element source is preferably performed in any one or more of the period time 1 during which the first heating temperature is maintained, the period time 2 during which the second heating temperature is maintained, and a period time 3 during which the third heating temperature is maintained.

Performing heating, cooling to around room temperature, and then heating again, for example, might increase the formation cost of the positive electrode active material. Thus, the formation method of the positive electrode active material 100A1 of one embodiment of the present invention which requires one heat treatment as in FIG. 9A to FIG. 9C is preferable because of its high productivity.

Magnesium and nickel gather in the surface portion 100a by the heating step. It is considered that, in the heating step, intense thermal motion of lithium occurs along lithium sites. It is thus presumed that magnesium is pushed outward in the composite oxide so that the magnesium concentration in the surface portion 100a becomes high. Magnesium may be partly released to the outside of the composite oxide. The higher the temperature of the heating step is, the narrower the half width of the distribution of the additive element such as magnesium in the surface portion 100a can be.

On a basal plane containing a relatively small amount of nickel, aluminum is probably diffused from the surface toward the inner portion 100b while substituting for cobalt. In an edge region with a high nickel concentration, on the other hand, there is a possibility that nickel existing in cobalt sites inhibits diffusion of aluminum.

A container (also referred to as a saggar, a setter, a pot, or a crucible) used in the heating step such as that in Step S13 is preferably made of aluminum oxide. An aluminum oxide sagger is made of a material that hardly releases impurities. In this embodiment, a sagger made of aluminum oxide with a purity of 99.9% is used. Heating is preferably performed with the sagger covered with a lid, in which case volatilization of a material can be prevented. It is preferable that the additive element such as magnesium or fluorine be attached to the container in advance. For example, a container that has been subjected to a step of heating while containing the additive element source such as the magnesium source or the fluorine source and/or the lithium source in advance is preferably used in the heating step. The use of such a container may further increase the magnesium concentration in the surface portion 100a.

### <Step S34>

Through the above steps, the positive electrode active material 100A1 can be formed (Step S34).

### (Formation Method 2 of Positive Electrode Active Material 100A1)

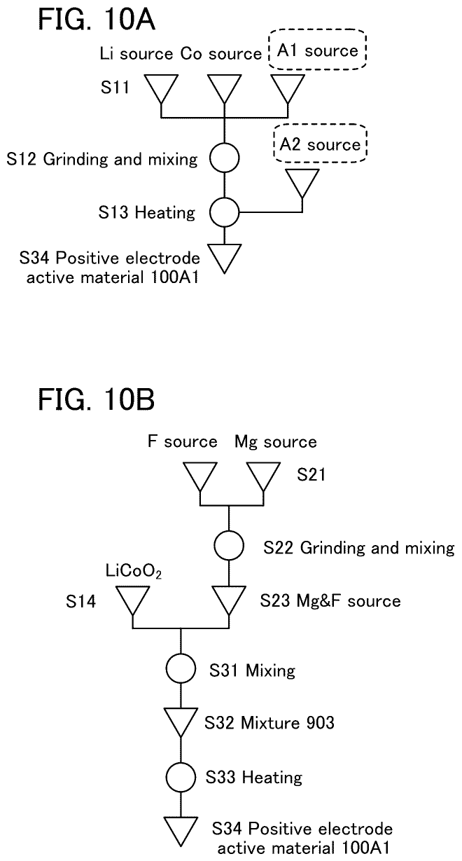

An additive element source may be mixed at the same time as a lithium source and a cobalt source in Step S11. For example, as in a flow shown in FIG. 10A, magnesium and/or nickel may be mixed as an A1 source in Step S11. In the case of using magnesium, the mixing is preferably performed at approximately 0.8 atomic %, for example, higher than or equal to 0.7 atomic % and lower than or equal to 0.9 atomic %. When the magnesium source is mixed at such a concentration in Step S11 and a heating step is performed, the maximum concentration of magnesium in the surface portion 100a can be 1 atomic %.

In that case, in Step S13, magnesium and/or nickel may be mixed again as an A2 source or another additive element may be mixed as the A2 source.

For the description except for the above, Formation method 1 of positive electrode active material can be referred to.

### (Formation Method 3 of Positive Electrode Active Material 100A1)

As in a flow shown in FIG. 10B, for example, an additive element may be mixed into pre-synthesized lithium cobalt oxide and then heating may be performed.

### <Step S14>

In Step S14, pre-synthesized lithium cobalt oxide is prepared. In that case, Step S11 to Step S13 can be skipped. In this embodiment, as LiCoO₂ in Step S14, commercially available lithium cobalt oxide (CELLSEED C-ION produced by Nippon Chemical Industrial Co., Ltd.) containing cobalt as a transition metal M and not containing any additive element is prepared.

### <Step S21>

In Step S21, lithium fluoride and magnesium fluoride are prepared as a fluorine source and a magnesium source, respectively, and weighed so that LiF:MgF₂=1:3 (molar ratio).

### <Step S22>

Then, LiF and MgF₂ are mixed into dehydrated acetone and the mixture is stirred at a rotating speed of 400 rpm for 12 hours, whereby an additive element source (Mg&F source) is formed. In the mixing, a ball mill can be used and a grinding medium can be zirconium oxide balls. For example, the F source and the Mg source that weighed approximately 9 g in total are put in a 45-mL-capacity container of the mixing ball mill together with 20 mL of dehydrated acetone and 22 g of zirconium oxide balls (1 mmφ) and mixed. After that, the mixture is made to pass through a sieve with an aperture of 300 μm, whereby the Mg&F source is obtained (Step S23).

### <Step S31>

Next, in Step S31, lithium cobalt oxide and the Mg&F source are mixed. For example, stirring can be performed at a rotating speed of 150 rpm for one hour. These conditions are milder than those of the stirring in the formation of the Mg&F source. Finally, the mixture is made to pass through a sieve with an aperture of 300 μm, whereby a mixture 903 having a uniform particle diameter is obtained (Step S32).

### <Step S33, Step S34>

Subsequently, in Step S33, the mixture 903 is heated, so that a positive electrode active material is obtained. For the steps in and after the heating, the description of Step S13 in Formation method 1 of positive electrode active material can be referred to.

### (Formation Method 4 of Positive Electrode Active Material 100A1)

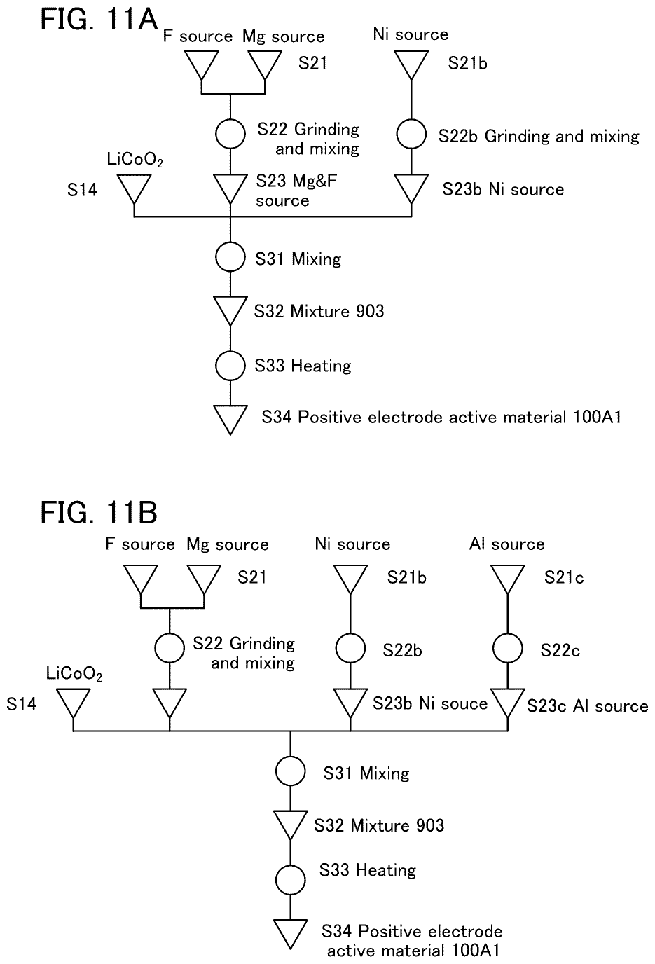

As in a flow shown in FIG. 11A, for example, in addition to a magnesium source and a fluorine source, a nickel source may be mixed into pre-synthesized lithium cobalt oxide and then heating may be performed.

### <Step S22b>

In Step S22b, nickel hydroxide on which a grinding step is performed is prepared as the nickel source and weighed to be 0.5 mol % with respect to lithium cobalt oxide.

For the subsequent steps, the descriptions of Formation methods 1 to 3 of positive electrode active material can be referred to.

### (Formation Method 5 of Positive Electrode Active Material 100A1)

As in a flow shown in FIG. 111B, for example, in addition to a magnesium source, a fluorine source, and a nickel source, an aluminum source may be mixed into pre-synthesized lithium cobalt oxide and then heating may be performed.

### <Step S22c>

In Step S22c, aluminum hydroxide on which a grinding step is performed is prepared as the aluminum source and weighed to be 0.5 mol % with respect to lithium cobalt oxide.

For the subsequent steps, the description of Formation method 4 of positive electrode active material can be referred to.

### (Formation Method 6 of Positive Electrode Active Material 100A1)

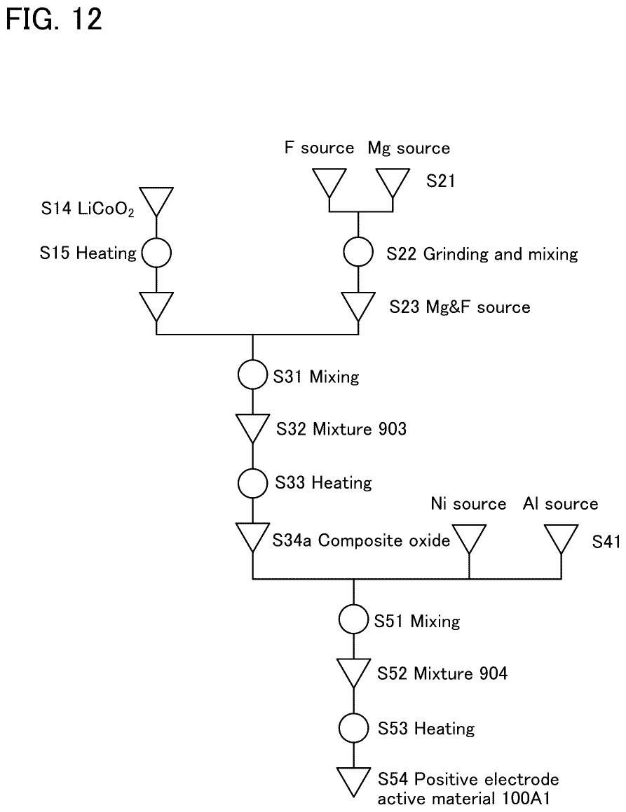

As in a flow shown in FIG. 12, for example, in addition to a magnesium source, a fluorine source, and a nickel source, an aluminum source may be mixed into pre-synthesized lithium cobalt oxide and then heating may be performed. Mixing and heating of the magnesium source and the fluorine source may be performed separately from mixing and heating of the nickel source and the aluminum source. It is further preferable that heating be also performed between synthesis of lithium cobalt oxide and mixing of the additive elements. This heating is referred to as initial heating in some cases.

### <Step S15>

In Step S15 in FIG. 12, the pre-synthesized lithium cobalt oxide is heated. Owing to influence of lithium extraction from part of the surface portion 100a of the lithium cobalt oxide by the heating, the distribution of the additive element becomes more favorable.

Specifically, the distributions of the additive elements can be easily made different from each other by the initial heating in the following mechanism. First, lithium is extracted from part of the surface portion 100a by the initial heating. Next, the additive element sources such as a nickel source, an aluminum source, and a magnesium source and lithium cobalt oxide including the surface portion 100a that is deficient in lithium are mixed and heated. Among the additive elements, magnesium is a divalent representative element, and nickel is a transition metal but is likely to be a divalent ion. Therefore, in part of the surface portion 100a, a rock-salt phase containing Co²⁺, which is reduced due to lithium deficiency, Mg²⁺, and Ni²⁺ is formed. Note that this phase is formed in part of the surface portion 100a, and thus is sometimes not clearly observed in an electron microscope image, such as a STEM image, and an electron diffraction pattern.

Among the additive elements, nickel is likely to form a solid solution and is diffused to the inner portion 100b in the case where the surface portion 100a is lithium cobalt oxide having a layered rock-salt crystal structure, but nickel is likely to remain in the surface portion 100a in the case where part of the surface portion 100a has a rock-salt crystal structure. Thus, the initial heating can make it easy for a divalent additive element such as nickel to remain in the surface portion 100a. The effect of this initial heating is large particularly at the surface having an orientation other than the (001) orientation of the positive electrode active material 100A1 and the surface portion 100a thereof.

Furthermore, in such a rock-salt crystal structure, the bond distance between a metal Me and oxygen (Me-O distance) tends to be longer than that in a layered rock-salt crystal structure.

For example, Me-O distance is 2.09×10⁻¹ nm and 2.11×10⁻¹ nm in Ni_{0.5}Mg_{0.5}O having a rock-salt crystal structure and MgO having a rock-salt crystal structure, respectively. Even when a spinel phase is formed in part of the surface portion 100a, Me-O distance is 2.0125×10⁻¹ nm and 2.02×10⁻¹ nm in NiAl₂O₄ having a spinel structure and MgAl₂O₄ having a spinel structure, respectively. In each case, Me-O distance is longer than 2×10⁻¹ nm.

Meanwhile, in a layered rock-salt crystal structure, the bond distance between oxygen and a metal other than lithium is shorter than the above-described distance. For example, Al—O distance is 1.905×10⁻¹ nm (Li—O distance is 2.11×10⁻¹ nm) in LiAlO₂ having a layered rock-salt crystal structure. In addition, Co—O distance is 1.9224×10⁻¹ nm (Li—O distance is 2.0916×10⁻¹ nm) in LiCoO₂ having a layered rock-salt crystal structure.

According to the ionic radius of Shannon (Shannon et al., Acta A 32 (1976) 751.), the ion radius of hexacoordinated aluminum and the ion radius of hexacoordinated oxygen are 0.535×10⁻¹ nm and 1.4×10⁻¹ nm, respectively, and the sum of those values is 1.935×10⁻¹ nm.

From the above, aluminum is considered to exist in a site other than a lithium site more stably in a layered rock-salt crystal structure than in a rock-salt crystal structure. Thus, in the surface portion 100a, aluminum is more likely to be distributed in a region having a layered rock-salt phase at a larger depth and/or the inner portion 100b than in a region having a rock-salt phase that is close to the surface.

Moreover, the initial heating can be expected to have an effect of increasing the crystallinity of the layered rock-salt crystal structure of the inner portion 100b.

For this reason, the initial heating is preferably performed in order to form the positive electrode active material 100A1 that has the monoclinic O1(15) type crystal structure particularly when x in LiₓCoO₂ is, for example, greater than or equal to 0.15 and less than or equal to 0.17.

However, the initial heating is not necessarily performed. In some cases, by controlling the atmosphere, temperature, time, or the like in another heating step, e.g., annealing, the positive electrode active material 100A1 that has the O3′ type structure and/or the monoclinic O1(15) type structure when x in LiₓCoO₂ is small can be formed.

### <Step S41>

In this embodiment, in Step S41, nickel hydroxide on which a grinding step is performed is prepared as the nickel source and aluminum hydroxide on which a grinding step is performed is prepared as the aluminum source. The nickel hydroxide is weighed to be 0.5 mol % with respect to lithium cobalt oxide, and the aluminum hydroxide is weighed to be 0.5 mol % with respect to lithium cobalt oxide.

### <Step S51>

In Step S51, the nickel source, the aluminum source, and a composite oxide formed in a manner similar to Formation method 3 of positive electrode active material are mixed.

For steps other than the above, the descriptions of Formation methods 1 to 5 of positive electrode active material can be referred to.

### (Formation Method 7 of Positive Electrode Active Material 100A1)

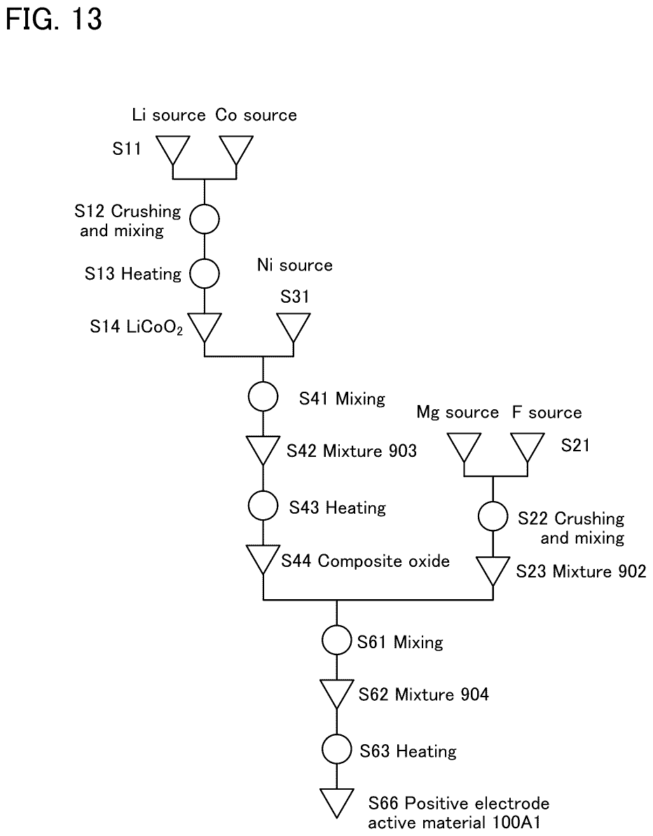

As in a flow shown in FIG. 13, for example, after at least one of a nickel source and an aluminum source is mixed into pre-synthesized lithium cobalt oxide and heating is performed, mixing of a magnesium source and a fluorine source may be performed and then heating may be performed again.

### <Step S31>

In this embodiment, in Step S31, nickel hydroxide on which a grinding step is performed is prepared as the nickel source, and aluminum hydroxide on which a grinding step is performed is prepared as the aluminum source. The nickel hydroxide is weighed to be 0.5 mol % with respect to lithium cobalt oxide. Although not illustrated, an aluminum source may be further prepared in Step S31. In the case of preparing the aluminum source, aluminum hydroxide on which a grinding step is performed is prepared and weighed to be 0.5 mol % with respect to lithium cobalt oxide.

For the subsequent steps, the descriptions of Formation methods 1 to 6 of positive electrode active material can be referred to.

### (Formation Method 8 of Positive Electrode Active Material 100A1)

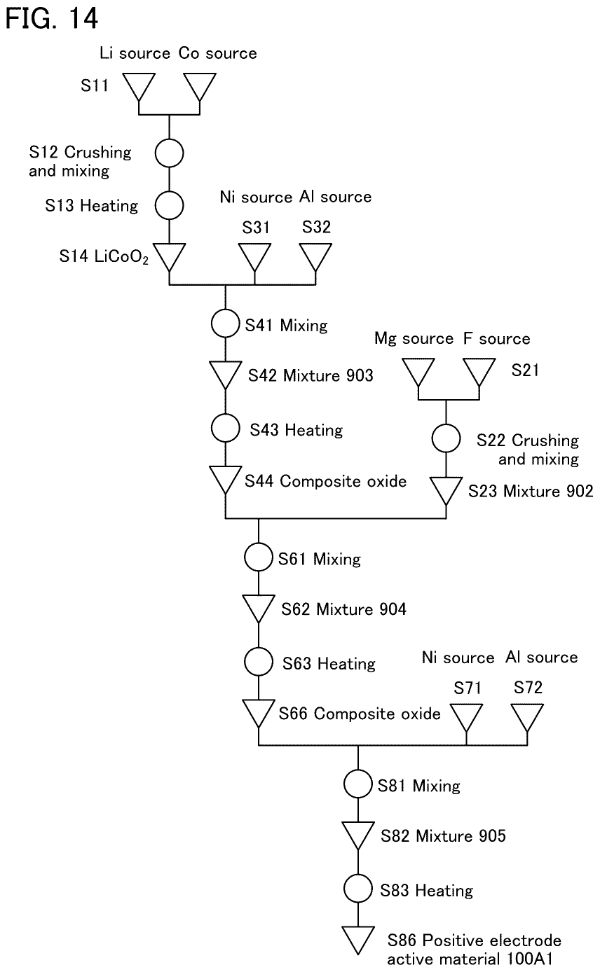

As in a flow shown in FIG. 14, for example, after at least one of a nickel source and an aluminum source is mixed into pre-synthesized lithium cobalt oxide and heating is performed, mixing of a magnesium source and a fluorine source and heating may be performed, and then mixing of at least one of a nickel source and an aluminum source and heating may be performed. For the steps in FIG. 14, the descriptions of Formation methods 1 to 7 of positive electrode active material can be referred to.

### (Heating)

The heating in Formation method 1 of positive electrode active material to Formation method 8 of positive electrode active material may be performed with a rotary kiln or a roller hearth kiln. Heating with stirring can be performed in either case of a sequential rotary kiln or a batch-type rotary kiln. As an example of a device that can be used for the heating, a batch-type rotary kiln is described below.

### <Batch-Type Rotary Kiln>

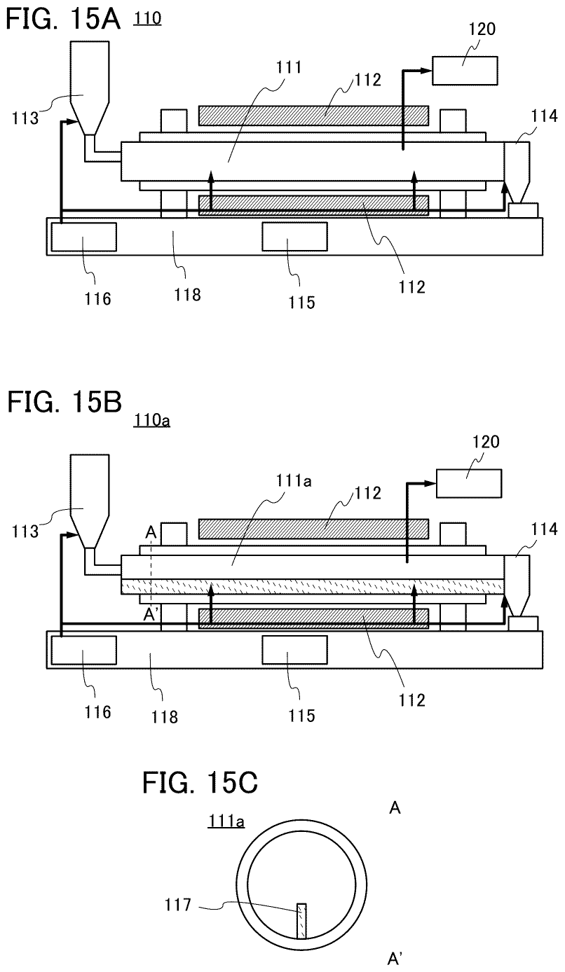

FIG. 15A is a schematic cross-sectional view of a batch-type rotary kiln 110. The rotary kiln 110 includes a kiln main body 111, a heating unit 112, a source material supply unit 113, and an atmosphere control unit 116. The rotary kiln 110 preferably includes a control board 115 and a measurement device 120. The kiln main body 111 is fixed to a plate 118.

The kiln main body 111 has a substantially cylindrical shape, the source material supply unit 113 is connected to one end of the kiln main body 111, and the other end of the kiln main body 111 is provided with a material collection unit 114. When rotating, the kiln main body has a function of stirring an object put into the kiln.

The heating unit 112 has a function of heating the kiln main body 111 to a temperature higher than or equal to 700° C. and lower than or equal to 1200° C. As the heating unit, a silicon carbide heater, a carbon heater, a metal heater, or a molybdenum disilicide heater can be used, for example.

The source material supply unit 113 has a function of putting an object into the kiln main body 111.

The atmosphere control unit 116 has a function of controlling an atmosphere inside the kiln main body 111. An example of the atmosphere control unit 116 is a gas introduction line. A gas to be introduced preferably contains oxygen.

The measurement device 120 can measure the atmosphere inside the kiln main body 111, for example. For the measurement device 120, gas chromatography (GC), a mass spectrometer (MS), GC-MS, infrared spectroscopy (IR), or Fourier transform-infrared spectroscopy (FT-IR) can be employed. By measuring the atmosphere, more specifically partial pressures of lithium fluoride, oxygen, and the like, in the kiln main body 111, whether the heating conditions are preferable can be ascertained. Note that the measurement device 120 may be a measurement device for a factor other than an atmosphere as long as whether the heating conditions are preferable can be ascertained. For example, as the measurement device 120, a quartz crystal oscillation type film thickness meter or the like may be provided in the exhaust port or the vicinity thereof. By measuring the thickness of lithium fluoride that is exhausted, cooled down, and deposited with the quartz crystal oscillation type film thickness meter, the lithium fluoride can be measured quantitatively. Note that a plurality of the measurement devices 120 may be provided, or a plurality of kinds of measurement devices may be provided.

The control board 115 can control the heating temperature, the atmosphere, and the like of the kiln main body 111. The control board 115 preferably has a function of supplying signals to the heating unit 112 and the atmosphere control unit 116. The heating unit 112 preferably has a function of performing heating on the basis of the signal supplied from the control board 115. The atmosphere control unit 116 preferably has a function of introducing a gas on the basis of the signal supplied from the control board 115, for example.

Information of measurement data obtained by the measurement device 120 is preferably supplied to the control board 115. The control board 115 has a function of analyzing the information of the measurement data obtained by the measurement device 120 and a function of controlling the heating unit 112, the atmosphere control unit 116, and the like on the basis of the analysis results, for example.

The heating unit 112 can determine the output of the heater or the like on the basis of the information of the measurement data obtained by the measurement device 120. The atmosphere control unit 116 can determine the flow rate of a gas or whether or not a gas is supplied, for example, on the basis of the information of the measurement data obtained by the measurement device 120.

Since the rotary kiln 110 can stir the object by rotating the kiln main body 111 during heating, particles of the object are unlikely to adhere to one another. That is, a step of rotating the kiln main body 111 corresponds to an adhesion preventing step.

The batch-type rotary kiln as illustrated in FIG. 15A is preferable because atmosphere control is easy.

As illustrated in FIG. 15B and FIG. 15C, a rotary kiln 110a including a kiln main body 111a in which a blade 117 for stirring is provided may be employed. FIG. 15B is a schematic cross-sectional view of the batch-type rotary kiln 110a, and FIG. 15C is a cross-sectional view of the kiln main body 11a taken along A-A′ in FIG. 15B.

Although FIG. 15B and FIG. 15C illustrate the kiln main body 11a provided with one linear blade 117 as an example, one embodiment of the present invention is not limited to this. A plurality of the blades 117 may be provided. The blade 117 may have another shape such as a helical shape.

### <Another Example of Batch-Type Rotary Kiln>

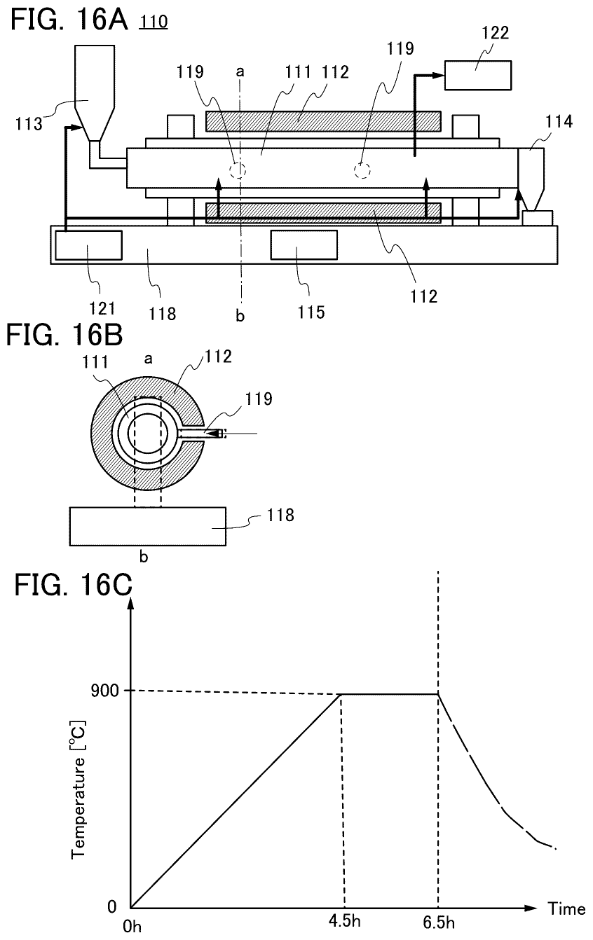

FIG. 16A shows another example of a schematic cross-sectional view of the batch-type rotary kiln 110. The rotary kiln 110 includes the kiln main body 111, which is a rotating drum, the heating unit 112, a vibration unit 119, the source material supply unit 113, and the material collection unit 114. The rotary kiln 110 includes the control board 115, a gas supply unit 121, and a gas exhaust unit 122. Although not illustrated in the gas exhaust unit 122, a pump for exhausting a gas inside the kiln main body 111, a valve for preventing the backflow of a gas, a detoxification device (a combustion detoxification device or a plasma detoxification device) for detoxicating a gas before its release to the outside air, or the like may be provided. Since a fluoride gas is used, it is preferable to use pipes including a material that is unlikely to react with a fluoride gas on an inner wall as pipes for supplying a gas, and a plurality of valves may be provided for each of the pipes to prevent gas leakage. It is preferable to use a material that is unlikely to react with a fluoride gas not only for the pipes but also for components used for joint portions, e.g., a joint portion between a pipe and a furnace, a joint portion between a pipe and the gas supply unit 121, and a joint portion between a pipe and the gas exhaust unit 122.

FIG. 16B is a schematic cross-sectional view of the batch-type rotary kiln 110 taken along a chain line ab in FIG. 16A.

As illustrated in FIG. 16B, the kiln main body 111 has a cylindrical shape, and an outer cylinder portion, i.e., the heating unit 112 is provided to surround an inner cylinder portion, i.e., the kiln main body 111. The kiln main body 111 is fixed to the plate 118. Part of the heating unit 112 includes an opening, and the vibration unit 119 is provided to be in contact with the inner cylinder portion. The step of preventing powder adhesion to an inner wall of a core tube is performed by moving the vibration unit 119 to apply an impact or vibration only to the kiln main body 111.

Furthermore, heating can be performed while the inner cylinder portion, i.e., the core tube of the kiln main body 111 added with a powder is rotated or while a container (pot) where the powder is put and covered with a lid is placed inside the core tube of the kiln main body 111 and rotated. As the container, for example, a container made of aluminum oxide can be used.

FIG. 16C shows an example of a time chart of heat treatment. In FIG. 16C, after the temperature reaches 900° C. at the temperature rising rate of 200° C. for one hour, the temperature is maintained at 900° C. for two hours and then natural cooling is performed. FIG. 16C shows an example in which the core tube is vibrated from the start of heating up to 6.5 hours and the vibration is stopped in natural cooling.

### <Surface Portion and Inner Portion>

In this specification and the like, the surface portion 100a of the positive electrode active material 100A1 refers to a region that is within 50 nm, preferably within 35 nm, further preferably within 20 nm in depth from the surface toward the inner portion, and most preferably a region positioned within 10 nm in depth in a perpendicular direction or a substantially perpendicular direction from the surface toward the inner portion. Note that “substantially perpendicular” refers to a state where an angle is greater than or equal to 800 and less than or equal to 100°. A plane generated by a split and/or a crack can also be referred to as a surface. The surface portion 100a can be rephrased as the vicinity of a surface, a region in the vicinity of a surface, or a shell.

As illustrated in FIG. 6B, the surface portion 100a includes an edge region 100al and a basal region 100a2. Note that in FIG. 6A and FIG. 6B, a straight line denoted by (00l) represents a (00l) plane. Here, the edge region 100al has a surface exposed in a direction intersecting with the (00l) plane, and a region within 50 nm in depth from the surface toward the inner portion, preferably within 35 nm in depth from the surface toward the inner portion, further preferably within 20 nm in depth from the surface toward the inner portion, most preferably within 10 nm in depth in a perpendicular direction or a substantially perpendicular direction from the surface toward the inner portion is referred to as the edge region 100al. Here, “intersect” means that an angle between a line perpendicular to a first plane (the (00l) plane) and a line normal to a second plane (a surface of the positive electrode active material 100A1) is greater than or equal to 10° and less than or equal to 90°, preferably greater than or equal to 30° and less than or equal to 90°.

Moreover, the basal region 100a2 has a surface parallel to the (00l) plane, and a region within 50 nm in depth from the surface toward the inner portion, preferably within 35 nm in depth from the surface toward the inner portion, further preferably within 20 nm in depth from the surface toward the inner portion, most preferably within 10 nm in depth in a perpendicular direction or a substantially perpendicular direction from the surface toward the inner portion is referred to as the basal region 100a2. Here, “parallel” means that an angle between the line perpendicular to the first plane (the (00) plane) and the line normal to the second plane (the surface of the positive electrode active material 100A1) is greater than or equal to 0° and less than or equal to 5°, preferably greater than or equal to 0° and less than or equal to 2.5°.

The inner portion 100b refers to a region deeper than the surface portion 100a of the positive electrode active material. The inner portion 100b can be rephrased as an inner region or a core.

A surface of the positive electrode active material 100A1 refers to a surface of a composite oxide including the surface portion 100a, the inner portion 100b, and the like. Thus, the positive electrode active material 100A1 does not contain a material to which a metal oxide that does not contain a lithium site contributing to charge and discharge, such as aluminum oxide (Al₂O₃), is attached, or a carbonate, a hydroxy group, or the like which is chemically adsorbed after formation of the positive electrode active material. The attached metal oxide refers to, for example, a metal oxide having a crystal structure different from that of the inner portion 100b.

Furthermore, an electrolyte, an organic solvent, a binder, a conductive material, and a compound originating from any of these that are attached to the positive electrode active material 100A1 are not contained either.

Peaks of the amounts of magnesium and nickel detected are preferably observed in a region within 3 nm from the surface or the reference point. The distribution of magnesium and that of nickel preferably overlap with each other. The peak of the detected amount of magnesium and that of the detected amount of nickel are at the same depth, the peak of magnesium may be closer to the surface, or the peak of nickel may be closer to the surface. The difference in depth between the peak of the detected amount of nickel and the peak of the detected amount of magnesium is preferably less than or equal to 3 nm, further preferably less than or equal to 1 nm.

As in the case of magnesium or nickel, the detected amount of fluorine is preferably larger in the surface portion 100a than in the inner portion. A peak of the detected amount of fluorine is preferably located in a region of the surface portion 100a that is closer to the surface. For example, the detected amount preferably has the peak within 3 nm from the surface or a reference point. Similarly, the detected amounts of titanium, silicon, phosphorus, boron, and/or calcium are/is also preferably larger in the surface portion 100a than in the inner portion. The peaks of the detected amounts are preferably located in a region of the surface portion 100a that is closer to the surface. For example, the detected amounts preferably have the peaks within 3 nm from the surface or a reference point.

It is further preferable that the distribution of aluminum be different from that of magnesium and that of nickel described above. For example, it is further preferable that a peak of the amount of aluminum detected and the peaks of the amounts of magnesium and nickel detected in the surface portion 100a be exhibited at different depths from the surface or the reference point in EDX line analysis described later. The peak of the detected amount here refers to the local maximum value of the detected amount in the surface portion 100a or a region ranging from the surface to 50 nm or less. The detected amount refers to counts in EDX line analysis, for example. The distribution of magnesium and that of aluminum may overlap with each other, or there may be almost no overlap between the distribution of magnesium and that of aluminum. A peak of the detected amount of aluminum may be located in the surface portion 100a or may be located deeper than the surface portion 100a. For example, the peak is preferably observed in a region ranging from the surface or the reference point toward the inner portion to a depth of greater than or equal to 5 nm and less than or equal to 30 nm.

In such a manner, aluminum is distributed more inwardly than magnesium presumably because the diffusion rate of aluminum is higher than that of magnesium. It is presumed that aluminum is diffused to the inner portion while substituting for cobalt. Meanwhile, the detected amount of aluminum is small in the region that is the closest to the surface, which is presumably because aluminum can exist more stably in a region other than a region where magnesium or the like at a high concentration forms a solid solution.

As in the case of aluminum, a peak of the amount of manganese detected is preferably observed in a region that is located inward from a region where a peak of the amount of magnesium detected is observed.

Note that the additive elements do not necessarily have similar concentration gradients and similar distributions throughout the surface portion 100a of the positive electrode active material 100A1. The arrow Y1-Y2 is illustrated in FIG. 6 as a depth direction example of the (00l) plane of lithium cobalt oxide of the positive electrode active material 100A1.

The additive element distribution at the surface having a (001) orientation, which is crossed by the arrow Y1-Y2, may be different from that at other surfaces. For example, the surface having a (001) orientation and the surface portion 100a thereof may have a lower detected amount of one or two or more elements selected from the additive elements than a surface having an orientation other than a (001) orientation. Specifically, the detected amount of magnesium and/or nickel may be smaller. Alternatively, at the surface having a (001) orientation and the surface portion 100a thereof, one or two or more selected from the additive elements may be detected at 1 at % or less, or may not be detected. Specifically, it is acceptable that nickel is not detected or the detected amount thereof is 1 atomic % or less. Especially in the case of EDX or any other analysis method by which characteristic X-rays are detected, the energy of Kβ for cobalt is close to that of Kα, for nickel and it is thus difficult to detect a slight amount of nickel in a material whose main element is cobalt. At the surface having a (001) orientation and the surface portion 100a thereof, the peaks of the detected amounts of one or two or more selected from the additive elements may be located shallow from the surface as compared with the surface having an orientation other than a (001) orientation. Specifically, the peaks of the detected amounts of magnesium and aluminum may be located at positions shallower from the surface than the peaks of the detected amounts of magnesium and aluminum at other surface.

In a layered rock-salt crystal structure belonging to R-3m, cations are arranged parallel to the (001) plane. In other words, CoO₂ layers and lithium layers are alternately stacked parallel to the (001) plane. Accordingly, a diffusion path of lithium ions also exists parallel to the (001) plane.

The CoO₂ layer is relatively stable and thus, the surface of the positive electrode active material 100A1 is more stable when having a (001) orientation. A main diffusion path of lithium ions in charge and discharge is not exposed at the (001) plane.

By contrast, a diffusion path of lithium ions is exposed at the surface having an orientation other than a (001) orientation. Thus, the surface having an orientation other than a (001) orientation and the surface portion 100a thereof easily lose stability because they are regions where extraction of lithium ions starts as well as important regions for maintaining a diffusion path of lithium ions. It is thus extremely important to reinforce the surface having an orientation other than a (001) orientation and the surface portion 100a thereof so that the crystal structure of the whole positive electrode active material 100A1 is maintained.

Accordingly, in the positive electrode active material 100A1 of another embodiment of the present invention, it is important that the additive element at the surface having an orientation other than a (001) orientation and the surface portion 100a thereof is the above-described distribution. By contrast, at the surface having a (001) orientation and the surface portion 100a thereof, the concentration of the additive element may be low or the additive element may be absent.

For example, the half width of the distribution of magnesium at the surface having a (001) orientation and the surface portion 100a thereof is preferably greater than or equal to 10 nm and less than or equal to 200 nm, further preferably greater than or equal to 50 nm and less than or equal to 150 nm, still further preferably greater than or equal to 80 nm and less than or equal to 120 nm. The half width of the distribution of magnesium at the surface having an orientation other than a (001) orientation and the surface portion 100a thereof is preferably greater than 200 nm and less than or equal to 500 nm, further preferably greater than 200 nm and less than or equal to 300 nm, still further preferably greater than or equal to 230 nm and less than or equal to 270 nm.

The half width of the distribution of nickel at the surface having an orientation other than a (001) orientation and the surface portion 100a thereof is preferably greater than or equal to 30 nm and less than or equal to 150 nm, further preferably greater than or equal to 50 nm and less than or equal to 130 nm, still further preferably greater than or equal to 70 nm and less than or equal to 110 nm.

### [Magnesium]

Magnesium is divalent, and a magnesium ion is more stable in lithium sites than in cobalt sites in a layered rock-salt crystal structure; thus, magnesium is likely to enter the lithium sites. An appropriate concentration of magnesium in the lithium sites of the surface portion 100a can facilitate maintenance of the layered rock-salt crystal structure. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the positive electrode active material 100A1. In addition, a high concentration of magnesium in the surface portion 100a can be expected to increase the corrosion resistance to hydrofluoric acid generated by the decomposition of an electrolyte solution.

An appropriate concentration of magnesium does not have an adverse effect on insertion and extraction of lithium in charge and discharge, and the above-described advantages can be obtained. However, excess magnesium might adversely affect insertion and extraction of lithium. Furthermore, the effect of stabilizing the crystal structure might be reduced. This is probably because magnesium enters the cobalt sites in addition to the lithium sites. Moreover, an excess magnesium compound (e.g., an oxide and a fluoride) which is substituted for neither the lithium site nor the cobalt site might segregate at the surface of the positive electrode active material or the like to serve as a resistance component of a secondary battery. As the concentration of magnesium in the positive electrode active material increases, the discharge capacity of the positive electrode active material decreases in some cases. This is probably because excess magnesium enters the lithium sites and the amount of lithium contributing to charge and discharge decreases.

Thus, the entire positive electrode active material 100A1 preferably contains an appropriate amount of magnesium. For example, the number of magnesium atoms is preferably greater than or equal to 0.002 times and less than or equal to 0.06 times, further preferably greater than or equal to 0.005 times and less than or equal to 0.03 times, still further preferably approximately 0.01 times the number of cobalt atoms. The amount of magnesium contained in the entire positive electrode active material 100A1 here may be a value obtained by element analysis on the entire positive electrode active material 100A1 using GD-MS, ICP-MS, or the like, or may be a value based on the ratio of the raw materials mixed in the formation process of the positive electrode active material 100A1, for example.

### [Nickel]

Nickel in a layered rock-salt crystal structure of LiMeO₂ can exist in both the cobalt site and the lithium site. Since nickel has a lower oxidation-reduction potential than cobalt, when nickel exists in the cobalt site, lithium and electrons can be regarded as being easily released during charge, for example. As a result, the charge and discharge speed is expected to be increased. Accordingly, even at the same charge voltage, higher charge and discharge capacity can be obtained in the case where the transition metal M is nickel than in the case where the transition metal M is cobalt. It is known that a phase change of LiNiO₂ to the H1-3 phase or the O1 phase does not easily occur even when the charge depth is increased. Thus, nickel existing in cobalt sites has an effect of further stabilizing the O3 structure.

In addition, when nickel exists in the lithium sites, a shift in the layered structure formed of octahedrons of cobalt and oxygen can be inhibited. Moreover, a change in volume in charge and discharge is inhibited. Thus, as well as magnesium, nickel existing in lithium sites functions as a column supporting CoO₂ layers and inhibits a phase change to the H1-3 phase. In a high-voltage charged state, nickel existing in cobalt sites moves to lithium sites in some cases. Thus, in particular, the crystal structure can be expected to be more stable in a charged state at high temperatures, e.g., 45° C. or higher, which is preferable.

The distance between a cation and an anion of nickel oxide (NiO) is closer to the average of the distance between a cation and an anion of LiCoO₂ than those of rock-salt MgO and rock-salt CoO, and the orientations of NiO and LiCoO₂ are likely to be aligned with each other.

Ionization tendency is the lowest in nickel (Ni), followed in order by cobalt (Co), aluminum (Al), and magnesium (Mg) (Mg>Al>Co>Ni). Therefore, it can be considered that in charge, nickel is less likely to be dissolved into an electrolyte solution than the other elements described above. Accordingly, nickel can be considered to have a high effect of stabilizing the crystal structure of the surface portion in a charged state.

Furthermore, in nickel, Ni²⁺ is the most stable among Ni²⁺, Ni³⁺, and Ni⁴⁺, and nickel has higher trivalent ionization energy than cobalt. Thus, it is known that a spinel crystal structure does not appear only with nickel and oxygen. Therefore, nickel can be considered to have an effect of inhibiting a phase change from a layered rock-salt crystal structure to a spinel crystal structure.

Meanwhile, excess nickel increases the influence of distortion due to the Jahn-Teller effect, which is not preferable. Moreover, excess nickel might adversely affect insertion and extraction of lithium. A too high nickel concentration might decrease the heat resistance when such a material is used for a secondary battery. Furthermore, acceptable temperature and time ranges for a formation process, in particular, a heating step might be narrowed. This is because when nickel becomes NiO(II) in a heating step, the crystal structure does not return to a layered rock-salt crystal structure.

Thus, the entire positive electrode active material 100A1 preferably contains an appropriate amount of nickel. For example, in the positive electrode active material 100A1, the number of nickel atoms is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by element analysis on the entire positive electrode active material by GD-MS, ICP-MS, or the like, or may be a value based on the ratio of the raw materials mixed in the process of forming the positive electrode active material, for example.

### [Aluminum]

Aluminum can exist in the cobalt site in a layered rock-salt crystal structure. Since aluminum is a trivalent representative element and its valence does not change, lithium around aluminum is unlikely to move even in charge and discharge. Thus, aluminum and lithium therearound serve as columns to inhibit a change in the crystal structure. This would reduce degradation of the positive electrode active material 100A1 if force of expansion and contraction of the positive electrode active material 100A1 in the c-axis direction operates owing to insertion and extraction of lithium ions, i.e., if force of expansion and contraction in the c-axis direction operates owing to a change in charge depth or charge rate, as described later.

Furthermore, aluminum has effects of inhibiting dissolution of cobalt around aluminum and improving continuous charge tolerance. Moreover, an Al—O bond is stronger than a Co—O bond; thus, extraction of oxygen around aluminum can be inhibited. These effects improve thermal stability. Hence, a secondary battery including the positive electrode active material 100A1 containing aluminum as the additive element can have improved safety. Furthermore, the positive electrode active material 100A1 can have a crystal structure that is unlikely to be broken by repeated charge and discharge.

Meanwhile, excess aluminum might adversely affect insertion and extraction of lithium. Since lithium around aluminum is unlikely to move, the discharge capacity of the positive electrode active material might be reduced.

Thus, the entire positive electrode active material 100A1 preferably contains an appropriate amount of aluminum. For example, in the entire positive electrode active material 100A1, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. Here, the amount of aluminum contained in the entire positive electrode active material 100A1 may be a value obtained by element analysis on the entire positive electrode active material 100A1 with GD-MS, ICP-MS, or the like or may be a value based on the ratio of the raw materials mixed in the process of forming the positive electrode active material 100A1, for example.

### [Fluorine]

When fluorine exists at the surface portion 100a including the surface that is in contact with an electrolyte solution, or when fluoride is attached to the surface, an overreaction between the positive electrode active material 100A1 and the electrolyte solution can be inhibited. In addition, the corrosion resistance to hydrofluoric acid can be effectively increased.

A fluoride such as lithium fluoride can function as a fusing agent (also referred to as a flux agent) for lowering the melting point of the other additive element sources. Owing to the flux effect, at least part of the surface portion of lithium cobalt oxide and at least part of the additive element source are probably melted in a heating step to form a mixed layer. This flux effect can increase the substitution efficiency of the another additive element. The lowering the melting point enables sintering of a liquid phase to start at a lower temperature, leading to an increase in crystallinity of the positive electrode active material 100A1, in some cases.

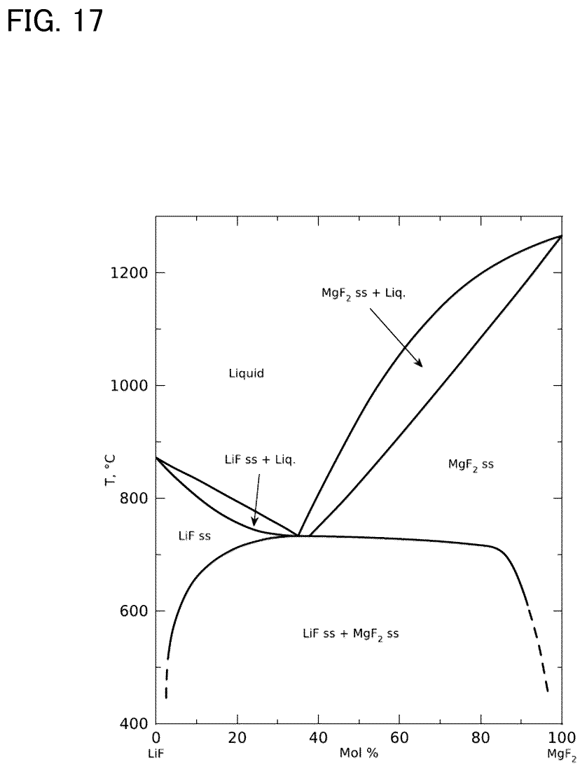

In the case where the fluoride contains LiF and MgF₂, for example, as shown in FIG. 17 (cited from Non-Patent Document 14), since the eutectic point of LiF and MgF₂ is around 742° C., the heating temperature in the heating step after the mixing of the additive element is preferably higher than or equal to 742° C. A mixture obtained by mixing at LiCoO₂:LiF:MgF₂=100:0.33:1 (molar ratio) exhibits an endothermic peak at around 830° C. in DSC measurement. Thus, it is further preferable that the heating temperature in the heating step after the mixing of the additive element be higher than or equal to 830° C. Alternatively, the heating temperature may be higher than or equal to 800° C., which is between the above temperatures.

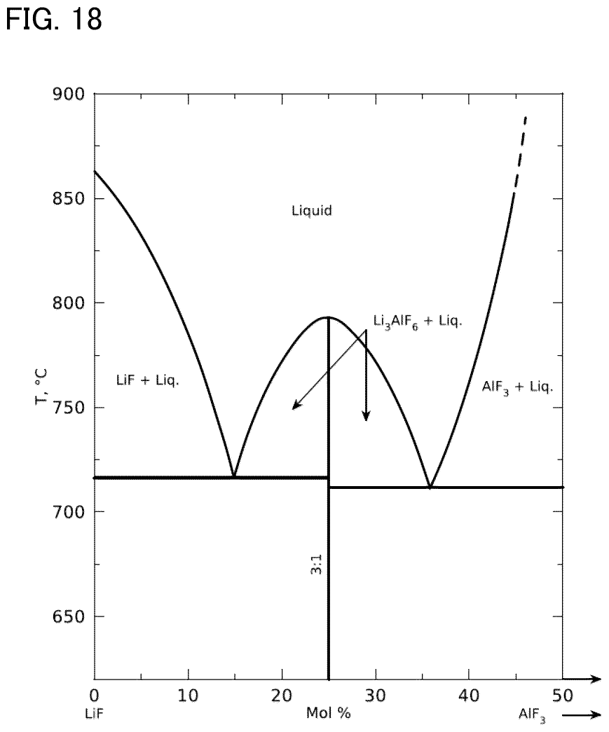

As shown in FIG. 18 (cited from Non-Patent Document 15), there are two eutectic points of LiF and AlF₃, each of which is around 720° C. Thus, in the case where the fluoride contains LiF and AlF₃, it is preferable that the heating temperature in the heating step after the mixing of the additive element be higher than or equal to 725° C.

### [Other Additive Elements]

When titanium exists in the surface portion 100a, an effect of promoting diffusion of lithium ions in charge and discharge is expected. Meanwhile, excess titanium might lead to the absorption of magnesium from lithium cobalt oxide and formation of a heterophase on the surface, such as MgTiO₃.

When the surface portion 100a contains phosphorus, a short circuit can be inhibited while a state with small x in LiₓCoO₂ is maintained, in some cases, which is preferable. For example, a compound containing phosphorus and oxygen preferably exists in the surface portion 100a.

When the positive electrode active material 100A1 contains phosphorus, phosphorus may react with hydrogen fluoride generated by the decomposition of the electrolyte solution or the electrolyte, which can decrease the concentration of hydrogen fluoride in the electrolyte and is thus preferable.

In the case where the electrolyte contains LiPF₆, hydrogen fluoride might be generated by hydrolysis. In addition, hydrogen fluoride might be generated by the reaction of polyvinylidene fluoride (PVDF) used as a component of the positive electrode and alkali. The decrease in the hydrogen fluoride concentration in the electrolyte can inhibit corrosion of a current collector and/or separation of a coating portion in some cases. Furthermore, a reduction in adhesion properties due to gelling and/or insolubilization of PVDF can be inhibited in some cases.

The positive electrode active material 100A1 preferably contains magnesium and phosphorus, in which case the stability in a state with small x in LiₓCoO₂ is extremely high. In the case where the positive electrode active material 100A1 contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, it is preferably greater than or equal to 1% and less than or equal to 10%. Alternatively, it is preferably greater than or equal to 1% and less than or equal to 8%. Alternatively, it is preferably greater than or equal to 2% and less than or equal to 20%. Alternatively, it is preferably greater than or equal to 2% and less than or equal to 8%. Alternatively, it is preferably greater than or equal to 3% and less than or equal to 20%. Alternatively, it is preferably greater than or equal to 3% and less than or equal to 10%. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, it is preferably greater than or equal to 0.1% and less than or equal to 5%. Alternatively, it is preferably greater than or equal to 0.1% and less than or equal to 4%. Alternatively, it is preferably greater than or equal to 0.5% and less than or equal to 10%. Alternatively, it is preferably greater than or equal to 0.5% and less than or equal to 4%. Alternatively, it is preferably greater than or equal to 0.7% and less than or equal to 10%. Alternatively, it is preferably greater than or equal to 0.7% and less than or equal to 5%. The concentrations of phosphorus and magnesium described here may each be a value obtained by element analysis on the entire positive electrode active material 100A1 by GD-MS, ICP-MS, or the like, or may be a value based on the ratio of the raw materials mixed in the formation process of the positive electrode active material 100A1, for example.

In the case where the positive electrode active material 100A1 has a crack, crack development can be inhibited by phosphorus, more specifically, a compound containing phosphorus and oxygen, for example, being in the inner portion of the positive electrode active material having the crack on its surface, e.g., a filling portion.

### [Synergistic Effect Between a Plurality of Additive Elements]

When the surface portion 100a contains both magnesium and nickel, divalent nickel can exist more stably in the vicinity of divalent magnesium. Thus, dissolution of magnesium might be inhibited even when x in LiₓCoO₂ is small. This can contribute to stabilization of the surface portion 100a.

For a similar reason, when the additive element is added to lithium cobalt oxide in the formation process, magnesium is preferably added in a step before addition of nickel. Alternatively, magnesium and nickel are preferably added in the same step. While magnesium has a large ion radius and thus is likely to remain in the surface portion of lithium cobalt oxide regardless of in which step magnesium is added, nickel may be widely diffused to the inner portion of lithium cobalt oxide when magnesium is absent. Thus, when nickel is added before magnesium is added, nickel might be diffused to the inner portion of lithium cobalt oxide and a preferable amount of nickel might not remain in the surface portion.

Additive elements that are differently distributed are preferably contained at a time, in which case the crystal structure in a wider region can be stabilized. For example, the stable crystal structure can be obtained in a wider region in the case where the positive electrode active material 100A1 contains, in the surface portion 100a, magnesium and nickel distributed in a region closer to the surface and aluminum distributed in a region deeper than magnesium and nickel, than in the case where only one or two of the additive elements are contained. In the case where the positive electrode active material 100A1 contains the additive elements that are differently distributed as described above, the surface can be sufficiently stabilized by magnesium, nickel, or the like; thus, aluminum is not necessary for the surface. It is preferable that aluminum be widely distributed in a deeper region. For example, it is preferable that aluminum be continuously detected in a region ranging from a depth from the surface of 1 nm or more to a depth from the surface of 25 nm or less. Aluminum is preferably widely distributed in a region ranging from a depth from the surface of 0 nm or more to a depth from the surface of 100 nm or less, further preferably a region ranging from a depth from the surface of 0.5 nm or more to a depth from the surface of 50 nm or less, in which case the crystal structure of a wider region can be stabilized.

When a plurality of the additive elements are contained as described above, the effects of the additive elements contribute synergistically to further stabilization of the surface portion 100a. In particular, magnesium, nickel, and aluminum are preferably contained, in which case a high effect of stabilizing the composition and the crystal structure can be obtained.

Note that the surface portion 100a occupied by only a compound of an additive element and oxygen is not preferable because the surface portion 100a would make insertion and extraction of lithium difficult. For example, it is not preferable that the surface portion 100a be occupied by only MgO, a structure in which MgO and NiO(II) form a solid solution, and/or a structure in which MgO and CoO(II) form a solid solution. Thus, the surface portion 100a should contain at least cobalt, also contain lithium in a discharged state, and have the path through which lithium is inserted and extracted.

To ensure the sufficient path through which lithium is inserted and extracted, the concentration of cobalt is preferably higher than that of magnesium in the surface portion 100a. For example, when measurement by XPS is performed from the surface of the positive electrode active material 100A1, Mg/Co, which is the ratio of the number of magnesium atoms Mg to the number of cobalt atoms Co is preferably less than or equal to 0.62. Alternatively, the concentration of cobalt is preferably higher than that of nickel in the surface portion 100a. Alternatively, the concentration of cobalt is preferably higher than that of aluminum in the surface portion 100a. Alternatively, the concentration of cobalt is preferably higher than that of fluorine in the surface portion 100a.

Moreover, excess nickel might hinder diffusion of lithium; thus, the concentration of magnesium is preferably higher than that of nickel in the surface portion 100a. For example, when measurement by XPS is performed from the surface of the positive electrode active material 100A1, the number of nickel atoms is preferably ⅙ or less of that of magnesium atoms.

It is preferable that some additive elements, in particular, magnesium, nickel, and aluminum have higher concentrations in the surface portion 100a than in the inner portion 100b and exist randomly also in the inner portion 100b to have low concentrations. When magnesium and aluminum exist in the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of cobalt and oxygen can be inhibited in a manner similar to the above. Also in the case where both magnesium and nickel are contained, a synergistic effect of inhibiting dissolution of magnesium can be expected in a manner similar to the above.

It is preferable that the crystal structure continuously change from the inner portion 100b toward the surface owing to the above-described concentration gradient of the additive element. Alternatively, the crystal orientations of the surface portion 100a and the inner portion 100b are preferably substantially aligned with each other.

For example, a crystal structure preferably changes continuously from the layered rock-salt inner portion 100b toward the surface and the surface portion 100a that have a rock-salt crystal structure or have features of both a rock-salt crystal structure and a layered rock-salt crystal structure. Alternatively, the orientation of the surface portion 100a that has a rock-salt crystal structure or has the features of both a rock-salt crystal structure and a layered rock-salt crystal structure and the orientation of the inner portion 100b having the layered rock-salt crystal structure are preferably substantially aligned with each other.

In this specification and the like, a layered rock-salt crystal structure, which belongs to the space group R-3m, of a composite oxide containing lithium and a transition metal such as cobalt, nickel, manganese, and iron refers to a crystal structure in which a rock-salt ion arrangement where cations and anions are alternately arranged is included and lithium and the transition metal are regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal is distorted in some cases.

A rock-salt crystal structure refers to a structure in which a cubic crystal structure such as a crystal structure belonging to the space group Fm-3m is included and cations and anions are alternately arranged. Note that a cation or anion vacancy may be included.

Having features of both a layered rock-salt crystal structure and a rock-salt crystal structure can be determined by electron diffraction, a TEM image, a cross-sectional STEM image, and the like.

There is no distinction among cation sites in a rock-salt crystal structure. Meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point (000), the bright spot nearest to the center spot is on the (111) plane in an ideal rock-salt crystal structure, for instance, and on the (003) plane in a layered rock-salt crystal structure, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, for instance, when two phases of rock-salt MgO and layered rock-salt LiCoO₂ are included in a region to be analyzed, a plane orientation in which bright spots with high luminance and bright spots with low luminance are alternately arranged is seen in an electron diffraction pattern. A bright spot common between the rock-salt crystal structure and the layered rock-salt crystal structure has high luminance, whereas a bright spot caused only in the layered rock-salt crystal structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium exists in part of the layers with low luminance, i.e., the lithium layers.

Anions of a layered rock-salt crystal and anions of a rock-salt crystal form a cubic close-packed structure (face-centered cubic lattice structure). Anions of an O3′ crystal and a monoclinic O1(15) crystal described later are presumed to form a cubic close-packed structure. Thus, when a layered rock-salt crystal and a rock-salt crystal are in contact with each other, there is a crystal plane at which orientations of cubic close-packed structures formed of anions are aligned with each other.

The description can also be made as follows. Anions on the {111}plane of a cubic crystal structure have a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111}plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that a space group of the layered rock-salt crystal and the O3′ crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ crystal is different from that in the rock-salt crystal. In this specification, in the layered rock-salt crystal, the O3′ crystal, and the rock-salt crystal, a state where the orientations of the cubic close-packed structures formed of anions are aligned with each other may be referred to as a state where crystal orientations are substantially aligned with each other. In addition, topotaxy refers to having similarity in a three-dimensional structure such that crystal orientations are substantially aligned with each other, or to having the same orientations crystallographically.

The crystal orientations in two regions being substantially aligned with each other can be determined, for example, from a TEM (Transmission Electron Microscope) image, a STEM (Scanning Transmission Electron Microscope) image, a HAADF-STEM (High-angle Annular Dark Field Scanning TEM) image, an ABF-STEM (Annular Bright-Field Scanning Transmission Electron Microscope) image, and an electron diffraction pattern. It can be determined also from an FFT pattern of a TEM image or an FFT pattern of a STEM image or the like. Furthermore, XRD (X-ray Diffraction), neutron diffraction, and the like can also be used for judging.

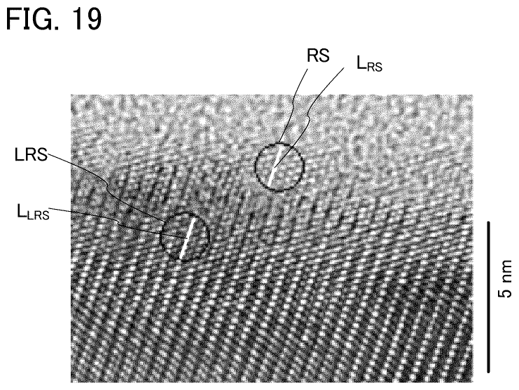

FIG. 19 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a layered rock-salt type composite hexagonal lattice, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., LRS and LLRS in FIG. 19) is less than or equal to 5° or less than or equal to 2.5° in the TEM image, it can be determined that the crystal planes are substantially aligned with each other, that is, orientations of the crystals are substantially aligned with each other. Similarly, when the angle between the dark lines is less than or equal to 5° or less than or equal to 2.5°, it can be judged that the crystal orientations are substantially aligned with each other.

In a HAADF-STEM image, a contrast proportional to the atomic number is obtained, and an element having a larger atomic number is observed to be brighter. For example, in the case of lithium cobalt oxide that has a layered rock-salt structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed in the direction perpendicular to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is less than or equal to 5° or less than or equal to 2.5° in a HAADF-STEM image, it can be judged that arrangements of the atoms are substantially aligned with each other, that is, orientations of the crystals are substantially aligned with each other. Similarly, when the angle between the dark lines is less than or equal to 5° or less than or equal to 2.5°, it can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

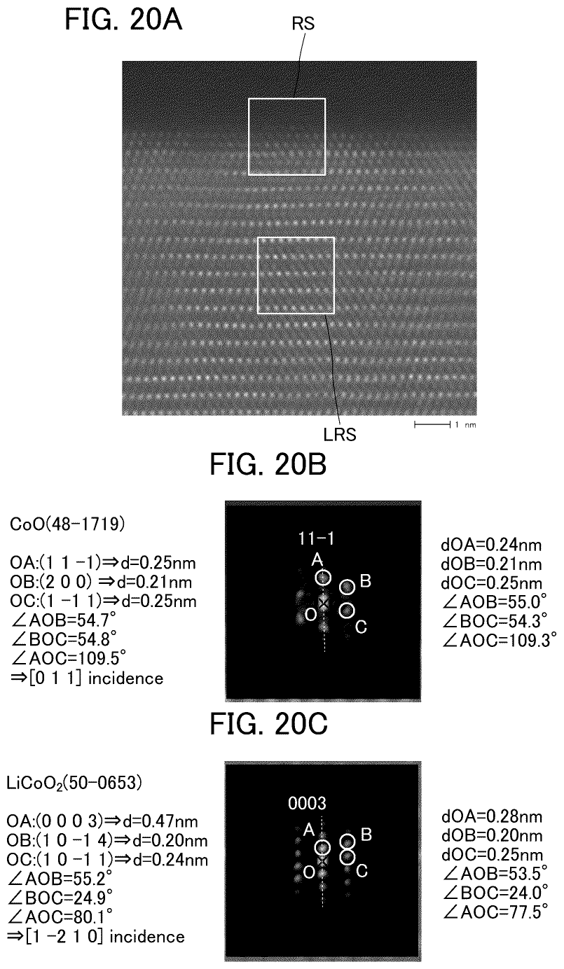

FIG. 20A shows an example of a STEM image in which orientations of the layered rock-salt crystal LRS and the rock-salt crystal RS are substantially aligned with each other. FIG. 20B shows an FFT pattern of a region of the rock-salt crystal RS, and FIG. 20C shows an FFT pattern of a region of the layered rock-salt crystal LRS. In FIG. 20B and FIG. 20C, the composition, the JCPDS card number, and d values and angles to be calculated are shown on the left. The measured values are shown on the right. A spot denoted by O is zero-order diffraction.

A spot denoted by A in FIG. 20B is derived from 11-1 reflection of a cubic structure. A spot denoted by A in FIG. 20C is derived from 0003 reflection of a layered rock-salt structure. It is found from FIG. 20B and FIG. 20C that the direction of the 11-1 reflection of the cubic structure and the direction of the 0003 reflection of the layered rock-salt structure are substantially aligned with each other. That is, a straight line that passes through AO in FIG. 20B is substantially parallel to a straight line that passes through AO in FIG. 20C. Here, the terms “substantially aligned” and “substantially parallel” mean that the angle is less than or equal to 5° or less than or equal to 2.5°.

When the orientations of the layered rock-salt crystal and the rock-salt crystal are substantially aligned with each other in the above manner in an FFT pattern and an electron diffraction pattern, the <0003> orientation of the layered rock-salt crystal and the <11-1> orientation of the rock-salt crystal may be substantially aligned with each other. In that case, it is preferable that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot denoted by B in FIG. 20C is derived from 10-14 reflection of the layered rock-salt structure. This is sometimes observed at a position where the difference in orientation from the reciprocal lattice point derived from the 0003 reflection of the layered rock-salt structure (A in FIG. 20C) is greater than or equal to 520 and less than or equal to 560 (i.e., ∠AOB is greater than or equal to 520 and less than or equal to 56°) and d is greater than or equal to 0.19 nm and less than or equal to 0.21 nm. Note that these indices are just an example, and the spot does not necessarily correspond with them. For example, the spot may be a reciprocal lattice point equivalent to 0003 and 10-14.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 20B is derived from 200 reflection of the cubic structure. This diffraction spot is sometimes observed at a position where the difference in orientation from the spot derived from the 11-1 reflection of the cubic structure (A in FIG. 20B) is greater than or equal to 540 and less than or equal to 560 (i.e., ∠AOB is greater than or equal to 540 and less than or equal to 56°). Note that these indices are just an example, and the spot does not necessarily correspond with them. For example, the spot may be a reciprocal lattice point equivalent to 11-1 and 200.

It is known that in a layered rock-salt positive electrode active material, such as lithium cobalt oxide, the (0003) plane and a plane equivalent thereto and the (10-14) plane and a plane equivalent thereto are likely to be crystal planes. Thus, to observe the (0003) plane with a TEM or the like, for example, a positive electrode active material particle in which a crystal plane that is presumably the (0003) plane is observed with a SEM or the like is preferably selected first; then, the positive electrode active material particle is preferably processed to be thin using an FIB (Focused Ion Beam) or the like so that the (0003) plane can be observed with the TEM or the like with an electron beam thereof entering in [12-10]. To determine whether crystal orientations are aligned, the particle is preferably processed to be thin so that the (0003) plane of the layered rock-salt structure is easily observed.

<<State where x in LiₓCoO₂ is Small>>

The crystal structure in a state where x in LiₓCoO₂ is small of the positive electrode active material 100A1 of one embodiment of the present invention is different from that of a conventional positive electrode active material because the positive electrode active material 100A1 has the above-described additive element distribution and/or crystal structure in a discharged state. Here, “x is small” means 0.1<x≤0.24.

<<State where x in LiₓCoO₂ is Small>>

The crystal structure in a state where x in LiₓCoO₂ is small of the positive electrode active material 100A1 of one embodiment of the present invention is different from that of a conventional positive electrode active material because the positive electrode active material 100A1 has the above-described additive element distribution and/or crystal structure in a discharged state. Here, “x is small” means 0.1<x≤0.24.

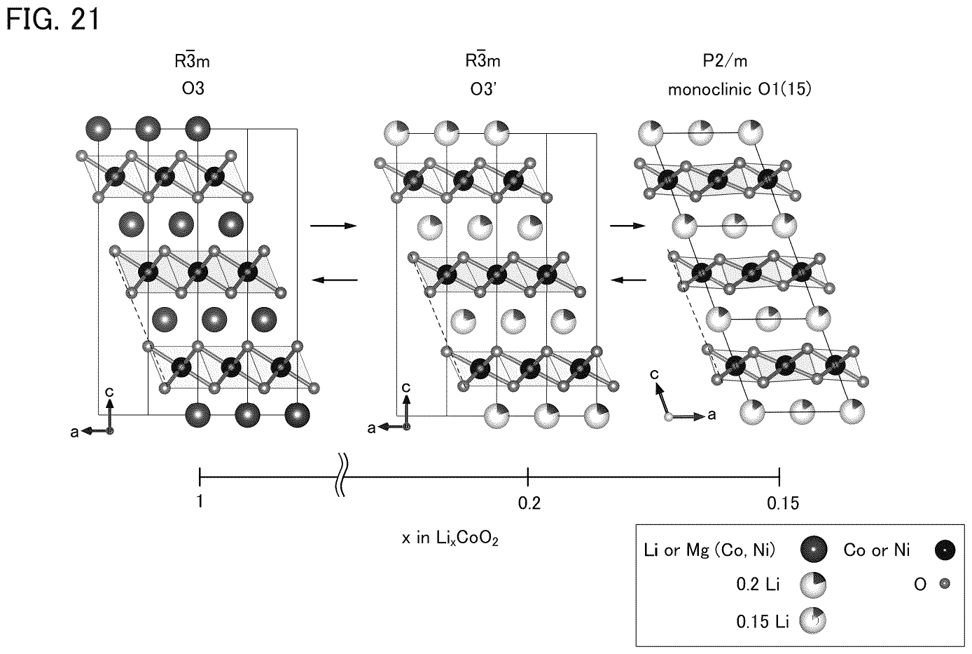

A conventional positive electrode active material and the positive electrode active material 100A1 of one embodiment of the present invention are compared and changes in crystal structures owing to a change in x in LiₓCoO₂ will be described with reference to FIG. 21 to FIG. 25.

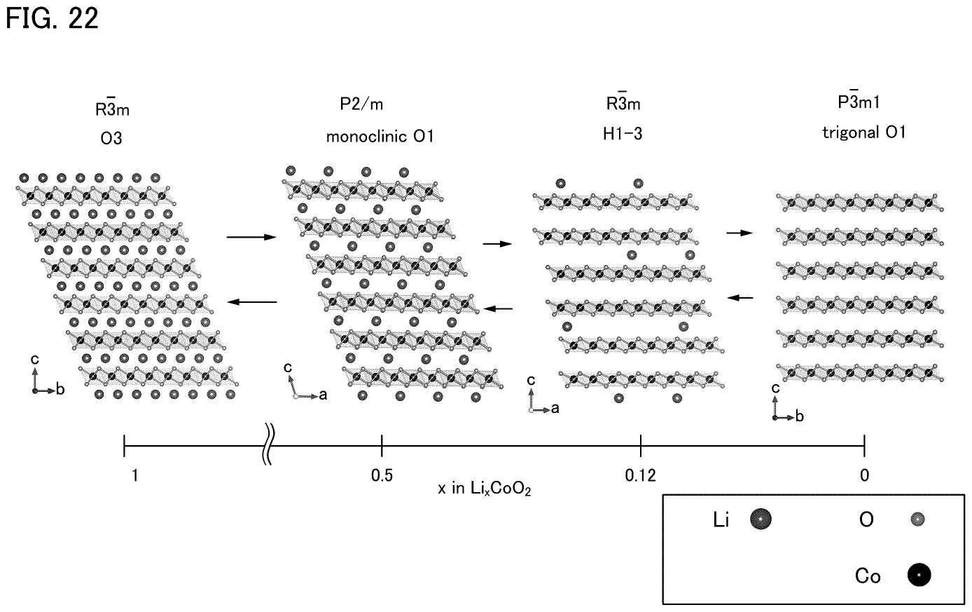

A change in the crystal structure of the conventional positive electrode active material is illustrated in FIG. 22. The conventional positive electrode active material shown in FIG. 22 is lithium cobalt oxide (LiCoO₂) containing no additive element. A change in the crystal structure of lithium cobalt oxide containing no additive element is described in Non-Patent Document 1 to Non-Patent Document 4 and the like.

In FIG. 22, the crystal structure of lithium cobalt oxide with x in LiₓCoO₂ of 1 is denoted by R-3m O3. In this crystal structure, lithium occupies octahedral sites and a unit cell includes three CoO₂ layers. Thus, this crystal structure is referred to as an O3 type crystal structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x being approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure belonging to the space group P-3m1 and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

Conventional lithium cobalt oxide with x being approximately 0.12 has the crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that since insertion and extraction of lithium do not necessarily uniformly occur in the positive electrode active material in reality, the lithium concentrations can vary; thus, the H1-3 type crystal structure is started to be observed when x is approximately 0.25 in practice. The number of cobalt atoms per unit cell in the actual H1-3 type crystal structure is twice that in other structures. However, in this specification including FIG. 22, the c-axis of the H1-3 type crystal structure is half that of the unit cell for easy comparison with the other crystal structures.

For the H1-3 type crystal structure, as disclosed in Non-Patent Document 3, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure in a positive electrode active material can be judged by the Rietveld analysis of XRD patterns, for example. In this case, a unit cell is selected such that the value of GOF (goodness of fit) is small.

When charge that makes x in LiₓCoO₂ be 0.24 or less and discharge are repeated, the crystal structure of conventional lithium cobalt oxide repeatedly changes between the R-3m O3 type structure in a discharged state and the H1-3 type crystal structure (i.e., an unbalanced phase change).

However, there is a large shift in the CoO₂ layers between these two crystal structures. As denoted by the dotted lines and the arrows in FIG. 22, the CoO₂ layer in the H1-3 type crystal structure largely shifts from that in the structure belonging to R-3m O3 in a discharged state. Such a dynamic structural change can adversely affect the stability of the crystal structure.

A difference in volume between these two crystal structures is also large. The crystal structure and the volume of the unit cell of lithium cobalt oxide change in accordance with a change in charge depth, i.e., a change in x in LiₓCoO₂.

A change in c-axis length of lithium cobalt oxide corresponds to a change in the angle at which a peak of, for example, the (003) plane of lithium cobalt oxide appears in an XRD pattern. It is known that a peak of the (003) plane of lithium cobalt oxide appears at around 2θ=19° to 20° in XRD using CuKα1 radiation.

Thus, the difference in volume per the same number of cobalt atoms between the R-3m O3 type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charge that makes x be 0.24 or less and discharge are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium.

On the other hand, in the positive electrode active material 100A1 of one embodiment of the present invention shown in FIG. 21, a change in the crystal structure between a discharged state with x in LiₓCoO₂ being 1 and a state with x being 0.24 or less is smaller than that in a conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100A1 of one embodiment of the present invention can have a crystal structure that is difficult to break even when charge that makes x be 0.24 or less and discharge are repeated, and enables excellent cycle performance. In addition, the positive electrode active material 100A1 of one embodiment of the present invention with x in LiₓCoO₂ being 0.24 or less can have a more stable crystal structure than a conventional positive electrode active material. Thus, the positive electrode active material 100A1 of one embodiment of the present invention with x in LiₓCoO₂ being kept at 0.24 or less inhibits a short circuit. This is preferable because the safety of the secondary battery is improved.

FIG. 21 shows crystal structures of the inner portion 100b of the positive electrode active material 100A1 in a state where x in LiₓCoO₂ is approximately 1, in a state where x in LiₓCoO₂ is approximately 0.2, and in a state where x in LiₓCoO₂ is approximately 0.15. The inner portion 100b, accounting for the majority of the volume of the positive electrode active material 100A1, largely contributes to charge and discharge and is accordingly a portion where a shift in CoO₂ layers and a volume change matter most.

The positive electrode active material 100A1 with x being 1 has the R-3m O3 type crystal structure, which is the same as that of conventional lithium cobalt oxide.

However, the positive electrode active material 100A1 has a crystal structure different from the H1-3 type crystal structure when x is 0.24 or less, e.g., approximately 0.2 or approximately 0.15, with which conventional lithium cobalt oxide has the H1-3 type crystal structure.

The positive electrode active material 100A1 of one embodiment of the present invention with x being approximately 0.2 has a trigonal crystal structure belonging to the space group R-3m. The symmetry of the CoO₂ layers of this structure is the same as that of O3. Thus, this crystal structure is called an O3′ type crystal structure. In FIG. 21, this crystal structure is denoted by R-3m O3′.

In the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (×10⁻¹ nm), further preferably 2.807≤a≤2.827 (×10⁻¹ nm), typically a=2.817 (×10⁻¹ nm). The lattice constant of the c-axis is preferably 13.681≤c≤13.881 (×10⁻¹ nm), further preferably 13.751≤c≤13.811 (×10⁻¹ nm), typically c=13.781 (×10⁻¹ nm).

When x is approximately 0.15, the positive electrode active material 100A1 of one embodiment of the present invention has a monoclinic crystal structure belonging to the space group P2/m. This structure includes one CoO₂ layer in a unit cell. Here, lithium in the positive electrode active material 100A1 is approximately 15 atomic % of that in a discharged state. Thus, this crystal structure is referred to as a monoclinic O1(15) type crystal structure. In FIG. 21, this crystal structure is denoted by P2/m monoclinic O1(15).

In the unit cell of the monoclinic O1(15) type crystal structure, the coordinates of cobalt and oxygen can be represented within the ranges below:
Co1 (0.5, 0, 0.5),
Co2 (0, 0.5, 0.5),
O1 (X_{O1}, 0, Z_{O1}),
0.23≤X_{O1}≤0.24, 0.61≤Z_{O1}≤0.65,
O2 (X_{O2}, 0.5, Z_{O2}), and
where 0.75≤X_{O2}≤0.78 and 0.68≤Z_{O2}≤0.71. In addition, the lattice constant of the unit cell is as follows:
a=4.880±0.05 (×10⁻¹ nm),
b=2.817±0.05 (×10⁻¹ nm),
c=4.839±0.05 (×10⁻¹ nm),
α=900,
β=109.6±0.1°, and
γ=90°.

Note that this crystal structure can have the lattice constants even when belonging to the space group R-3m if a certain error is allowed. The coordinates of cobalt and oxygen in the unit cell in this case can be represented by
Co (0, 0, 0.5),
O(0, 0, Z_{O}),
within the range of 0.21≤Z_{O}≤0.23. The lattice constant of the unit cell is as follows:
a=2.817±0.02 (×10⁻¹ nm), and
c=13.68±0.1 (×10⁻¹ nm).

In both of the O3′ type crystal structure and the monoclinic O1(15) type crystal structure, an ion of cobalt, nickel, magnesium, or the like occupies a site coordinated to six oxygen atoms. Note that light elements such as lithium and magnesium sometimes occupy a site coordinated to four oxygen atoms.

As denoted by the dotted lines in FIG. 21, the CoO₂ layers hardly shift between the R-3m O3 type crystal structure in the discharged state, the O3′ type crystal structure, and the monoclinic O1(15) type crystal structure.

The R-3m O3 type crystal structure in a discharged state and the O3′ type crystal structure which contain the same number of cobalt atoms have a difference in volume of 2.5% or less, specifically 2.2% or less, typically 1.8%.

The R-3m O3 type crystal structure in a discharged state and the monoclinic O1(15) type crystal structure which contain the same number of cobalt atoms have a difference in volume of 3.3% or less, specifically 3.0% or less, typically 2.5%.

Table 1 shows a difference in volume per cobalt atom between the R-3m O3 type structure in a discharged state, the O3′ type structure, the monoclinic O1(15) type structure, the H1-3 type structure, and the trigonal O1 type structure. For the lattice constants of the R-3m O3 type crystal structure in a discharged state and the trigonal O1 type crystal structure in Table 1, which are used for the calculation, ICSD coll. code. 172909 and 88721 can be referred to. For the lattice constants of the H1-3 type structure, Non-Patent Document 3 can be referred to. In the case of the O3′ type structure and the monoclinic O1(15) type structure, the lattice constants thereof can be calculated from the experimental values of XRD. Note that 1 Å=10⁻¹⁰ m.

TABLE 1

| | Lattice constant | | | | Volume of unit | Volume per | Volume change |
|---|---|---|---|---|---|---|---|
| Crystal structure | a(Å) | b(Å) | c(Å) | β(°) | cell (Å³) | Co (Å³) | rate (%) |
| R-3m O3 | 2.8156 | 2.8156 | 14.0542 | 90 | 96.49 | 32.16 | — |
| (LiCoO₂) | | | | | | | |
| O3′ | 2.818 | 2.818 | 13.78 | 90 | 94.76 | 31.59 | 1.8 |
| Monoclinic O1(15) | 4.881 | 2.817 | 4.839 | 109.6 | 62.69 | 31.35 | 2.5 |
| H1-3 | 2.82 | 2.82 | 26.92 | 90 | 185.4 | 30.90 | 3.9 |
| Trigonal O1 | 2.8048 | 2.8048 | 4.2509 | 90 | 28.96 | 28.96 | 10.0 |
| (CoO_{1.92}) | | | | | | | |

As described above, in the positive electrode active material 100A1 of one embodiment of the present invention, a change in the crystal structure caused when x in LiₓCoO₂ is small, i.e., when a large amount of lithium is extracted, is smaller than that in a conventional positive electrode active material. In addition, a change in the volume per the same number of cobalt atoms is inhibited. Thus, the crystal structure of the positive electrode active material 100A1 is less likely to break even when charge that makes x be 0.24 or less and discharge are repeated. Thus, the positive electrode active material 100A1 inhibits a decrease in charge and discharge capacity in charge and discharge cycles. Furthermore, the positive electrode active material 100A1 can stably use a larger amount of lithium than a conventional positive electrode active material and thus enables high discharge capacity per weight and per volume. Thus, with the use of the positive electrode active material 100A1, a secondary battery with high discharge capacity per weight and per volume can be manufactured.

Note that the positive electrode active material 100A1 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. In addition, the positive electrode active material 100A1 is confirmed to have the monoclinic O1(15) type crystal structure in some cases when x in LiₓCoO₂ is greater than 0.1 and less than or equal to 0.2, typically greater than or equal to 0.15 and less than or equal to 0.17. However, the crystal structure is influenced by not only x in LiₓCoO₂ but also the number of charge and discharge cycles, a charge current and a discharge current, temperature, an electrolyte, and the like, so that the range of x is not limited to the above.

Thus, when x in LiₓCoO₂ is greater than 0.1 and less than or equal to 0.24, the positive electrode active material 100A1 may have only the O3′ type crystal structure, only the monoclinic O1(15) type crystal structure, or both of them. Not all particles of the inner portion 100b of the positive electrode active material 100A1 necessarily have the O3′ type crystal structure and/or the monoclinic O1(15) type crystal structure. The positive electrode active material may include another crystal structure or may be partly amorphous.

In order to make x in LiₓCoO₂ small, charge at a high charge voltage is necessary in general. Thus, the state where x in LiₓCoO₂ is small can be rephrased as a state where charge at a high charge voltage has been performed. For example, when CC/CV charge is performed at 25° C. and 4.6 V or higher with reference to the potential of a lithium metal, the H1-3 type crystal structure appears in a conventional positive electrode active material. Thus, a charge voltage of 4.6 V or higher can be regarded as a high charge voltage with reference to the potential of a lithium metal. In this specification and the like, unless otherwise specified, a charge voltage is shown with reference to the potential of a lithium metal.

Thus, the positive electrode active material 100A1 of one embodiment of the present invention is preferable because the crystal structure with the symmetry of R-3m O3 can be maintained even when charge at a high charge voltage, e.g., a voltage higher than or equal to 4.6 V, is performed at 25° C. Moreover, the positive electrode active material 100A1 of one embodiment of the present invention is preferable because the O3′ type crystal structure can be obtained when charge with a higher charge voltage, e.g., a voltage higher than or equal to 4.65 V and lower than or equal to 4.7 V is performed at 25° C. Furthermore, the positive electrode active material 100A1 of one embodiment of the present invention is preferable because the monoclinic O1(15) type crystal structure can be obtained when charge at a much higher charge voltage, e.g., a voltage higher than 4.7 V and lower than or equal to 4.8 V is performed at 25° C.

In the positive electrode active material 100A1, when the charge voltage is increased, the H1-3 type crystal structure is eventually observed in some cases. As described above, the crystal structure is influenced by the number of charge and discharge cycles, a charge current and a discharge current, temperature, an electrolyte, and the like, so that the positive electrode active material 100A1 of one embodiment of the present invention sometimes has the O3′ type crystal structure even at a lower charge voltage, e.g., a charge voltage higher than or equal to 4.5 V and lower than 4.6 V at 25° C. Similarly, the positive electrode active material 100A1 may sometimes have the monoclinic O1(15) type crystal structure at a charge voltage higher than or equal to 4.65 V and lower than or equal to 4.7 V at 25° C.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Thus, for a secondary battery using graphite as a negative electrode active material, a similar crystal structure is obtained at a voltage corresponding to a difference between voltage in the case where a lithium metal is used as the above-described negative electrode active material and the potential of the graphite.

Although a chance of the existence of lithium is the same in all lithium sites in O3′ and monoclinic O1(15) in FIG. 21, one embodiment of the present invention is not limited thereto. Lithium may exist unevenly in only some of the lithium sites; for example, lithium may symmetrically exist as in the monoclinic O1 (Li_{0.5}CoO₂) shown in FIG. 22. Distribution of lithium can be analyzed by neutron diffraction, for example.

The O3′ type crystal structure and the monoclinic O1(15) type crystal structure can be regarded as a crystal structure that contains lithium between layers randomly but is similar to a CdCl₂ type crystal structure. The crystal structure similar to the CdCl₂ type crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂ type crystal structure in general.

### <<Crystal Grain Boundary>>

It is further preferable that the additive element contained in the positive electrode active material 100A1 of one embodiment of the present invention have the above-described distribution and be at least partly unevenly distributed at the crystal grain boundary and the vicinity thereof.

Note that in this specification and the like, uneven distribution means that the concentration of an element in a certain region differs from that in another region. This may be rephrased as segregation, precipitation, unevenness, deviation, or a mixture of a high-concentration portion and a low-concentration portion.

For example, the concentration of magnesium at the crystal grain boundary and the vicinity thereof in the positive electrode active material 100A1 is preferably higher than that in the other regions in the inner portion 100b. In addition, the concentration of fluorine at the crystal grain boundary and the vicinity thereof is preferably higher than that in the other regions in the inner portion 100b. In addition, the concentration of nickel at the crystal grain boundary and the vicinity thereof is preferably higher than that in the other regions in the inner portion 100b. In addition, the concentration of aluminum at the crystal grain boundary and the vicinity thereof is preferably higher than that in the other regions in the inner portion 100b.

The crystal grain boundary is a type of plane defect. Thus, the crystal grain boundary tends to be unstable and the crystal structure easily starts to change like the surface of the particle. Thus, the higher the concentration of the additive element at the crystal grain boundary and the vicinity thereof is, the more effectively the change in the crystal structure can be reduced.

When the magnesium concentration and the fluorine concentration are high at the crystal grain boundary and the vicinity thereof, the magnesium concentration and the fluorine concentration in the vicinity of a surface generated by a crack are also high even when the crack is generated along the crystal grain boundary of the positive electrode active material 100A1 of one embodiment of the present invention. Thus, the positive electrode active material including a crack can also have an increased corrosion resistance to hydrofluoric acid. In addition, the positive electrode active material including a crack can inhibit a side reaction between the electrolyte solution and the positive electrode active material.

### <Particle Diameter>

When the particle diameter of the positive electrode active material 100A1 of one embodiment of the present invention is too large, there are problems such as difficulty in lithium diffusion and large surface roughness of an active material layer at the time when the material is applied to a current collector. By contrast, too small a particle diameter causes problems such as overreaction with the electrolyte solution. Thus, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, it is preferably greater than or equal to 1 μm and less than or equal to 40 μm. Alternatively, it is preferably greater than or equal to 1 μm and less than or equal to 30 μm. Alternatively, it is preferably greater than or equal to 2 μm and less than or equal to 100 μm. Alternatively, it is preferably greater than or equal to 2 μm and less than or equal to 30 μm. Alternatively, it is preferably greater than or equal to 5 μm and less than or equal to 100 μm. Alternatively, it is preferably greater than or equal to 5 μm and less than or equal to 40 μm.

A positive electrode is preferably formed using a mixture of particles having different particle diameters, which can increase the electrode density and thus a secondary battery with a high energy density can be achieved. The positive electrode active material 100A1 with a relatively small particle diameter is expected to have favorable charge and discharge rate characteristics. The positive electrode active material 100A1 with a relatively large particle diameter is expected to have high charge and discharge cycle performance and maintain high discharge capacity.

### <Analysis Method>

Whether or not a given positive electrode active material is the positive electrode active material 100A1 of one embodiment of the present invention, which has the O3′ type crystal structure and/or monoclinic O1(15) type crystal structure when x in LiₓCoO₂ is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt in the positive electrode active material can be analyzed with high resolution, comparison of the degree of crystallinity and comparison of the crystal orientation can be performed, distortion of lattice periodicity and the crystallite size can be analyzed, and a positive electrode obtained only by disassembling a secondary battery can be measured with sufficient accuracy, for example. A diffraction peak reflecting the crystal structure of the inner portion 100b of the positive electrode active material 100A1, which accounts for the majority of the volume of the positive electrode active material 100A1, is obtained through XRD, in particular, powder XRD.

In the case where the crystallite size is measured by powder XRD, the measurement is preferably performed while the influence of orientation of the positive electrode active material particle due to pressure or the like is removed. For example, it is preferable that the positive electrode active material be taken out from a positive electrode obtained by disassembling a secondary battery, the positive electrode active material be made into a powder sample, and then the measurement be performed.

As described above, the positive electrode active material 100A1 of one embodiment of the present invention has a feature of a small change in the crystal structure between when x in LiₓCoO₂ is 1 and when x is less than or equal to 0.24. A material 50% or more of which has the crystal structure to be largely changed by high-voltage charge is not preferable because the material cannot withstand repetition of high-voltage charge and discharge.

It should be noted that the O3′ type crystal structure or the monoclinic O1(15) type crystal structure is not obtained in some cases only by addition of the additive element. For example, when x in LiₓCoO₂ is less than or equal to 0.24, lithium cobalt oxide containing magnesium and fluorine or lithium cobalt oxide containing magnesium and aluminum has the O3′ type crystal structure and/or the monoclinic O1(15) type crystal structure at 60% or more in some cases, and has the H1-3 type crystal structure at 50% or more in other cases, depending on the concentration and distribution of the additive element.

In addition, in the case where x is too small, e.g., 0.1 or less, or under the condition where charge voltage is higher than 4.9 V, the positive electrode active material 100A1 of one embodiment of the present invention sometimes has the H1-3 type crystal structure or the trigonal O1 type crystal structure. Thus, determining whether or not a positive electrode active material is the positive electrode active material 100A1 of one embodiment of the present invention requires analysis of the crystal structure by XRD and other methods and data such as charge capacity or charge voltage.

Note that a positive electrode active material with small x sometimes causes a change in the crystal structure when exposed to the air. For example, the O3′ type crystal structure and the monoclinic O1(15) type crystal structure change into the H1-3 type crystal structure in some cases. For that reason, all samples subjected to analysis of crystal structures are preferably handled in an inert atmosphere such as an argon atmosphere.

Whether the distribution of the additive element contained in a positive electrode active material is in the above-described state can be determined by, for example, analysis using XPS, energy dispersive X-ray spectroscopy (EDX), EPMA (electron probe microanalysis), or the like.

The crystal structure of the surface portion 100a, the crystal grain boundary, or the like can be analyzed by electron diffraction of a cross section of the positive electrode active material 100A1, for example.

### <<Charge Method>>

Charge for determining whether or not a composite oxide is the positive electrode active material 100A1 of one embodiment of the present invention can be performed on a coin cell (CR2032 type with a diameter of 20 mm and a height of 3.2 mm) with the composite oxide used for a positive electrode and a lithium metal used for a counter electrode, for example. The coin cell includes an electrolyte solution, a separator, a positive electrode can, and a negative electrode can.

Alternatively, in a lithium-ion secondary battery in which a certain composite oxide is used for a positive electrode and a material other than a lithium metal (e.g., graphite) is used for a negative electrode, charge for determining whether or not the composite oxide is the positive electrode active material 100A1 of one embodiment of the present invention can be performed after the following treatment: the lithium-ion secondary battery is disassembled to take out the positive electrode including the composite oxide, and then, a coin cell (CR2032 type with a diameter of 20 mm and a height of 3.2 mm) is formed with a lithium counter electrode in a manner similar to the above. A reason for performing such treatment before charge is as follows. The voltage of the battery is a difference between the positive electrode potential and the negative electrode potential; thus, it is difficult to accurately determine the potential of the positive electrode in the lithium-ion secondary battery using a material other than a lithium metal for the negative electrode.

More specifically, a positive electrode can be formed by application of slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in the electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell formed under the above conditions is charged with a given voltage (e.g., 4.5 V, 4.55 V, 4.6 V, 4.65 V, 4.7 V, 4.75 V, or 4.8 V). The charge method is not particularly limited as long as charge with a given voltage can be performed for sufficient time. In the case of CCCV charge, for example, CC charge can be performed with a current higher than or equal to 20 mA/g and lower than or equal to 100 mA/g. CV charge can be ended with a current higher than or equal to 2 mA/g and lower than or equal to 10 mA/g. To observe a phase change of the positive electrode active material, charge with such a small current value is preferably performed. Meanwhile, in the case where a current does not reach higher than or equal to 2 mA/g and lower than or equal to 10 mA/g even when CV charge is performed for a long time, the CV charge may be ended after the sufficient time passes from the start because the current is probably consumed not for charging the positive electrode active material but for decomposing the electrolyte solution. The sufficient time in this case can be longer than or equal to 1.5 hours and shorter than or equal to 3 hours. The temperature is set to 25° C. or 45° C. After charge is performed in this manner, the coin cell is disassembled in a glove box with an argon atmosphere to take out the positive electrode, whereby the positive electrode active material with predetermined charge capacity can be obtained. In order to inhibit a reaction with components in the external environment, the positive electrode is preferably enclosed in an argon atmosphere in performing various analyses later. For example, XRD can be performed on the positive electrode enclosed in an airtight container with an argon atmosphere. After charge is completed, the positive electrode is preferably taken out immediately and subjected to the analysis. Specifically, the positive electrode is preferably subjected to analysis within an hour, further preferably within 30 minutes after the completion of charge.

In the case where the crystal structure in a charged state after charge and discharge are performed multiple times is analyzed, the conditions of the charge and discharge performed multiple times may be different from the above-described charge conditions. For example, the charge can be performed by constant current charge with a current value greater than or equal to 20 mA/g and less than or equal to 100 mA/g to a given voltage (e.g., 4.6 V, 4.65 V, 4.7 V, 4.75 V, or 4.8 V) and then constant voltage charge until the current value becomes greater than or equal to 2 mA/g and less than or equal to 10 mA/g. The discharge can be performed by constant current discharge with greater than or equal to 20 mA/g and less than or equal to 100 mA/g to 2.5 V.

Also in the case where the crystal structure in a discharged state after the charge and discharge are performed multiple times is analyzed, constant current discharge can be performed with a current value greater than or equal to 20 mA/g and less than or equal to 100 mA/g to 2.5 V, for example.

### <<XRD>>

The apparatus and conditions for the XRD measurement are not particularly limited. For example, the measurement can be performed using the following apparatus and conditions.
XRD apparatus: D8 ADVANCE produced by Bruker AXS
X-ray: CuKα₁ radiation
Output: 40 kV, 40 mA
Angle of divergence: Div. Slit, 0.5°
Detector: LynxEye
Scanning method: 2θ/θ continuous scan
Measurement range (2θ): from 15° to 90°
Step width (2θ): 0.01°
Counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

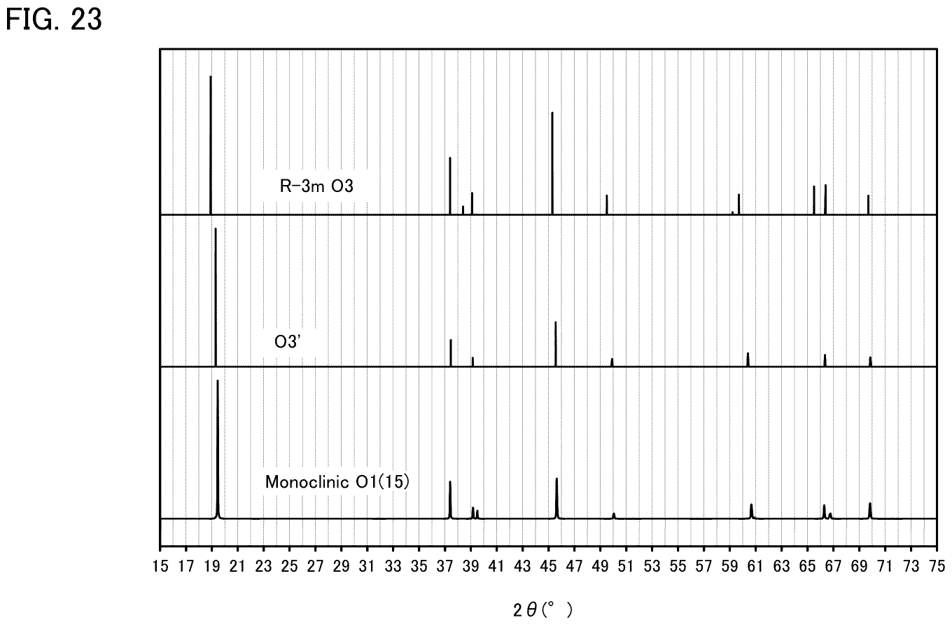

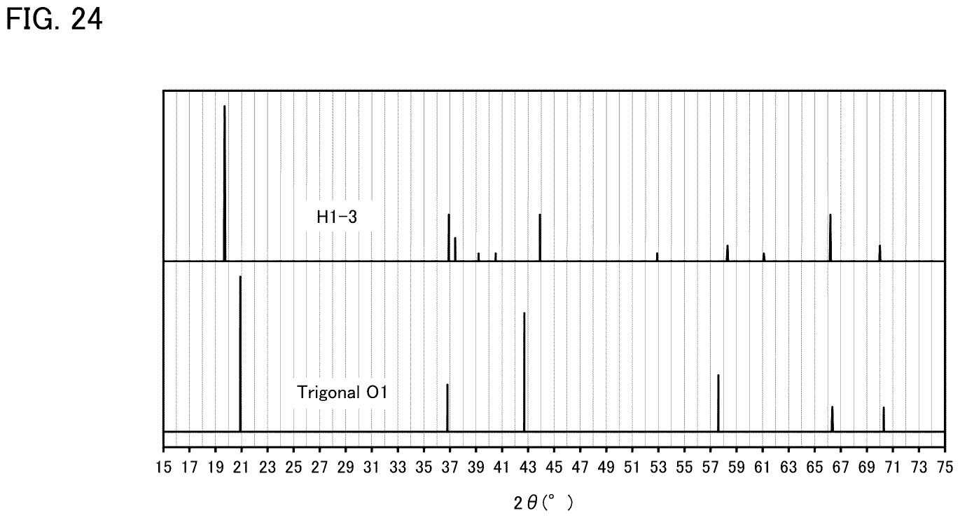

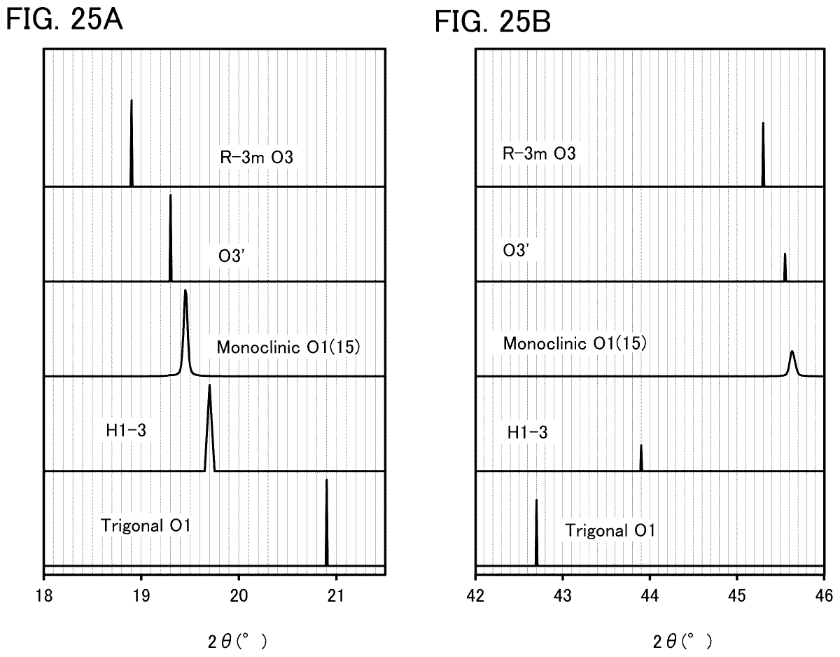

FIG. 23, FIG. 24, FIG. 25A, and FIG. 25B show ideal powder XRD patterns with CuKα₁ radiation that are calculated from models of the O3′ type crystal structure, the monoclinic O1(15) type crystal structure, and the H1-3 type crystal structure. For comparison, ideal XRD patterns calculated from the crystal structure of LiCoO₂ O3 with x in LiₓCoO₂ of 1 and the crystal structure of the trigonal O1 with x of 0 are also shown. FIG. 25A and FIG. 25B each show the XRD patterns of the O3′ type crystal structure, the monoclinic O1(15) type crystal structure, and the H1-3 type crystal structure. FIG. 25A and FIG. 25B are enlarged diagrams showing a range of 2θ greater than or equal to 180 and less than or equal to 21° and a range of 2θ greater than or equal to 42° and less than or equal to 46°, respectively. Note that the patterns of LiCoO₂ (O3) and CoO₂ (O1) were made from crystal structure data obtained from ICSD (Inorganic Crystal Structure Database) (see Non-Patent Document 5) with Reflex Powder Diffraction, which is a module of Materials Studio (BIOVIA). The 2θ range is from 15° to 75°, the step size is 0.01, the wavelength λ1 is 1.540562×10⁻¹⁰ m, the wavelength λ2 is not set, and a single monochromator is used. The pattern of the H1-3 type crystal structure is similarly made from the crystal structure data disclosed in Non-Patent Document 3. The O3′ type crystal structure and the monoclinic O1(15) type crystal structure are estimated from the XRD pattern of the positive electrode active material of one embodiment of the present invention, the crystal structure is fitted with TOPAS ver. 3 (crystal structure analysis software produced by Bruker Corporation), and the XRD patterns of the O3′ type crystal structure and the monoclinic O1(15) type crystal structure are made in a manner similar to that for other structures.

As shown in FIG. 23, FIG. 25A, and FIG. 25B, the O3′ type crystal structure exhibits diffraction peaks at 2θ of 19.25±0.12° (greater than or equal to 19.13° and less than 19.37°) and 2θ of 45.47±0.10° (greater than or equal to 45.370 and less than 45.57°).

Furthermore, the monoclinic O1(15) type crystal structure exhibits diffraction peaks at 2θ of 19.47±0.10° (greater than or equal to 19.37° and less than or equal to 19.57°) and 2θ of 45.62±0.05° (greater than or equal to 45.570 and less than or equal to 45.67°).

However, as shown in FIG. 24, FIG. 25A, and FIG. 25B, the H1-3 type crystal structure and the trigonal O1 do not exhibit peaks at these positions. Thus, it can be said that exhibiting peaks at greater than or equal to 19.13° and less than 19.37° and/or greater than or equal to 19.37° and less than or equal to 19.57° and at greater than or equal to 45.370 and less than 45.570 and/or greater than or equal to 45.570 and less than or equal to 45.67° in a state with small x in LiₓCoO₂ is the feature of the positive electrode active material 100A1 of one embodiment of the present invention.

It can also be said that in the positive electrode active material 100A1 of one embodiment of the present invention, the XRD diffraction peaks exhibited by the crystal structure with x=1 and the crystal structure with x≤0.24 appear at close positions. More specifically, it can be said that a difference in 2θ between the main diffraction peak exhibited by the crystal structure with x=1 and the main diffraction peak exhibited by the crystal structure with x≤0.24, which are exhibited at 2θ of greater than or equal to 420 and less than or equal to 46°, is less than or equal to 0.7°, preferably less than or equal to 0.5°.

Although the positive electrode active material 100A1 of one embodiment of the present invention has the O3′ type crystal structure and/or the monoclinic O1(15) type crystal structure when x in LiₓCoO₂ is small, not all particles necessarily have the O3′ type crystal structure and/or the monoclinic O1(15) type crystal structure. The positive electrode active material may include another crystal structure such as O3 type crystal structure or may be partly amorphous. Note that when the XRD patterns are subjected to the Rietveld analysis, the O3 type crystal structure, the O3′ type crystal structure, and/or the monoclinic O1(15) type crystal structure preferably account(s) for greater than or equal to 50%, further preferably greater than or equal to 60%, still further preferably greater than or equal to 66%. The positive electrode active material in which the O3 type crystal structure, the O3′ type crystal structure, and/or the monoclinic O1(15) type crystal structure account(s) for greater than or equal to 50%, preferably greater than or equal to 60%, further preferably greater than or equal to 66% enables sufficiently good cycle performance.

In addition, the H1-3 type crystal structure and the O1 type crystal structure account for preferably less than 50% in the Rietveld analysis performed in a similar manner. Alternatively, the H1-3 type crystal structure and the O1 type crystal structure account for preferably less than or equal to 34%. It is still further preferable that substantially no H1-3 type crystal structure and substantially no O1 type crystal structure be observed.

Furthermore, even after 100 or more cycles of charge and discharge after the measurement starts, the O3′ type crystal structure and/or the monoclinic O1(15) type crystal structure preferably account for more than or equal to 35%, further preferably more than or equal to 40%, still further preferably more than or equal to 43% when the Rietveld analysis is performed.

Even in a state where x in LiₓCoO₂ is small, the O3 type crystal structure is maintained owing to an effect of the additive elements such as nickel, in some cases. Thus, the positive electrode active material preferably has the O3 type crystal structure in addition to the O3′ type crystal structure. A (003) diffraction peak of O3 has its local maximum value at 19.10±0.10°, for example, and a (104) diffraction peak of O3 has its local maximum value at 2θ=45.35±0.10°, for example.

The Rietveld analysis and calculation of the area intensity ratio of a certain peak enable estimation of the degree of the existence ratio of each crystal structure. The area intensity ratios of peaks can be calculated, with the use of TOPAS as analysis software, by performing fitting using the Pseudo Voigt function in a range where 2θ is greater than or equal to 15° and less than or equal to 25°, for example. The number of background items can be 2θ, for example. It is known that a peak corresponding to the (003) plane of lithium cobalt oxide, a peak corresponding to the (006) plane of the H1-3 type crystal structure, and the like are observed in the range where 2θ is greater than or equal to 15° and less than or equal to 25°.

When the area of a peak corresponding to (003) diffraction of O3 is assumed to be 103 and the area of a peak corresponding to (003) diffraction of O3′ is assumed to be I_{O3′}, for example, I_{O3}/(I_{O3}+I_{O3′}), which is the area intensity ratio of the O3 peak to the sum of O3 and O3′, is preferably greater than or equal to 1% and less than or equal to 60%, further preferably greater than or equal to 15% and less than or equal to 60%, still further preferably greater than or equal to 30% and less than or equal to 60%.

Also in terms of the area intensity ratio, the amount of the H1-3 type crystal structure is preferably small. When the area of a peak corresponding to (006) diffraction of H1-3 is assumed to be I_{H1-3}, for example, I_{H1-3}/(I_{O3}+I_{H1-3}), which is the area intensity ratio of the H1-3 peak to the sum of O3′ and H1-3, is preferably less than or equal to 50%, further preferably less than or equal to 30%, still further preferably less than or equal to 20%.

Sharpness of a diffraction peak in an XRD pattern indicates the degree of crystallinity. It is thus preferable that the diffraction peaks after charge be sharp or in other words, have a small half width. For example, the full width at half maximum is preferably small. Even peaks that are derived from the same crystal phase have different half widths depending on the XRD measurement conditions or the 2θ value. In the case of the above-described measurement conditions, the peak observed at 2θ of greater than or equal to 430 and less than or equal to 460 preferably has a full width at half maximum of less than or equal to 0.2°, further preferably less than or equal to 0.15°, still further preferably less than or equal to 0.12°, for example. Not all peaks need to fulfill the requirement. A crystal phase can be regarded as having high crystallinity when one or more peaks fulfill the requirement. Such high crystallinity contributes to stability of the crystal structure after sufficient charge.

The crystallite sizes of the O3′ type crystal structure and the monoclinic O1(15) type crystal structure included in the positive electrode active material 100A1 are only decreased to approximately one-twentieth that of LiCoO₂ (O3) in a discharged state. Thus, a clear peak of the O3′ type crystal structure and/or the monoclinic O1(15) type crystal structure can be observed when x in LiₓCoO₂ is small, even under the same XRD measurement conditions as those of a positive electrode before charge and discharge. By contrast, conventional LiCoO₂ has a small crystallite size and a broad and small peak even when it can have a structure part of which is similar to the O3′ type crystal structure and/or the monoclinic O1(15) type crystal structure. The crystallite size can be calculated from the half width of the XRD peak.

As described above, the influence of the Jahn-Teller effect is preferably small in the positive electrode active material 100A1 of one embodiment of the present invention. The positive electrode active material 100A1 may contain a transition metal such as nickel or manganese as the additive element in addition to cobalt as long as the influence of the Jahn-Teller effect is small.

The nickel concentration is preferably lower than 7.5%, for example, because an excellent positive electrode active material with small Jahn-Teller distortion can be obtained. The manganese concentration is preferably lower than or equal to 4%, for example.

Note that the nickel concentration and the manganese concentration in the surface portion 100a are not limited to the above ranges. In other words, the nickel concentration and the manganese concentration in the surface portion 100a may be higher than the above concentrations in some cases.

Examination of preferable ranges of the lattice constants of the positive electrode active material of one embodiment of the present invention based on the above revealed that, in the layered rock-salt crystal structure of the positive electrode active material 100A1 in a discharged state or a state where charge and discharge are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charge and discharge are not performed may be, for example, the state of a powder before the formation of a positive electrode of a secondary battery.

Alternatively, in the layered rock-salt crystal structure of the positive electrode active material 100A1 in the discharged state or the state where charge and discharge are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material 100A1 in the discharged state or the state where charge and discharge are not performed is subjected to XRD analysis, a first peak is observed at 2θ of greater than or equal to 18.50° and less than or equal to 19.30° and a second peak is observed at 2θ of greater than or equal to 38.000 and less than or equal to 38.80°, in some cases.

### <<XPS>>

In an inorganic oxide, a region that extends from the surface to a depth of approximately 2 nm to 8 nm (normally, less than or equal to 5 nm) can be analyzed by X-ray photoelectron spectroscopy (XPS) using monochromatic aluminum Kα radiation as an X-ray; thus, the concentrations of elements in a region extending to approximately half the depth of the surface portion 100a can be quantitatively analyzed by XPS. The bonding states of the elements can be analyzed by narrow scanning. Note that the quantitative accuracy of XPS is approximately ±1 atomic % in many cases. The lower detection limit is approximately 1 atomic % but depends on the element.

In the positive electrode active material 100A1 of one embodiment of the present invention, the concentration of one or two or more selected from the additive elements is preferably higher in the surface portion 100a than in the inner portion 100b. This means that the concentration of one or two or more selected from the additive elements in the surface portion 100a is preferably higher than the average concentration of the selected element(s) in the entire positive electrode active material 100A1. For this reason, for example, it can be said that the concentration of one or two or more additive elements selected from the surface portion 100a, which is measured by XPS or the like, is preferably higher than the average concentration of the additive element(s) in the entire positive electrode active material 100A1, which is measured by ICP-MS (inductively coupled plasma-mass spectrometry), GD-MS (glow discharge mass spectrometry), or the like. For example, the concentration of magnesium in at least part of the surface portion 100a, which is measured by XPS or the like, is preferably higher than the average concentration of magnesium in the entire positive electrode active material 100A1. The concentration of nickel in at least part of the surface portion 100a is preferably higher than the average concentration of nickel in the entire positive electrode active material 100A1. The concentration of aluminum in at least part of the surface portion 100a is preferably higher than the average concentration of aluminum in the entire positive electrode active material 100A1. The concentration of fluorine in at least part of the surface portion 100a is preferably higher than the average concentration of fluorine in the entire positive electrode active material 100A1.

Note that the surface and the surface portion 100a of the positive electrode active material 100A1 of one embodiment of the present invention do not contain a carbonate, a hydroxy group, or the like which is chemically adsorbed after formation of the positive electrode active material 100A1. Furthermore, an electrolyte solution, a binder, a conductive material, and a compound originating from any of these that are attached to the surface of the positive electrode active material 100A1 are not included either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample of a positive electrode active material or a positive electrode active material layer or the like may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

The concentration of the additive element may be compared using the ratio of the additive element to cobalt. The ratio of the additive element to cobalt is preferably used, in which case comparison can be performed while reducing the influence of a carbonate or the like that is chemically adsorbed after formation of the positive electrode active material. For example, in the XPS analysis, the atomic ratio of magnesium to cobalt (Mg/Co) is preferably greater than or equal to 0.4 and less than or equal to 1.5. In the ICP-MS analysis, Mg/Co is preferably greater than or equal to 0.001 and less than or equal to 0.06.

Similarly, to secure the sufficient path through which lithium is inserted and extracted, the concentrations of lithium and cobalt are preferably higher than those of the additive elements in the surface portion 100a of the positive electrode active material 100A1. It can be said that the concentrations of lithium and cobalt in the surface portion 100a are preferably higher than that of one or two or more selected from the additive elements contained in the surface portion 100a, which is measured by XPS or the like. For example, the concentration of cobalt in at least part of the surface portion 100a, which is measured by XPS or the like, is preferably higher than the concentration of magnesium in at least part of the surface portion 100a, which is measured by XPS or the like. Similarly, the concentration of lithium is preferably higher than the concentration of magnesium. In addition, the concentration of cobalt is preferably higher than the concentration of nickel. Similarly, the concentration of lithium is preferably higher than the concentration of nickel. The concentration of cobalt is preferably higher than the concentration of aluminum. Similarly, the concentration of lithium is preferably higher than the concentration of aluminum. The concentration of cobalt is preferably higher than the concentration of fluorine. Similarly, the concentration of lithium is preferably higher than the concentration of fluorine.

It is further preferable that aluminum be widely distributed in a deep region, e.g., a region from the surface or the reference point to a depth of greater than or equal to 5 nm and less than or equal to 50 nm. Therefore, it is further preferable that the concentration of aluminum be lower than or equal to 1 atomic % or no aluminum be detected by XPS or the like although aluminum is detected by analysis on the entire positive electrode active material 100A1 by ICP-MS, GD-MS, or the like.

Furthermore, when XPS analysis is performed on the positive electrode active material 100A1 of one embodiment of the present invention, the number of magnesium atoms is preferably greater than or equal to 0.4 times and less than or equal to 1.2 times, further preferably greater than or equal to 0.65 times and less than or equal to 1.0 times the number of cobalt atoms. The number of nickel atoms is preferably less than or equal to 0.15 times, further preferably greater than or equal to 0.03 times and less than or equal to 0.13 times the number of cobalt atoms. The number of aluminum atoms is preferably less than or equal to 0.12 times, further preferably less than or equal to 0.09 times the number of cobalt atoms. The number of fluorine atoms is preferably greater than or equal to 0.3 times and less than or equal to 0.9 times, further preferably greater than or equal to 0.1 times and less than or equal to 1.1 times the number of cobalt atoms. When the number is within the above range, it can be said that the additive element is not attached to the surface of the positive electrode active material 100A1 in a narrow range but widely distributed at a preferable concentration in the surface portion 100a of the positive electrode active material 100A1.

In the XPS analysis, monochromatic aluminum Kα, radiation can be used as an X-ray source, for example. An extraction angle is, for example, 45°. For example, the measurement can be performed using the following apparatus and conditions.
Measurement apparatus: Quantera II produced by PHI, Inc.
X-ray source: monochromatic Al Kα (1486.6 eV)
Detection area: 100 μmφ
Detection depth: approximately 4 to 5 nm (extraction angle 45°)
Measurement spectrum: wide scanning, narrow scanning of each detected element

In addition, when the positive electrode active material 100A1 of one embodiment of the present invention is analyzed by XPS, a peak indicating the bonding energy of fluorine with another element is preferably at greater than or equal to 682 eV and less than 685 eV, further preferably approximately 684.3 eV. The above value is different from 685 eV, which is the bonding energy of lithium fluoride, and 686 eV, which is the bonding energy of magnesium fluoride.

Furthermore, when the positive electrode active material 100A1 of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to the bonding energy of magnesium oxide.

### <<EDX>>

The one or two or more selected from the additive elements contained in the positive electrode active material 100A1 preferably have a concentration gradient. It is further preferable that the additive elements contained in the positive electrode active material 100A1 exhibit concentration peaks at different depths from the surface. The concentration gradient of the additive element can be evaluated by exposing a cross section of the positive electrode active material 100A1 using FIB (Focused Ion Beam) or the like and analyzing the cross section using energy dispersive X-ray spectroscopy (EDX), EPMA (electron probe microanalysis), or the like.

In the EDX measurement, to measure a region while scanning is performed and evaluate the region two-dimensionally is referred to as EDX area analysis. The measurement for evaluation of the atomic concentration distribution in a positive electrode active material by line scan is referred to as line analysis. Furthermore, extracting data of a linear region from EDX area analysis is referred to as line analysis in some cases. The measurement of a region without scanning is referred to as point analysis.

By EDX area analysis (e.g., element mapping), the concentrations of the additive element in the surface portion 100a, the inner portion 100b, the vicinity of a crystal grain boundary, and the like of the positive electrode active material 100A1 can be quantitatively analyzed. By EDX line analysis, the concentration distribution and the highest concentration of the additive element can be analyzed. An analysis method in which a thinned sample is used, such as STEM-EDX, is preferable because the method makes it possible to analyze the concentration distribution in the depth direction from the surface toward the center in a specific region of the positive electrode active material regardless of the distribution in the front-back direction.

Since the positive electrode active material 100A1 is a compound containing oxygen and a transition metal into and from which lithium can be inserted and extracted, an interface between a region where oxygen and the transition metal M(Co, Ni, Mn, Fe, or the like) that is oxidized or reduced due to insertion and extraction of lithium exist and a region where oxygen and the transition metal M do not exist is considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

In STEM-EDX line analysis or the like, it is sometimes difficult to precisely determine the surface because a steep change in the characteristic X-ray of an element is not seen in principle or due to a measurement error. Therefore, when the depth direction in STEM-EDX line analysis or the like is mentioned, a reference point is a point where a value of the detected amount of the characteristic X-ray of the transition metal M is equal to 50% of the sum of the average value M_{AVE} of the detected amount of the transition metal Min the inner portion and the average value M_{BG} of the detected amount of the transition metal M of the background and a point where a value of the detected amount of oxygen is equal to 50% of the sum of the average value O_{AVE} of the detected amount of oxygen in the inner portion and the detected amount of the average value O_{BG} of the detected amount of oxygen of the background. Note that in the case where the positions of the points of 50% of the sum of the detected amount in the inner portion and the background amount differ between the transition metal M and oxygen, the difference is probably due to the influence of a carbonate, a metal oxide containing oxygen, or the like, which is attached to the surface. Thus, the point that is equal to 50% of the sum of the average value M_{AVE} of the detected amount of the transition metal Min the inner portion and the average value M_{BG} of the amount of transition metal M of the background can be used. In the case of a positive electrode active material containing a plurality of transition metals M, the reference point can be determined using M_{AVE} and M_{BG} of an element whose count number is the largest in the inner portion 100b.

The average value M_{BG} of the detected amount of the background of the characteristic X-ray of the transition metal M can be calculated by averaging the detected amounts of the characteristic X-ray of the transition metal Min the range greater than or equal to 2 nm, preferably greater than or equal to 3 nm on the outer side of the positive electrode active material, other than a portion in the vicinity of the portion at which the detected amount of the characteristic X-ray of the transition metal M begins to increase, for example. The average value M_{AVE} of the detected amount of the transition metal Min the inner portion can be calculated by averaging the detected amounts in the range greater than or equal to 2 nm, preferably greater than or equal to 3 nm in a region where the count numbers of the characteristic X-ray of the transition metals M and the characteristic X-ray of oxygen atoms are saturated and stabilized, e.g., a portion that is greater than or equal to 30 nm, preferably greater than 50 nm in depth from the portion where the detected amount of the transition metal M begins to increase, for example. The average value O_{BG} of the amount of background of the characteristic X-ray of oxygen and the average value O_{AVE} of the amount of detected oxygen in the inner portion can be calculated in a similar manner.

The surface of the positive electrode active material 100A1 in, for example, a cross-sectional STEM (scanning transmission electron microscope) image is a boundary between a region where an image derived from the crystal structure of the positive electrode active material is observed and a region where the image is not observed, and is determined as the outermost surface of a region where an atomic column derived from an atomic nucleus of a metal element that has a greater atomic number than lithium among the metal elements constituting the positive electrode active material is confirmed.

The spatial resolution of STEM-EDX is approximately 1 nm. Thus, the maximum value of the intensity distribution of characteristic X-ray corresponding to the additive element may be shifted by approximately 1 nm. For example, even when the maximum value of the intensity distribution of the characteristic X-ray corresponding to the additive element such as magnesium is outside the surface determined in the above-described manner, it can be said that a difference between the maximum value and the surface can be referred to as within the margin of error as long as the difference is less than 1 nm.

A peak in STEM-EDX line analysis refers to the maximum value of the detection intensity in the intensity distribution of the characteristic X-ray corresponding to each element or the maximum value of the characteristic X-ray of each element. As a noise in STEM-EDX line analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by measurement by scanning six times can be used as the detection intensity of the characteristic X-ray corresponding to each element. The number of scanning is not limited to six and an average obtained by performing scanning seven or more times can be used as the detection intensity of the characteristic X-ray corresponding to each element.

STEM-EDX line analysis can be performed as follows, for example. First, a protective film is deposited over a surface of a positive electrode active material. For example, carbon can be deposited with an ion sputter apparatus (MC1000, produced by Hitachi High-Tech Corporation).

Next, the positive electrode active material is thinned to form a cross-section sample to be subjected to STEM analysis. For example, the positive electrode active material can be thinned with an FIB-SEM apparatus (XVision 200TBS, produced by Hitachi High-Tech Corporation). Here, picking up can be performed by an MPS (micro probing system), and an accelerating voltage at final processing condition can be, for example, 10 kV.

The STEM-EDX line analysis can be performed with a STEM apparatus (HD-2700 produced by Hitachi High-Tech Corporation), for example, and Octane T Ultra W produced by EDAX Inc can be used as EDX detectors. In the EDX line analysis, the emission current of the STEM apparatus is set to be higher than or equal to 6 μA and lower than or equal to 10 μA, and a portion of the thinned sample, which is not positioned at a deep level and has little unevenness, is measured. The magnification is 150,000 times, for example. The EDX line analysis can be performed under conditions where drift correction is performed, the line width is 42 nm, the pitch is 0.2 nm, and the number of frames is six or more.

EDX area analysis or EDX point analysis of the positive electrode active material 100A1 of one embodiment of the present invention preferably reveals that the concentration of each additive element, in particular, an additive element X in the surface portion 100a is higher than that in the inner portion 100b.

For example, EDX area analysis or EDX point analysis of the positive electrode active material 100A1 containing magnesium as the additive element preferably reveals that the concentration of magnesium in the surface portion 100a is higher than that in the inner portion 100b. In the EDX line analysis, a peak of the concentration of magnesium in the surface portion 100a is preferably located in a region ranging, toward the center of the positive electrode active material 100A1, from the surface thereof or the reference point to a depth of 3 nm, further preferably a depth of 1 nm, still further preferably a depth of 0.5 nm. In addition, the concentration of magnesium preferably attenuates, at a depth of 1 nm from the point where the concentration reaches the peak, to less than or equal to 60% of the peak concentration. In addition, the concentration of magnesium preferably attenuates, at a depth of 2 nm from the point where the concentration reaches the peak, to less than or equal to 30% of the peak concentration. Here, a “peak (also referred to as peak top) of concentration” refers to the local maximum value of concentration.

In the EDX line analysis, the magnesium concentration (the detected amount of magnesium/the sum of the detected amounts of magnesium, oxygen, cobalt, fluorine, aluminum, and silicon) in the surface portion 100a is preferably higher than or equal to 0.5 atomic % and lower than or equal to 10 atomic %, further preferably higher than or equal to 1 atomic % and lower than or equal to 5 atomic %.

When the positive electrode active material 100A1 contains magnesium and fluorine as the additive elements, the distribution of fluorine preferably overlaps with the distribution of magnesium. For example, a difference in the depth direction between a peak of the concentration of fluorine and a peak of the concentration of magnesium is preferably within 10 nm, further preferably within 3 nm, still further preferably within 1 nm.

In the EDX line analysis, a peak of the concentration of fluorine in the surface portion 100a is preferably located in a region ranging, toward the center of the positive electrode active material 100A1, from the surface thereof or the reference point to a depth of 3 nm, further preferably a depth of 1 nm, still further preferably a depth of 0.5 nm. It is further preferable that a peak of the concentration of fluorine be exhibited slightly closer to the surface side than a peak of the concentration of magnesium is, which increases resistance to hydrofluoric acid. For example, it is preferable that a peak of the concentration of fluorine be exhibited slightly closer to the surface side than a peak of the concentration of magnesium is by 0.5 nm or more, further preferably 1.5 nm or more.

When the positive electrode active material 100A1 contains nickel as the additive element, a peak of the concentration of nickel in the surface portion 100a is preferably located in a region ranging, toward the center of the positive electrode active material 100A1, from the surface thereof or the reference point to a depth of 3 nm, further preferably 1 nm, still further preferably 0.5 nm. When the positive electrode active material 100A1 contains magnesium and nickel, the distribution of nickel preferably overlaps with the distribution of magnesium. For example, a difference in the depth direction between a peak of the concentration of nickel and a peak of the concentration of magnesium is preferably within 3 nm, further preferably within 1 nm.

In the case where the positive electrode active material 100A1 contains aluminum as the additive element, the peak concentration of magnesium, nickel, or fluorine is preferably closer to the surface than the peak concentration of aluminum is in the surface portion 100a in the EDX line analysis. For example, the peak of the concentration of aluminum preferably exists in a region from the surface of the positive electrode active material 100A1 or the reference point to a depth of greater than or equal to 0.5 nm and less than or equal to 50 nm, further preferably greater than or equal to 5 nm and less than or equal to 50 nm toward the center.

When EDX line, area, or point analysis is performed on the positive electrode active material 100A1, the atomic ratio of magnesium Mg at a peak of the magnesium concentration to the average value of cobalt Co in the inner portion (Mg/Co) is preferably greater than or equal to 0.05 and less than or equal to 0.6, further preferably greater than or equal to 0.1 and less than or equal to 0.4. The atomic ratio of the average value of aluminum Al to cobalt Co in the inner portion (Al/Co) at a peak of the concentration of aluminum is preferably greater than or equal to 0.05 and less than or equal to 0.6, further preferably greater than or equal to 0.1 and less than or equal to 0.45. The atomic ratio of the average value of nickel Ni to cobalt Co in the inner portion (Ni/Co) at a peak of the concentration of nickel is preferably higher than or equal to 0 and lower than or equal to 0.2, further preferably higher than or equal to 0.01 and lower than or equal to 0.1. The atomic ratio of fluorine F to cobalt Co (F/Co) at a peak of the concentration of fluorine is preferably higher than or equal to 0 and lower than or equal to 1.6, further preferably higher than or equal to 0.1 and lower than or equal to 1.4.

When the line analysis or the area analysis is performed on the positive electrode active material 100A1, the atomic ratio of an additive element A to cobalt Co (A/Co) in the vicinity of the crystal grain boundary is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

When the line analysis or the area analysis is performed on the positive electrode active material 100A1 containing magnesium as the additive element, the atomic ratio of magnesium to cobalt (Mg/Co) in the vicinity of the crystal grain boundary is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30. When the ratio is within the above range in a plurality of portions, e.g., three or more portions of the positive electrode active material 100A1, it can be said that the additive element is not attached to the surface of the positive electrode active material 100A1 in a narrow range but widely distributed at a preferable concentration in the surface portion 100a of the positive electrode active material 100A1.

### <<Raman Spectroscopy>>

As described above, at least part of the surface portion 100a of the positive electrode active material 100A1 of one embodiment of the present invention preferably has the rock-salt crystal structure. Thus, when the positive electrode active material 100A1 and a positive electrode including the positive electrode active material 100A1 are analyzed by Raman spectroscopy, a cubic crystal structure such as a rock-salt crystal structure is preferably observed in addition to a layered rock-salt crystal structure. In a STEM image and a nanobeam electron diffraction pattern described later, a bright spot cannot be detected when cobalt that is substituted at a lithium site, cobalt that exists at a site coordinated to four oxygen atoms, or the like does not appear with a certain frequency in the depth direction in observation. Meanwhile, Raman spectroscopy observes a vibration mode of a bond such as a Co—O bond, so that even when the number of Co—O bonds is small, a peak of a wave number of a vibration mode corresponding to the Co—O bond can be observed in some cases. Furthermore, since Raman spectroscopy can measure a range with an area of several square micrometers and a depth of approximately 1 μm of a surface portion, a Co—O bond only at the surface of a particle can be observed with high sensitivity.

When a laser wavelength is 532 nm, for example, peaks (vibration mode: E_{g}, A_{1g}) of LiCoO₂ having a layered rock-salt structure are observed in ranges from 470 cm⁻¹ to 490 cm⁻¹ and from 580 cm⁻¹ to 600 cm⁻¹. Meanwhile, a peak (vibration mode: A_{1g}) of cubic CoOₓ (0<x<1) (Co_{1-y}O having a rock-salt structure (0<y<1) or Co₃O₄ having a spinel structure) is observed in a range from 665 cm⁻¹ to 685 cm⁻¹.

Thus, in the case where the integrated intensities of the peak in the range from 470 cm⁻¹ to 490 cm⁻¹, the peak in the range from 580 cm⁻¹ to 600 cm⁻¹, and the peak in the range from 665 cm⁻¹ to 685 cm⁻¹ are represented by I1, I2, and I3, respectively, I3/I2 is preferably greater than or equal to 1% and less than or equal to 10%, further preferably greater than or equal to 3% and less than or equal to 9%.

In the case where a cubic crystal structure such as a rock-salt crystal structure is observed in the above-described range, it can be said that a preferable range of the surface portion 100a of the positive electrode active material 100A1 has a rock-salt crystal structure.

### <<Nanobeam Electron Diffraction Pattern>>

As in Raman spectroscopy, features of both a layered rock-salt crystal structure and a rock-salt crystal structure are preferably observed in a nanobeam electron diffraction pattern. Note that in consideration of the above-described difference in sensitivity, in a STEM image and a nanobeam electron diffraction pattern, it is preferable that the features of a rock-salt crystal structure not be too significant at the surface portion 100a, in particular, the outermost surface (e.g., a portion from the surface to a depth of 1 nm). This is because a diffusion path of lithium can be secured and a function of stabilizing a crystal structure can be enhanced in the case where the additive element such as magnesium exists in the lithium layer while the outermost surface has a layered rock-salt crystal structure as compared with the case where the outermost surface is covered with a rock-salt crystal structure.

Therefore, for example, when a nanobeam electron diffraction pattern of a region ranging from the surface to a depth less than or equal to 1 nm and a nanobeam electron diffraction pattern of a region ranging from a depth from the surface of 3 nm or more to a depth from the surface of 10 nm or less are obtained, a difference between lattice constants calculated from the patterns is preferably small.

For example, a difference between lattice constants calculated from a measured portion from the surface to a depth of 1 nm or less and a measured portion from the surface to a depth of 3 nm or more and 10 nm or less is preferably less than or equal to 0.1×10⁻¹ nm for the a-axis and less than or equal to 1.0×10⁻¹ nm for the c-axis. The difference is further preferably less than or equal to 0.05×10⁻¹ nm for the a-axis and further preferably less than or equal to 0.6×10⁻¹ nm for the c-axis. The difference is still further preferably less than or equal to 0.04×10⁻¹ nm for the a-axis and still further preferably less than or equal to 0.3×10⁻¹ nm for the c-axis.

### <<Surface Roughness and Specific Surface Area>>

The positive electrode active material 100A1 of one embodiment of the present invention preferably has a smooth surface with little unevenness. A smooth surface with little unevenness indicates that an effect of a fusing agent described later has adequately functioned and the surfaces of the additive element source and the lithium cobalt oxide have melted. Thus, a smooth surface with little unevenness indicates favorable distribution of the additive element in the surface portion 100a.

A smooth surface with little unevenness can be determined from, for example, a cross-sectional SEM image or a cross-sectional TEM image of the positive electrode active material 100A1 or the specific surface area of the positive electrode active material 100A1.

The level of the surface smoothness of the positive electrode active material 100A1 can be quantified from its cross-sectional SEM image, as described below, for example.

First, the positive electrode active material 100A1 is processed with an FIB or the like such that its cross section is exposed. At this time, the positive electrode active material 100A1 is preferably covered with the protective film, a protective agent, or the like. Next, a SEM image of the interface between the positive electrode active material 100A1 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100A1 and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square surface roughness (RMS) is obtained by calculating standard deviation. This surface roughness refers to the surface roughness in at least 400 nm of the particle periphery of the positive electrode active material.

On the surface of the particle of the positive electrode active material 100A1 of this embodiment, root-mean-square (RMS) surface roughness, which is an index of roughness, is preferably less than 3 nm, further preferably less than 1 nm, still further preferably less than 0.5 nm.

Note that the image processing software used for the noise processing, the interface extraction, or the like is not particularly limited, and for example, “ImageJ” described in Non-Patent Document 9 to Non-Patent Document 11 can be used. In addition, the spreadsheet software or the like is not particularly limited, and Microsoft Office Excel can be used, for example.

For example, the level of surface smoothness of the positive electrode active material 100A1 can also be quantified from the ratio of an actual specific surface area S_{R} measured by a constant-volume gas adsorption method to an ideal specific surface area Sᵢ.

The ideal specific surface area Sᵢ is calculated on the assumption that all the particles have the same diameter as D50, have the same weight, and have ideal spherical shapes.

The median diameter D50 can be measured with a particle size distribution analyzer or the like using a laser diffraction and scattering method. The specific surface area can be measured with a specific surface area analyzer or the like by a constant-volume gas adsorption method, for example.

In the positive electrode active material 100A1 of one embodiment of the present invention, the ratio of the actual specific surface area S_{R} to the ideal specific surface area Sᵢ obtained from the median diameter D50, S_{R}/Sᵢ, is preferably lower than or equal to 2.1.

Alternatively, the level of the surface smoothness of the positive electrode active material 100A1 can be quantified from its cross-sectional SEM image by the following method.

First, a surface SEM image of the positive electrode active material 100A1 is obtained. At this time, conductive coating may be performed as pretreatment for observation. The surface to be observed is preferably vertical to an electron beam. In the case of comparing a plurality of samples, the same measurement conditions and the same observation area are adopted.

Then, the above SEM image is converted into an 8-bit image (which is referred to as a grayscale image) with the use of image processing software (e.g., ImageJ). The grayscale image includes luminance (brightness information). For example, in an 8-bit grayscale image, luminance can be represented by 2⁸=256 gradation levels. A dark portion has a low gradation level and a bright portion has a high gradation level. A variation in luminance can be quantified in relation to the number of gradation levels. The quantified value is referred to as a grayscale value. By obtaining such a grayscale value, the unevenness of the positive electrode active material can be evaluated quantitatively.

In addition, a variation in luminance in a target region can also be represented with a histogram. A histogram three-dimensionally shows distribution of gradation levels in a target region and is also referred to as a luminance histogram. A luminance histogram enables visually easy-to-understand evaluation of unevenness of the positive electrode active material.

In the positive electrode active material 100A1 of one embodiment of the present invention, the difference between the maximum grayscale value and the minimum grayscale value is preferably less than or equal to 120, further preferably less than or equal to 115, still further preferably greater than or equal to 70 and less than or equal to 115. The standard deviation of the grayscale value is preferably less than or equal to 11, further preferably less than or equal to 8, still further preferably greater than or equal to 4 and less than or equal to 8.

### <<Conditioning>>

A battery including the positive electrode active material 100A1 is preferably subjected to conditioning described below in fabrication.

As a method for conditioning that can be included in the method for fabricating the battery, charge for making the crystal structure of the positive electrode active material 100A1 included in the battery an O3′ type crystal structure can be performed, for example. For charge the battery, conditioning is preferably performed in a state where the shape of the battery is completed or close to completion. The charge step in this case is preferably started from a discharged state, and the discharged state refers to, for example, a state where an open circuit voltage of a lithium-ion secondary battery using lithium cobalt oxide for a positive electrode is lower than or equal to 3.5 V.

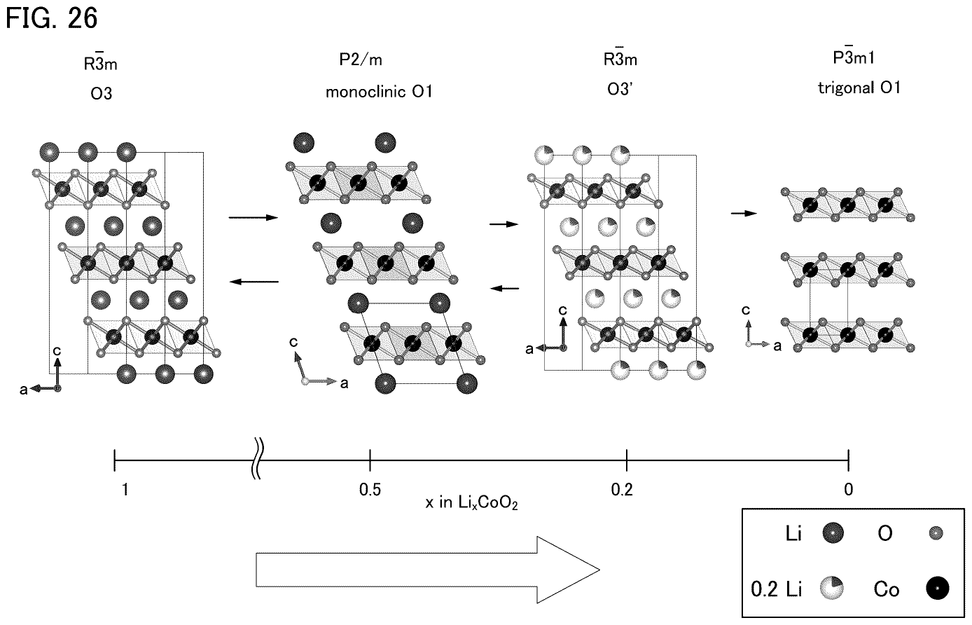

In the method for conditioning the lithium-ion secondary battery in the above-described discharged state, a schematic diagram of a crystal structure with LiₓCoO₂ as the horizontal axis illustrated in FIG. 26 shows lithium cobalt oxide in which the value of x is smaller than 0.5. That is, as indicated by arrows framed by black lines in FIG. 26, the positive electrode active material 100A1 comes to have the O3′ type crystal structure through a monoclinic crystal structure belonging to the space group P2/m that is exhibited at x=0.5 (or in the vicinity thereof) by the conditioning charge. In that case, in the conditioning charge, a hump (also referred to as a plateau in some cases) is sometimes observed in a charge curve (a graph where the horizontal axis is capacitance and the vertical axis is voltage).

Alternatively, when a graph showing a change in the c-axis length with LiₓCoO₂ as the horizontal axis in FIG. 8 is referred to, the c-axis length is approximately the longest at x=0.5 (or the vicinity thereof). That is, it can be said that the positive electrode active material 100A1 comes to have the O3′ type crystal structure through the crystal structure where the c-axis length is the longest by the conditioning charge.

In the conditioning charge, the appropriate charge current is lower than or equal to 1 C, preferably lower than or equal to 0.5 C, further preferably lower than or equal to 0.3 C. This is because in the case of high charge current, unevenness of a change in the crystal structure of the positive electrode active material 100A1, e.g., a difference in the extraction amount of lithium ion occurs between the positive electrode active material 100A1 at a position close to the positive electrode current collector and the positive electrode active material 100A1 at a position far from the positive electrode current collector, which might cause a difference in the crystal structure in the conditioning charge. Note that 1 C can be 200 mA/g per weight of the positive electrode active material. In the case of charge with such a sufficiently low current in the conditioning charge, the above-described hump is sometimes observed in the charge curve.

By performing conditioning after the fabrication of the battery with the above-described conditioning method, the positive electrode active material 100A1 included in the battery can be evenly used in charge and discharge performed after that (e.g., after the shipment of the battery). As a result, a deviation in degradation of the characteristics of the positive electrode active material 100A1 included in the battery can be inhibited.

Note that an effect of using the above-described conditioning method is available even when the positive electrode active material 100A1 is not utilized until the charge depth (charge rate) where the positive electrode active material 100A1 has the O3′ type crystal structure in a device including the battery including the positive electrode active material 100A1 (see Embodiment 5 or 6); thus, the positive electrode active material 100A1 can be evenly used and a deviation in degradation of the characteristics of the positive electrode active material 100A1 can be inhibited.

The above-described conditioning may be performed in the device including the battery including the positive electrode active material 100A1 (see Embodiment 5 or 6). Note that the timing of performing the conditioning is preferably earlier.

This embodiment can be used in appropriate combination with any of the other embodiments.

### Embodiment 3

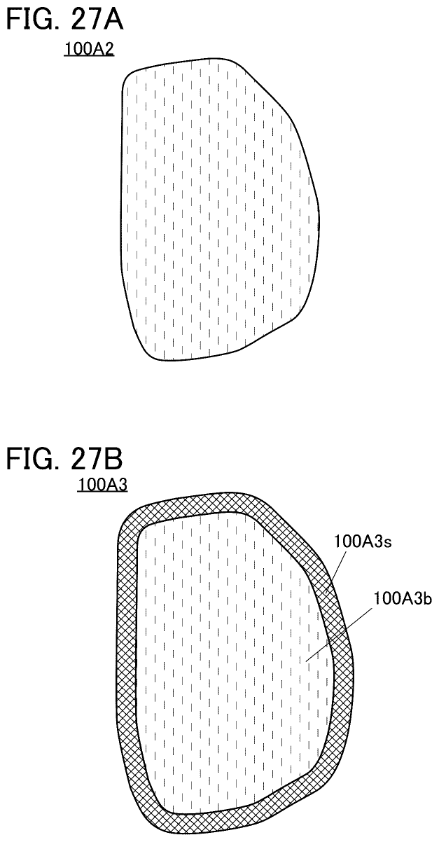

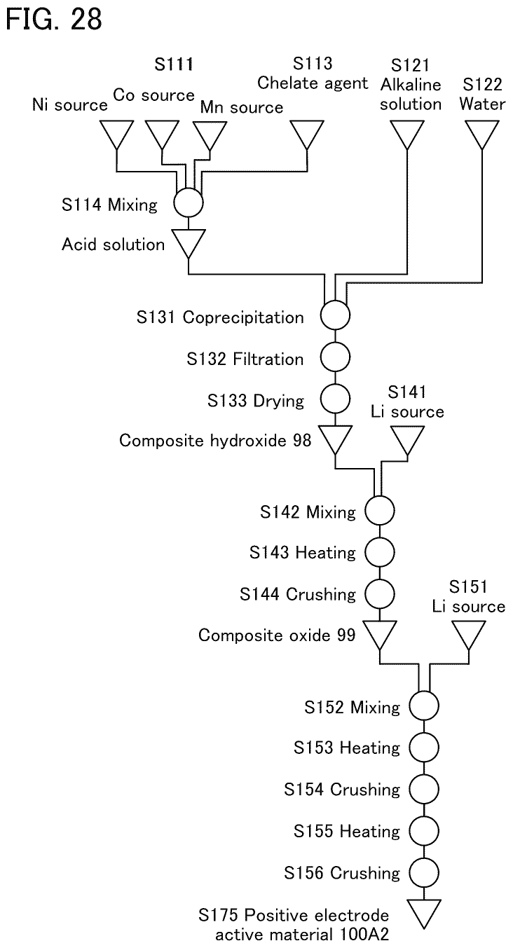

In this embodiment, as an example of the positive electrode active material 100A in Embodiment 1, a positive electrode active material 100A2 that is lithium nickel-cobalt-manganese oxide and a formation method thereof will be described with reference to FIG. 27 to FIG. 28.

FIG. 27A is a schematic cross-sectional view of a particle of the positive electrode active material 100A2. The positive electrode active material 100A2 is lithium nickel-cobalt-manganese oxide and is also referred to as a lithium composite oxide containing nickel, cobalt, and manganese. As described in Embodiment 1, lithium nickel-cobalt-manganese oxide has a layered rock-salt crystal structure belonging to the space group R-3m. When the composition of lithium nickel-cobalt-manganese oxide is represented by LiNiₓCo_{y}Mn_{z}O₂ (x>0, y>0, z>0, and 0.8<x+y+z<1.2), x, y, and z preferably satisfy x:y:z=8:1:1 or the neighborhood thereof. Alternatively, x, y, and z preferably satisfy x:y:z=9:0.5:0.5 or the neighborhood thereof. That is, a high proportion of nickel content that satisfies x>2(y+Z) is preferable. As the composition with a high proportion of nickel content, x, y, and z preferably satisfy x:y:z=6:2:2 or the neighborhood thereof. Alternatively, x, y, and z preferably satisfy x:y:z=5:2:3 or the neighborhood thereof. Note that the composition of the positive electrode active material 100A2 is not particularly limited, and x, y, and z may satisfy x:y:z=1:1:1 or the neighborhood thereof. Alternatively, x, y, and z may satisfy x:y:z=1:4:1 or the neighborhood thereof. Note that in this specification and the like, a value in the neighborhood of a composition refers to a range where the composition is obtained when the significant figure is one digit. At this time, digits below the significant figure are rounded off. For example, x:y:z=4.6:2.3:3.1 can be regarded as a value in the neighborhood of x:y:z=5:2:3.

The particle of the positive electrode active material 100A2 is preferably a primary particle (single particle). Alternatively, in the case where the particle of the positive electrode active material 100A2 is a secondary particle, the number of primary particles included in the secondary particle is preferably small, for example, preferably larger than or equal to 2 and smaller than or equal to 20, further preferably larger than or equal to 2 and smaller than or equal to 15, still further preferably larger than or equal to 2 and smaller than or equal to 10, yet further preferably larger than or equal to 2 and smaller than or equal to 5, yet still further preferably 2.

When the primary particle of lithium nickel-cobalt-manganese oxide or the secondary particle of lithium nickel-cobalt-manganese oxide formed of a small number of primary particles is used as the positive electrode active material 100A2 in such a manner, a large number of the (00l) planes of lithium nickel-cobalt-manganese oxides are aligned with the normal direction of the negative electrode current collector 31; that is, the direction where lithium ions and electrons are likely to move in the positive electrode active material 100A2 is aligned with the normal direction of the negative electrode current collector 31 in the case where the positive electrode active materials 100A2 are oriented in the positive electrode 11 described in Embodiment 1. Accordingly, the charge and discharge of the battery 10 can be smoothly performed and the output characteristics of the battery 10 can be improved.

As the particle size of the positive electrode active material 100A2, the median diameter (D50) measured by a laser diffraction and scattering method is preferably greater than or equal to 0.5 μm and less than or equal to 10 μm, further preferably greater than or equal to 1 μm and less than or equal to 5 μm.

The lithium nickel-cobalt-manganese oxide may include a shell layer on its particle surface. FIG. 27B is a schematic cross-sectional view of a particle of a positive electrode active material 100A3 including an inner portion 100A3b and a shell layer 100A3s. The inner portion 100A3b may be lithium nickel-cobalt-manganese oxide, which is the same as the positive electrode active material 100A2, or may include a composition mixed layer at the boundary with the shell layer 100A3s. The shell layer 100A3s preferably contains, for example, one or more selected from metal oxides such as aluminum oxide and titanium oxide and lithium composite oxides such as lithium niobate and lithium titanate. Note that the composition mixed layer refers to a region where one or more elements contained in the inner portion 100A3b and one or more elements contained in the shell layer 100A3s are each detected by an element analysis means such as STEM-EDX.

Note that the shell layer 100A3s is preferably formed uniformly on the surface of the positive electrode active material 100A3; however, the shell layer 100A3s only needs to be formed at least in a surface portion having a surface other than the (00l) plane where carrier ions are inserted and extracted. In the case where lithium nickel-cobalt-manganese oxide is used as the positive electrode active material 100A3, carrier ions are lithium ions.

### (Formation Method of Positive Electrode Active Material 100A2)

The positive electrode active material particle is formed in the following manner: an aqueous solution to be a nickel source, a cobalt source, and a manganese source is used, a nickel-cobalt-manganese hydroxide obtained by a coprecipitation method and a lithium hydroxide are mixed and subjected to first heat treatment, and then the resulting mixture and a lithium hydroxide are mixed and subjected to second heat treatment again.

A formation process of the positive electrode active material particle will be described below with reference to FIG. 28.

### <Step S111>

In Step S111 in FIG. 28, first, a transition metal M source, i.e., a nickel source (Ni source), a cobalt source (Co source), and a manganese source (Mn source) are prepared. The mixed ratio of nickel, cobalt, and manganese is preferably within a range where a product can have a layered rock-salt crystal structure.

It is particularly preferable that the positive electrode active material 100 contain a large amount of nickel as the transition metal M, in which case the cost of the raw material may be lower than that in the case of containing a large amount of cobalt and charge and discharge capacity per weight may be increased. For example, the proportion of nickel used as the transition metal M is preferably higher than 25 atomic %, further preferably higher than or equal to 60 atomic %, still further preferably higher than or equal to 80 atomic %. However, a too high proportion of nickel might decrease the chemical stability and heat resistance. Thus, the proportion of nickel used as the transition metal M is preferably lower than or equal to 95 atomic %.

A secondary battery preferably contains cobalt as the transition metal M of the positive electrode active material, in which case the average discharge voltage is high and the secondary battery can be highly reliable because cobalt contributes to stabilization of a layered rock-salt structure. Meanwhile, the price of cobalt is higher and more unstable than those of nickel and manganese; thus, a too high proportion of cobalt might increase the cost for manufacturing the secondary battery. For this reason, the proportion of cobalt used as the transition metal M is preferably higher than or equal to 2.5 atomic % and lower than or equal to 34 atomic %.

The positive electrode active material containing manganese as the transition metal M is preferable because the heat resistance and chemical stability are improved. However, a too high proportion of manganese tends to decrease discharge voltage and discharge capacity. For this reason, the proportion of manganese used as the transition metal M is preferably higher than or equal to 2.5 atomic % and lower than or equal to 34 atomic %, for example.

As the transition metal M source, an aqueous solution of a compound containing the transition metal M is prepared. As the nickel source, an aqueous solution of nickel salt can be used. As the nickel salt, nickel sulfate, nickel chloride, nickel nitrate, or a hydrate thereof can be used, for example. Furthermore, an organic acid salt of nickel typified by nickel acetate or a hydrate thereof can also be used. As the nickel source, an aqueous solution of nickel alkoxide or an organic nickel complex can be used. In this specification and the like, the term “organic acid salt” denotes a compound of a metal and an organic acid such as an acetic acid, a citric acid, an oxalic acid, a formic acid, or a butyric acid.

Similarly, as the cobalt source, an aqueous solution of cobalt salt can be used. As the cobalt salt, cobalt sulfate, cobalt chloride, cobalt nitrate, or a hydrate thereof can be used, for example. Furthermore, an organic acid salt of cobalt typified by cobalt acetate or a hydrate thereof can also be used. As the cobalt source, an aqueous solution of cobalt alkoxide or an organic cobalt complex can be used.

Similarly, as the manganese source, an aqueous solution of manganese salt can be used. As the manganese salt, an aqueous solution of manganese sulfate, manganese chloride, manganese nitrate, or hydrate of any of these can be used, for example. Furthermore, an organic acid salt of manganese typified by manganese acetate or a hydrate thereof can also be used. As the manganese source, an aqueous solution of manganese alkoxide or an organic manganese complex can be used.

In this embodiment, an aqueous solution in which nickel sulfate, cobalt sulfate, and manganese sulfate are dissolved in pure water is prepared as the transition metal M source. In this case, the atomic ratio of nickel, cobalt, and manganese is Ni:Co:Mn=8:1:1 or in the neighborhood thereof. The aqueous solution is acidic.

### <Step S113>

As shown in Step S113 in FIG. 28, a chelate agent may be prepared. Examples of the chelate agent include glycine, oxine, 1-nitroso-2-naphthol 2-mercaptobenzothiazole, and EDTA (ethylenediaminetetraacetic acid). Note that two or more kinds selected from glycine, oxine, 1-nitroso-2-naphthol, and 2-mercaptobenzothiazole may be used. At least one of the above is dissolved in pure water and the solution is used as a chelate aqueous solution. The chelate agent serves as a complexing agent to form a chelate compound, and is preferred to a general complexing agent. Needless to say, a complexing agent other than the chelate agent may be used, and ammonia water can be used as the complexing agent. The chelate aqueous solution is preferably used, in which case generation of unnecessary crystal nuclei is suppressed and growth is promoted. Since generation of unnecessary crystal nuclei is suppressed to inhibit generation of fine particles, a composite hydroxide with good particle size distribution can be obtained. In the case where ammonia solution is used as an alkaline solution, an ammonia salt is generated in some cases. Furthermore, the use of the chelate aqueous solution can slow an acid-base reaction, so that the reaction gradually progresses to form a nearly spherical secondary particle. Glycine has a function of keeping the pH constant and greater than or equal to 9 and less than or equal to 10 or the vicinity of the range. A glycine aqueous solution is preferably used as the chelate aqueous solution, in which case control of the pH in the reaction vessel is facilitated in obtaining a composite hydroxide 98 described above. The aqueous solution containing the transition metal and glycine preferably has a glycine concentration higher than or equal to 0.05 mol/L and lower than or equal to 0.3 mol/L, further preferably higher than or equal to 0.07 mol/L and lower than or equal to 0.32 mol/L.

### <Step S114>

Next, in Step S114 in FIG. 28, the transition metal M source and the chelate agent are mixed, so that an acid solution is formed.

### <Step S121>

Next, in Step S121 in FIG. 28, an alkaline solution is prepared. As the alkaline solution, an aqueous solution containing sodium hydroxide, potassium hydroxide, lithium hydroxide, or ammonia can be used, for example. The aqueous solution is preferably formed by using pure water. An aqueous solution in which two or more kinds selected from sodium hydroxide, potassium hydroxide, lithium hydroxide, and ammonia are dissolved in pure water may be used.

The pure water that is preferably used for the transition metal M source and the alkaline solution is water with a resistivity of 1 MΩ·cm or higher, preferably water with a resistivity of 10 MΩ·cm or higher, further preferably water with a resistivity of 15 MΩ·cm or higher. Water with the above-described resistivity has high purity and an extremely small amount of impurities.

### <Step S122>

As shown in Step S122 in FIG. 28, water is preferably prepared in a reaction vessel. The water may be an aqueous solution of a chelate agent, and pure water is preferably used. The use of pure water promotes nucleation, leading to formation of a composite hydroxide with a small particle diameter. The water prepared in a reaction vessel can be referred to as an adjustment liquid or a filling liquid in the reaction vessel. For the case of using a chelate aqueous solution, the description for Step S113 can be referred to.

### <Step S131>

Next, in Step S131 in FIG. 28, an acid solution and an alkaline solution are mixed to be reacted with each other. The reaction can be referred to as a coprecipitation reaction, a neutralization reaction, or an acid-base reaction.

During the coprecipitation reaction of Step S131, the pH of the reaction system is preferably higher than or equal to 9.0 and lower than or equal to 13.0.

For example, when an alkaline solution is put in a reaction vessel and an acid solution is added into the reaction vessel, the pH of the aqueous solution in the reaction vessel is preferably kept in the above range. Similarly, the same applies to a case where the acid solution is put in the reaction vessel and the alkaline solution is added thereinto. The liquid delivery rate of the acid solution is preferably less than or equal to 0.1 mL/min, in which case the pH condition can be controlled easily. The tank in which the acid solution is stored is equipped with a pump and the acid solution can be added into the reaction vessel through a tube with use of the pump. The adding amount of the acid solution, that is the amount of the delivered liquid, can be controlled with the pump.

The alkaline solution is added such that the pH of the aqueous solution in the reaction vessel is kept constant. The reaction vessel contains a reaction container or the like.

The aqueous solution in the reaction vessel is preferably stirred with a stirring means. The stirring means includes a stirrer, an impeller, or the like. The impeller can have two to six agitator blades; for example, in the case where four agitator blades are provided, they are preferably arranged to make a cross shape seen from above. The rotation number of the stirring means is preferably greater than or equal to 800 rpm and less than or equal to 1200 rpm. A baffle plate may be provided in the reaction vessel to change the stirring direction and the rate of flow. The provision of a baffle plate improves mixing efficiency and allows synthesis of composite hydroxide particles with more uniform.

The temperature of the reaction vessel is preferably controlled to be higher than or equal to 50° C. and lower than or equal to 90° C. After the temperature of the reaction vessel falls within the above temperature range, addition of the alkaline solution or the acid solution is preferably started.

The reaction vessel preferably has an inert atmosphere. In this case, nitrogen or argon can be used as the inert atmosphere. In the case of the nitrogen atmosphere, a nitrogen gas is preferably introduced at a flow rate of 0.5 L/min or more and 2 L/min or less.

In the reaction vessel, a reflux condenser is preferably placed. The nitrogen gas can be released from the reaction vessel and water vapor can be returned to the reaction vessel with use of the reflux condenser.

Through the above-described coprecipitation reaction, the composite hydroxide 98 containing the transition metal M is precipitated.

### <Step S132>

Filtration is preferably performed to collect the composite hydroxide 98 as shown in Step S132 in FIG. 28. Suction filtration is preferred for the filtration. In the filtration, an organic solvent (e.g., acetone) may be used for filtration after a reaction product precipitated in the reaction vessel is washed with pure water.

### <Step S133>

As shown in Step S133 in FIG. 28, the composite hydroxide 98 after the filtration is preferably dried. For example, drying is performed in a vacuum at higher than or equal to 60° C. and lower than or equal to 200° C. for longer than or equal to 0.5 hours and shorter than or equal to 20 hours. For example, the drying can be performed for 12 hours.

In this manner, the composite hydroxide 98 containing the transition metal M can be obtained. In this specification and the like, the composite hydroxide 98 denotes a hydroxide of a plurality of metals. The composite hydroxide 98 can be referred to as a precursor of the positive electrode active material.

### <Step S141>

Next, in Step S141 in FIG. 28, a lithium source is prepared. In a formation process of a particle of the positive electrode active material, a step for adding a lithium source is performed a plurality of times; thus, the amount of lithium prepared in Step S141 is smaller than the final required amount of lithium. For example, when the sum of atoms of nickel, cobalt, and manganese is 1, the lithium atom can be greater than or equal to 0.5 and less than or equal to 0.9 (atomic ratio), and is preferably 0.7 (atomic ratio).

As the lithium source, for example, lithium hydroxide, lithium carbonate, or lithium nitrate can be used. In particular, a material having a low melting point among lithium compounds, such as lithium hydroxide (melting point: 462° C.), is preferably used. Since a positive electrode active material containing nickel at a high proportion easily causes cation mixing as compared with lithium cobalt oxide or the like, heating in Step S43 and the like needs to be performed at low temperatures. Therefore, it is preferable to use a material having a low melting point.

The particle diameter of the lithium source is preferably small because it facilitates a favorable reaction. A lithium source microparticulated by fluidized bed jet milling can be used, for example. The particle diameter here refers to a median diameter.

### <Step S142>

Next, in Step S142 in FIG. 28, the composite hydroxide 98 and the lithium source are mixed. The mixing can be performed by a dry process or a wet process. For example, a ball mill, a bead mill, or a mixer can be used for the mixing. When a ball mill is used, zirconia balls are preferably used as media, for example. When a ball mill, a bead mill, or the like is used, the peripheral speed is preferably greater than or equal to 100 mm/sec and less than or equal to 2000 mm/sec in order to inhibit contamination from the media or the material. The composite hydroxide 98 and the lithium compound are sometimes pulverized during the mixing.

### <Step S143>

Then, heating is performed on the mixture of the composite hydroxide 98 and the lithium source. For distinction between the heating steps, Step S143, Step S153, and Step S155 in FIG. 28 may be referred to as first heating, second heating, and third heating, respectively.

An electric furnace or a rotary kiln furnace can be used as a firing device for the heating. A crucible, a sagger, a setter, or a container used in the heating is preferably made of a material that hardly releases impurities. For example, a crucible made of aluminum oxide with a purity of 99.9% can be used. Such a container is preferably heated with the lid on.

The heating in Step S143 is preferably performed at a temperature higher than or equal to 400° C. and lower than or equal to 750° C., further preferably higher than or equal to 650° C. and lower than or equal to 750° C. The time for the heating in Step S143 is preferably longer than or equal to 1 hour and shorter than or equal to 30 hours, further preferably longer than or equal to 2 hours and shorter than or equal to 20 hours.

The heating is preferably performed in an atmosphere containing oxygen or an oxygen-containing atmosphere that is what is called dry air with little water (e.g., with a dew point lower than or equal to −50° C., preferably lower than or equal to −80° C.).

Furthermore, a crushing step is preferably performed in Step S144 after the heating. The crushing can be performed in a mortar, for example. Furthermore, classification may be performed using a sieve. With the crushing step, the particle diameter and/or the shape of the positive electrode active material 100A2 can be uniformized. Through the above steps, a composite oxide 99 is obtained.

### <Step S151>

Next, in Step S151, a lithium source is prepared. At this time, the lithium source is prepared such that the total amount of lithium source prepared in this step and Step S141 is the final required amount of lithium. For example, when the total number of atoms of nickel, cobalt, and manganese is 1 and the number of lithium atoms is 0.7 (atomic ratio) in Step S141, 0.31 (atomic ratio) is preferably prepared in Step S151. Here, the final required amount of lithium atom is 1.01 when the total number of atoms of nickel, cobalt, and manganese is 1; however, one embodiment of the present invention is not limited thereto. The final required amount of lithium when the total number of atoms of nickel, cobalt, and manganese is 1 is preferably greater than or equal to 0.95 and less than or equal to 1.25, further preferably greater than or equal to 1.00 and less than or equal to 1.05. The description in Step S141 except for the amount of the lithium source to be prepared can be referred to.

Although a method in which the lithium source is added twice in Step S141 and Step S151 and heating is performed after each of the steps is described with reference to FIG. 28, one embodiment of the present invention is not limited thereto. The lithium source may be added three or more times and heating may be performed after each of the steps.

### <Step S152>

Then, the composite oxide 99 obtained in Step S144 and the lithium source are mixed. For the mixing, the description of Step S142 can be referred to.

### <Step S153>

Subsequently, heating is performed on the mixture of the composite oxide 99 and the lithium source. The heating in Step S153 is preferably performed at sufficiently high temperatures to increase the crystallite size of the positive electrode active material 100A2. The temperature range may depend on the composition of the transition metal M.

In the case where the proportion of nickel in the transition metal M is high, e.g., higher than or equal to 70%, the heating temperature in Step S153 is preferably higher than or equal to 750° C., further preferably higher than or equal to 800° C., still further preferably higher than or equal to 850° C., for example. Meanwhile, too high heating temperatures might cause reduction of the transition metal M such as nickel to the divalent state, for example. Accordingly, the heating temperature is preferably lower than or equal to 950° C., further preferably lower than or equal to 920° C., still further preferably lower than or equal to 900° C., for example.

In the case where the proportion of nickel in the transition metal M is higher than or equal to 40% and lower than or equal to 60%, the heating temperature is preferably higher than or equal to 900° C., further preferably higher than or equal to 950° C., still further preferably around 970° C., for example. Meanwhile, too high heating temperatures might cause the above disadvantage; accordingly, the heating temperature is preferably lower than or equal to 1020° C., further preferably lower than or equal to 990° C. For the other conditions of the heating, the description of Step S143 can be referred to.

Furthermore, a crushing step is preferably performed in Step S154 after the heating. The description of Step S144 can be referred to for the crushing.

### <Step S155>

In addition, the heating in Step S155 is preferably performed. The heating can reduce the residue of the lithium source or the like. The heating in Step S155 is preferably performed at a temperature higher than or equal to 400° C. and lower than or equal to 900° C., further preferably higher than or equal to 750° C. and lower than or equal to 850° C. The time for the heating in Step S152 is preferably longer than or equal to 1 hour and shorter than or equal to 30 hours, further preferably longer than or equal to 2 hours and shorter than or equal to 20 hours. Note that the heating in Step S155 is not necessarily performed. For the other conditions of the heating, the description of Step S143 can be referred to.

Furthermore, a crushing step is preferably performed in Step S156 after the heating. The description of Step S144 can be referred to for the crushing.

Although a method in which heating is performed twice in Step S153 and Step S155 after the lithium source is mixed in Step S151 is described with reference to FIG. 28, one embodiment of the present invention is not limited thereto. Heating may be performed three or more times.

Through the above steps, the positive electrode active material 100A2 can be formed.

The above mixing ratio of the metal contained in the positive electrode active material 100A2 can be measured by analysis by X-ray photoelectron spectroscopy (XPS), inductively coupled plasma mass spectrometry (ICP-MS), or energy dispersive X-ray spectroscopy (TEM-EDX).

The obtained positive electrode active material 100A2 preferably has a crystallite size, which is calculated from an XRD pattern, greater than or equal to 150 nm. In order to synthesize lithium nickel-manganese-cobalt oxide with a large crystallite size, it is effective to perform a process of lithium source addition and heating a plurality of times.

### (Formation Method of Positive Electrode Active Material 100A4)

As the positive electrode active material 100, not only lithium nickel-cobalt-manganese oxide, such as the positive electrode active material 100A2, but also lithium nickel-cobalt-manganese-aluminum oxide obtained by adding aluminum to lithium nickel-cobalt-manganese oxide (a positive electrode active material 100A4) may be used.

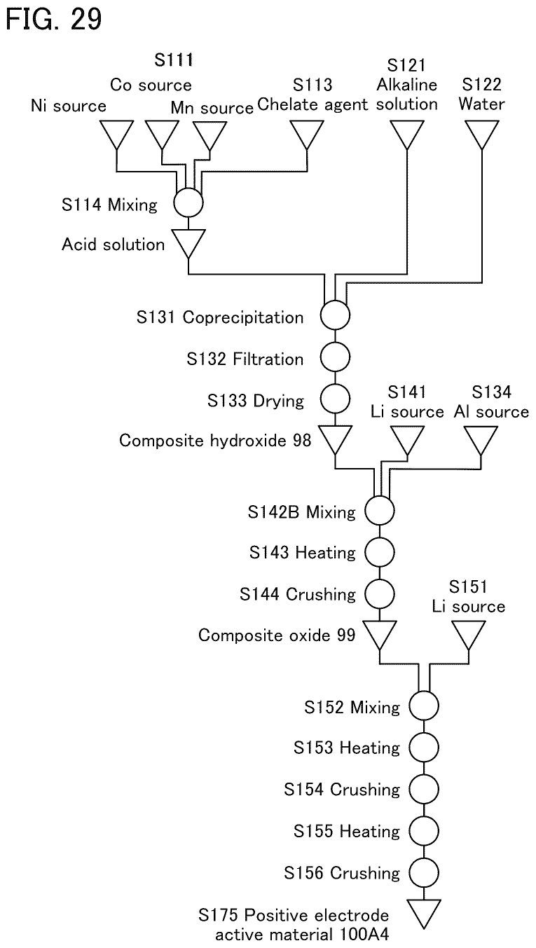

As a method for forming lithium nickel-cobalt-manganese-aluminum oxide, for example, an aluminum source in addition to the composite hydroxide 98 and the lithium source are preferably mixed in Step S142 of the method for forming the positive electrode active material 100A2. Such a method for forming lithium nickel-cobalt-manganese-aluminum oxide is illustrated in FIG. 29.

### <Step S134>

As Step S134 in FIG. 29, a step of preparing an aluminum source is described. As the aluminum source, aluminum hydroxide, aluminum sulfate, aluminum chloride, and aluminum nitrate can be used. The amount of aluminum atoms to be added is, for example, within a range of greater than or equal to 0.005 and less than or equal to 0.05 (atomic ratio) when the sum of atoms of nickel, cobalt, and manganese is 1.

The method for forming lithium nickel-cobalt-manganese-aluminum oxide in FIG. 29 can be the same as that in FIG. 28 except for the step of preparing the aluminum source in Step S134 and the step of mixing the composite hydroxide 98, the lithium source, and the aluminum source in Step S142B. The lithium nickel-cobalt-manganese-aluminum oxide formed in this manner is the positive electrode active material 100A4.

The positive electrode active material 100A4 formed by the method described with reference to FIG. 29 contains aluminum at a substantially uniform concentration in an inner portion of the particle, and thus can increase the storage capacity of a lithium-ion secondary battery and improve the cycle performance thereof.

This embodiment can be used in appropriate combination with any of the other embodiments.

### Embodiment 4

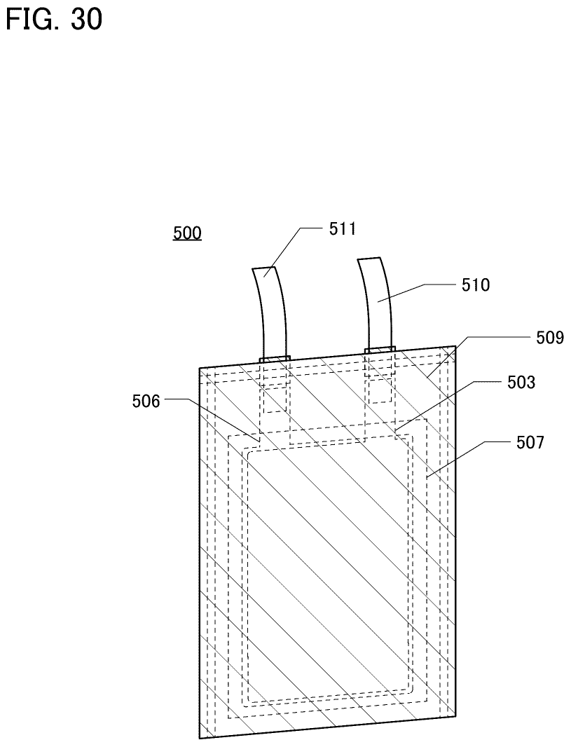

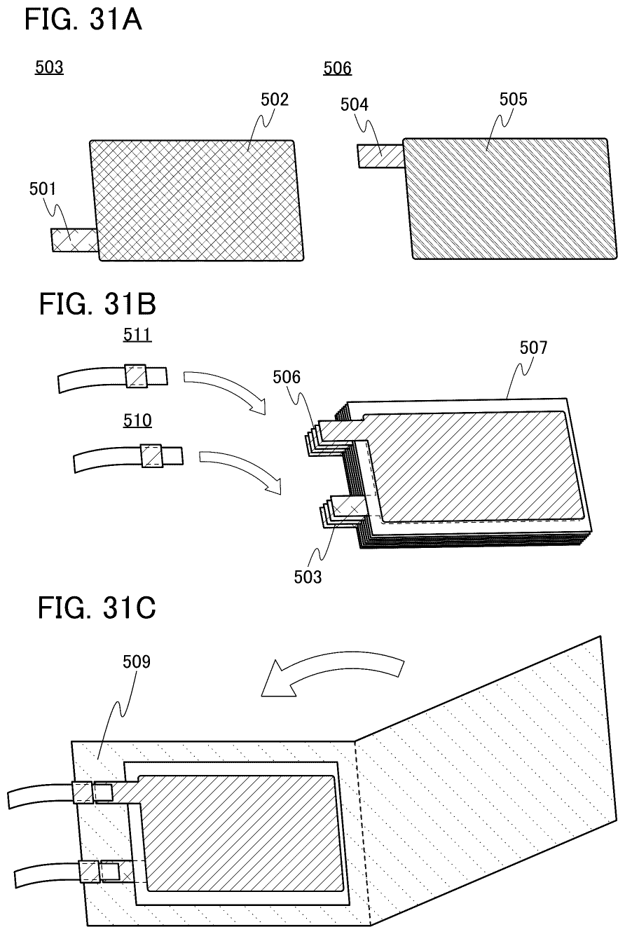

In this embodiment, examples of the secondary battery of one embodiment of the present invention will be described with reference to FIG. 30 and FIG. 31.

### <Structure Example of Secondary Battery>

Hereinafter, a secondary battery in which a positive electrode, a negative electrode, and an electrolyte solution are wrapped in an exterior body and illustrated in FIG. 30 is described as an example.

### [Positive Electrode]

The positive electrode includes a positive electrode active material layer and a positive electrode current collector. The positive electrode active material layer includes a positive electrode active material, and may include a conductive material (also referred to as a conductive additive) and a binder. As the positive electrode active material, the positive electrode active material formed by the formation method described in the above embodiment is used.

The positive electrode active material described in the above embodiment and another positive electrode active material may be mixed to be used.

Examples of the another positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ is given.

As another positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

As the conductive material, a carbon-based material such as acetylene black can be used. In addition, a carbon nanotube, graphene, or a graphene compound can be used as the conductive material.

A graphene compound in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

A graphene compound sometimes has excellent electrical characteristics of high conductivity and excellent physical properties of high flexibility and high mechanical strength. A graphene compound has a sheet-like shape. A graphene compound has a curved surface in some cases, thereby enabling low-resistant surface contact. Furthermore, a graphene compound sometimes has extremely high conductivity even with a shape with a small thickness, and thus a small amount of a graphene compound efficiently allows a conductive path to be formed in an active material layer. Hence, when a graphene compound is used as the conductive material, the area where the active material and the conductive material are in contact with each other can be increased. The graphene compound preferably covers 80% or more of the active material.

In the case where an active material particle with a small diameter, e.g., 1 μm or less, is used, the specific surface area of the active material particles is large and thus more conductive paths for connecting the active material particles are needed. In such a case, it is preferable to use a graphene compound that can efficiently form a conductive path even with a small amount.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have rapid charge and rapid discharge characteristics in some cases. In addition, a mobile electronic device or the like is required to have rapid charge characteristics in some cases. Rapid charge and discharge are referred to as charge and discharge at, for example, 200 mA/g, 400 mA/g, or 1000 mA/g or more.

A plurality of sheets of graphene or a plurality of graphene compounds are formed to partly coat or adhere to surfaces of a plurality of particles of a positive electrode active material, so that the plurality of graphenes or the plurality of graphene compounds preferably make surface contact with the particles of the positive electrode active material.

Here, the plurality of sheets of graphene or the plurality of graphene compounds can be bonded to each other to form a net-like graphene compound sheet (hereinafter, referred to as a graphene compound net or a graphene net). A graphene net that covers the active material can function as a binder for bonding the active material particles. Accordingly, the amount of the binder can be reduced, or the binder does not have to be used. This can increase the proportion of the active material in the electrode volume and the electrode weight. That is to say, the discharge capacity of the secondary battery can be increased.

A material used in formation of the graphene compound may be mixed with the graphene compound to be used for an active material layer. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

### [Binder]

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

### [Current Collector]

The current collector can be formed using a material that has high conductivity, such as a metal like stainless steel, gold, platinum, aluminum, or titanium, or an alloy thereof. It is preferable that a material used for the positive electrode current collector not dissolve at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer may include a conductive material and a binder.

### [Negative Electrode Active Material]

As the negative electrode active material, an alloy-based material and/or a carbon-based material can be used, for example.

For the negative electrode active material, an element that enables charge and discharge reactions by an alloying reaction and a dealloying reaction with lithium can be used. For example, a material containing one or two or more selected from silicon, tin, gallium, aluminum, germanium, lead, antimony, bismuth, silver, zinc, cadmium, indium, and the like can be used. Such elements have higher charge and discharge capacity than carbon; in particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Alternatively, SiO can be expressed as SiOₓ. Here, x is preferably 1 or an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferable because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those for the conductive material and the binder that can be included in the positive electrode active material layer can be used.

### [Negative Electrode Current Collector]

For the negative electrode current collector, a material similar to that of the positive electrode current collector can be used. Note that a material that does not alloy with carrier ions of lithium or the like is preferably used for the negative electrode current collector.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more ionic liquids (room temperature molten salts) that are unlikely to burn and volatize as the solvent of the electrolyte solution can prevent the secondary battery from exploding and/or igniting even when the internal temperature increases owing to an internal short circuit, overcharge, or the like in the secondary battery. An ionic liquid contains a cation and an anion, specifically, an organic cation and an organic anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination at an appropriate ratio.

As the electrolyte solution used for the secondary battery, it is preferable to use an electrolyte solution that is highly purified and contains a small amount of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

An additive agent such as vinylene carbonate, propane sultone (PS), tert-butylbenzene (TBB), fluoroethylene carbonate (FEC), lithium bis(oxalate)borate (LiBOB), a dinitrile compound such as succinonitrile or adiponitrile, fluorobenzene, or ethylene glycol bis(propionitrile) ether may be added to the electrolyte solution. The concentration of the material to be added in the whole solvent is, for example, higher than or equal to 0.1 wt % and lower than or equal to 5 wt %. It is particularly preferable to use VC or LiBOB because it facilitates formation of a favorable coating portion.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, a solid electrolyte including a polymer material such as a PEO (polyethylene oxide)-based polymer material, or the like can be used. When the solid electrolyte is used, a separator and/or a spacer is not necessary. Furthermore, the battery can be entirely solidified; therefore, there is no possibility of liquid leakage and thus the safety of the battery is dramatically improved.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charge can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is to be in contact with the positive electrode may be coated with the mixed material of aluminum oxide and aramid, and a surface of the polypropylene film that is to be in contact with the negative electrode may be coated with the fluorine-based material.

The use of a separator having a multilayer structure makes it possible to maintain the safety of the secondary battery even when the total thickness of the separator is small, so that the discharge capacity per volume of the secondary battery can be increased.

### [Exterior Body]

For an exterior body included in the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### <Laminated Secondary Battery and Fabricating Method Thereof>

FIG. 30 and FIG. 31 illustrate examples of the external view of a laminated secondary battery 500. In FIG. 30 and FIG. 31, a positive electrode 503, a negative electrode 506, a separator 507, an exterior body 509, a positive electrode lead electrode 510, and a negative electrode lead electrode 511 are included. When the laminated secondary battery has flexibility and is used in an electronic device at least part of which is flexible, the secondary battery can be bent as the electronic device is bent. An example of a method for fabricating the laminated secondary battery will be described with reference to FIG. 31A to FIG. 31C.

First, the negative electrode 506, the separator 507, and the positive electrode 503 are stacked. FIG. 31B illustrates the negative electrodes 506, the separators 507, and the positive electrodes 503 that are stacked. Here, an example in which five negative electrodes and four positive electrodes are used is illustrated. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 31C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that an electrolyte solution can be introduced later.

Next, the electrolyte solution (not illustrated) is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

When the positive electrode active material described in the above embodiment is used in the positive electrode 503, the secondary battery 500 with high discharge capacity and excellent cycle performance can be obtained.

This embodiment can be used in appropriate combination with any of the other embodiments.

### Embodiment 5

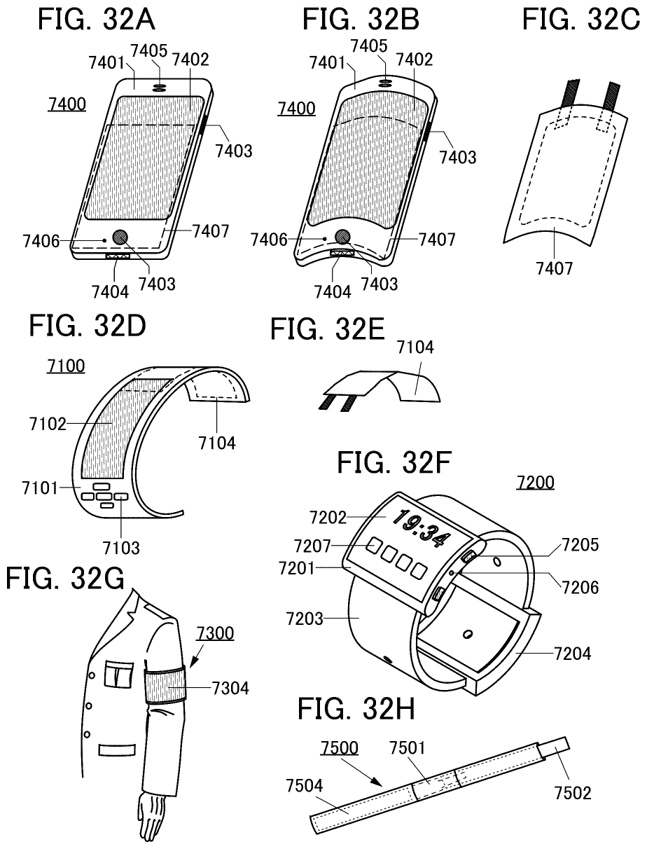

In this embodiment, examples of electronic devices each including the secondary battery of one embodiment of the present invention will be described with reference to FIG. 32A to FIG. 34C.

FIG. 32A to FIG. 32G illustrate examples of electronic devices each including the secondary battery containing a positive electrode active material described in the above embodiment. Examples of electronic devices each including the secondary battery include television devices (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

Furthermore, a flexible secondary battery can be incorporated along a curved inside or outside wall surface of a house, a building, or the like or a curved interior or exterior surface of an automobile.

FIG. 32A illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 32B illustrates the state where the mobile phone 7400 is curved. When the whole mobile phone 7400 is bent by the external force, the secondary battery 7407 included in the mobile phone 7400 is also bent. FIG. 32C illustrates the bent secondary battery 7407. The secondary battery 7407 is a thin storage battery. The secondary battery 7407 is fixed in a state of being bent. Note that the secondary battery 7407 includes a lead electrode electrically connected to a current collector.

FIG. 32D illustrates an example of a bangle-type display device. A portable display device 7100 includes a housing 7101, a display portion 7102, operation buttons 7103, and a secondary battery 7104. FIG. 32E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature greater than or equal to 40 mm and less than or equal to 150 mm. When the radius of curvature at the main surface of the secondary battery 7104 is in the range greater than or equal to 40 mm and less than or equal to 150 mm, the reliability can be kept high. When the secondary battery of one embodiment of the present invention is used as the secondary battery 7104, a lightweight portable display device with a long lifetime can be provided.

FIG. 32F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication based on an existing communication standard. For example, mutual communication with a headset capable of wireless communication enables hands-free calling.

Moreover, the portable information terminal 7200 includes the input/output terminal 7206, and data can be directly transmitted to and received from another information terminal via a connector. In addition, charge via the input/output terminal 7206 is possible. Note that the charge operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 32E can be provided in the housing 7201 while being curved, or can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 32G illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication based on an existing communication standard.

The display device 7300 includes an input/output terminal, and data can be directly transmitted to and received from another information terminal via a connector. In addition, charge via the input/output terminal is possible. Note that the charge operation may be performed by wireless power feeding without using the input/output terminal.

When the secondary battery of one embodiment of the present invention is used as the secondary battery included in the display device 7300, a lightweight display device with a long lifetime can be provided.

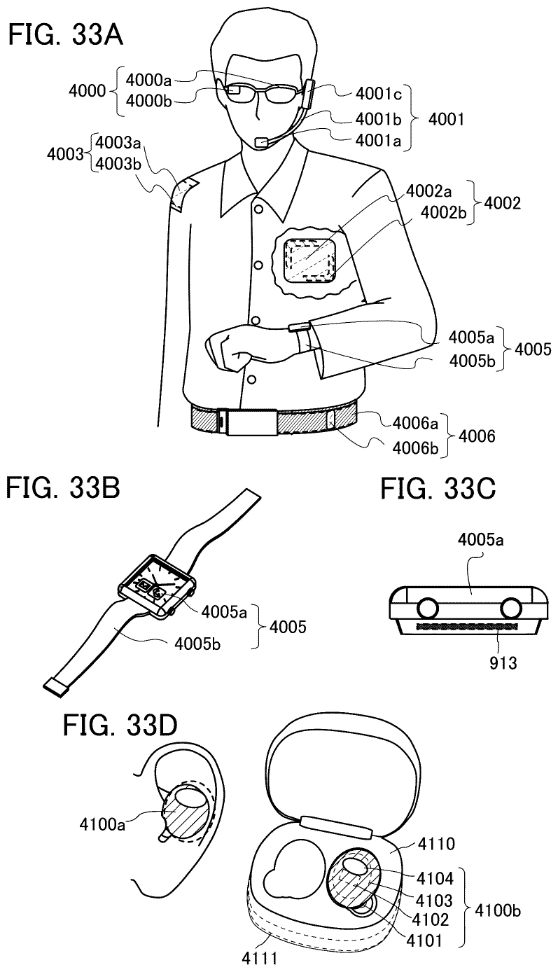

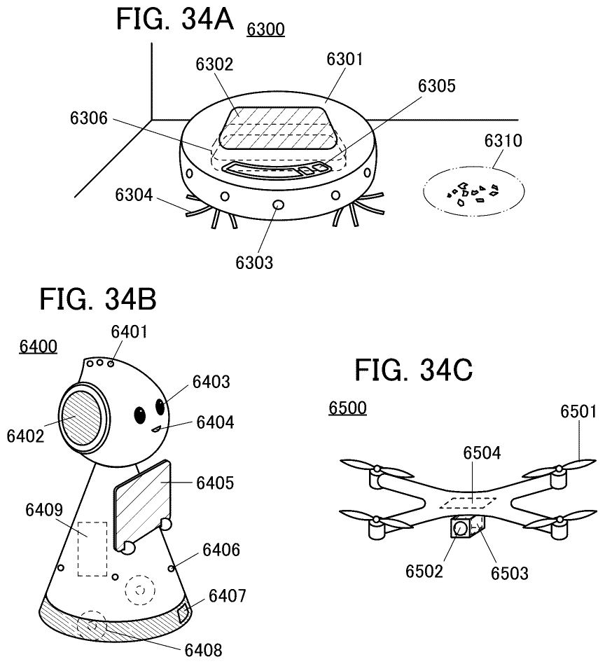

Examples of electronic devices each including the secondary battery with excellent cycle performance described in the above embodiment are described with reference to FIG. 32H, FIG. 33, and FIG. 34.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high discharge capacity are desired in consideration of handling ease for users.

FIG. 32H is a perspective view of a device called a cigarette smoking device (electronic cigarette). In FIG. 32H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and overdischarge of the secondary battery 7504 may be electrically connected to the secondary battery 7504. The secondary battery 7504 illustrated in FIG. 32H includes an external terminal for connection to a charger. When the electronic cigarette 7500 is held, the secondary battery 7504 is a tip portion; thus, it is preferable that the secondary battery 7504 have a short total length and be lightweight. With the secondary battery of one embodiment of the present invention, which has high discharge capacity and excellent cycle performance, the small and lightweight electronic cigarette 7500 that can be used for a long time over a long period can be provided.

FIG. 33A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 33A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b and/or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 33B is a perspective view of the watch-type device 4005 that is detached from an arm.

FIG. 33C is a side view. FIG. 33C illustrates a state where a secondary battery 913 is incorporated in the watch-type device 4005. The secondary battery 913 is the secondary battery described in Embodiment 6. The secondary battery 913, which is small and lightweight, is provided at a position overlapping with the display portion 4005a.

FIG. 33D illustrates an example of wireless earphones. The wireless earphones illustrated here include, but are not limited to, a pair of main bodies 4100a and 4100b.

The main body 4100a and the main body 4100b each include a driver unit 4101, an antenna 4102, and a secondary battery 4103. A display portion 4104 may also be included. Moreover, a substrate where a circuit such as a wireless IC is provided, a terminal for charge, and the like are preferably included. Furthermore, a microphone may be included.

A case 4110 includes a secondary battery 4111. Moreover, a substrate where a circuit such as a wireless IC or a charge control IC is provided, and a terminal for charge are preferably included. Furthermore, a display portion, a button, and the like may be included.

The main body 4100a and the main body 4100b can communicate wirelessly with another electronic device such as a smartphone. Thus, sound data and the like transmitted from another electronic device can be played through the main body 4100a and the main body 4100b. When the main body 4100a and the main body 4100b include a microphone, sound captured by the microphone is transmitted to another electronic device, and sound data obtained by processing with the electronic device can be transmitted to and played through the main body 4100a and the main body 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the above embodiment, for example, can be used. A secondary battery whose positive electrode includes the positive electrode active material 100 obtained in Embodiment 2 has a high energy density; thus, with the use of the secondary battery as the secondary battery 4103 and the secondary battery 4111, space saving required with downsizing of the wireless earphones can be achieved.

FIG. 34A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not shown, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes the secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 34B illustrates an example of a robot. A robot 6400 illustrated in FIG. 34B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of capturing an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 34C illustrates an example of a flying object. A flying object 6500 illustrated in FIG. 34C includes propellers 6501, a camera 6502, a secondary battery 6503, and the like and has a function of flying autonomously.

For example, image data captured by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with the other embodiments.

### Embodiment 6

In this embodiment, examples of vehicles each including a secondary battery containing a positive electrode active material of one embodiment of the present invention will be described.

The use of secondary batteries in vehicles enables production of next-generation clean energy vehicles such as hybrid electric vehicles (HVs), electric vehicles (EVs), and plug-in hybrid electric vehicles (PHVs).

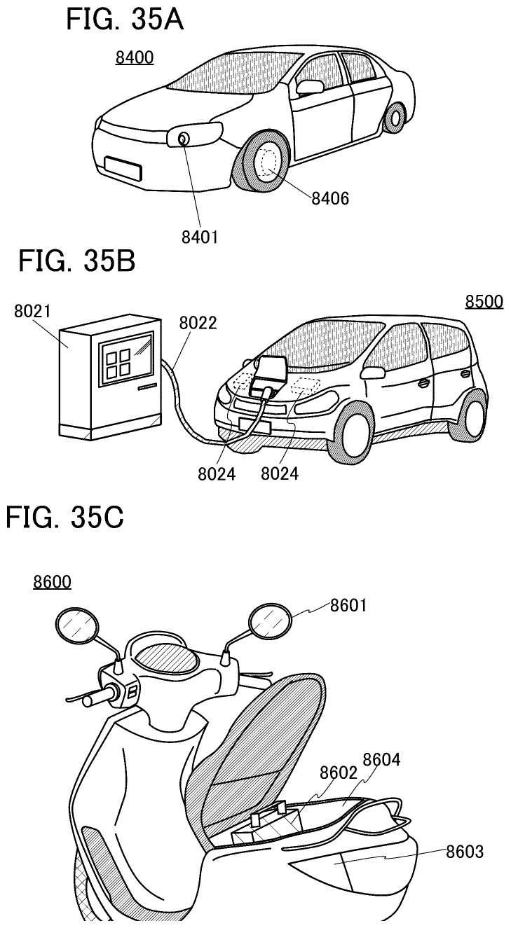

FIG. 35 illustrates examples of a vehicle including the secondary battery of one embodiment of the present invention. An automobile 8400 illustrated in FIG. 35A is an electric vehicle that runs on the power of an electric motor. Alternatively, the automobile 8400 is a hybrid electric vehicle capable of appropriately selecting and using an electric motor and an engine as a power source for driving. The use of one embodiment of the present invention can achieve a high-mileage vehicle. The automobile 8400 includes the secondary battery. For example, the modules of the secondary battery can be arranged in a floor portion in the automobile to be used. The secondary battery can be used not only for driving an electric motor 8406, but also for supplying electric power to a light-emitting device such as a headlight 8401 and a room light (not illustrated).

The secondary battery can also supply power to a display device included in the automobile 8400, such as a speedometer or a tachometer. Furthermore, the secondary battery can supply power to a semiconductor device included in the automobile 8400, such as a navigation system.

An automobile 8500 illustrated in FIG. 35B can be charged when the secondary battery included in the automobile 8500 is supplied with electric power through external charge equipment by a plug-in system, a contactless power feeding system, and/or the like. FIG. 35B illustrates a state where a secondary battery 8024 provided in the automobile 8500 is charged from a ground installation type charge apparatus 8021 through a cable 8022. In charge, a given method such as CHAdeMO (registered trademark) or Combined Charging System may be employed as a charge method, the standard of a connector, and the like as appropriate. The charge apparatus 8021 may be a charging station provided in a commerce facility or a power source in a house. For example, with the use of a plug-in technique, the secondary battery 8024 provided in the automobile 8500 can be charged by being supplied with power from outside. The charge can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charge can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves. To supply electric power in such a contactless manner, an electromagnetic induction method and/or a magnetic resonance method can be used.

In addition, FIG. 35C is an example of a motorcycle using the secondary battery of one embodiment of the present invention. A motor scooter 8600 illustrated in FIG. 35C includes a secondary battery 8602, side mirrors 8601, and direction indicators 8603. The secondary battery 8602 can supply electricity to the direction indicators 8603.

Furthermore, in the motor scooter 8600 illustrated in FIG. 35C, the secondary battery 8602 can be stored in an under-seat storage 8604. The secondary battery 8602 can be stored in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and the discharge capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power supply source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

This embodiment can be implemented in appropriate combination with the other embodiments.

### REFERENCE NUMERALS

10: battery, 11: positive electrode, 12: negative electrode, 13: separator, 21: positive electrode current collector, 22: positive electrode active material layer, 31: negative electrode current collector, 32: negative electrode active material layer, 41: conductive material, 51: electrolyte, 98: composite hydroxide, 99: composite oxide, 100: positive electrode active material, 100A: positive electrode active material, 100B: positive electrode active material, 100a: surface portion, 100b: inner portion, 110a: rotary kiln, 110: rotary kiln, 111a: kiln main body, 111: kiln main body, 112: heating unit, 113: material supply unit, 114: material collection unit, 115: control board, 116: atmosphere control unit, 117: blade, 118: plate, 119: vibration unit, 120: measurement device, 121: gas supply unit, 122: gas exhaust unit, 500: secondary battery, 503: positive electrode, 506: negative electrode, 507: separator, 509: exterior body, 510: positive electrode lead electrode, 511: negative electrode lead electrode, 903: mixture, 913: secondary battery

1. A lithium-ion secondary battery comprising a positive electrode and a negative electrode,
wherein the positive electrode comprises a positive electrode current collector and a positive electrode active material layer over the positive electrode current collector,
wherein the negative electrode comprises a negative electrode current collector and a negative electrode active material layer over the negative electrode current collector, and
wherein in a region where the positive electrode current collector and the negative electrode current collector face each other:
the positive electrode active material layer comprises a positive electrode active material;
the positive electrode active material has a layered rock-salt crystal structure belonging to a space group R-3m; and
an angle formed by a normal of the negative electrode current collector and a c-axis of the crystal structure of 50% or more of the number of particles of the positive electrode active material in the positive electrode active material layer is greater than or equal to 60° and less than or equal to 120°.

2. The lithium-ion secondary battery according to claim 1,
wherein the positive electrode active material layer comprises graphene, and
wherein the positive electrode active material comprises a region in contact with the graphene at a surface having a normal in a direction intersecting the c-axis of the crystal structure.

3. The lithium-ion secondary battery according to claim 1,
wherein the positive electrode active material is a lithium composite oxide comprising cobalt.

4. The lithium-ion secondary battery according to claim 1,
wherein the positive electrode active material is a lithium composite oxide comprising nickel, cobalt, and manganese.

5. A lithium-ion secondary battery comprising a positive electrode and a negative electrode,
wherein the positive electrode comprises a positive electrode current collector and a positive electrode active material layer over the positive electrode current collector,
wherein the negative electrode comprises a negative electrode current collector and a negative electrode active material layer over the negative electrode current collector, and
wherein in a region where the positive electrode current collector and the negative electrode current collector face each other:
the positive electrode active material layer comprises a positive electrode active material;
the positive electrode active material has an olivine crystal structure belonging to a space group pnma; and
an angle formed by a normal of the negative electrode current collector and a [010] direction of the crystal structure of 50% or more of the number of particles of the positive electrode active material in the positive electrode active material layer is greater than or equal to 0° and less than or equal to 30°.

6. The lithium-ion secondary battery according to claim 5,
wherein the positive electrode active material comprises lithium iron phosphate.
